(19) United States
(12) Patent Application Publication
(10) Pub. No.: US 2019/0205939 A1
(43) Pub. Date: Jul. 4, 2019

(54) Using Machine Learned Visitor Intent Propensity to Greet and Guide a Visitor at a Physical Venue

(71) Applicant: OneMarket Network LLC, San Francisco, CA (US)

(72) Inventors: Raghav Lal, Palo Alto, CA (US); Ramya Raghunathan, San Francisco, CA (US); Joanne McDermott, San Jose, CA (US); Asim Mohammad, Fremont, CA (US)

(73) Assignee: OneMarket Network LLC, San Francisco, CA (US)

(21) Appl. No.: 16/231,036

(22) Filed: Dec. 21, 2018

Related U.S. Application Data
(63) Continuation-in-part of application No. 16/189,993, filed on Nov. 13, 2018.
Application No. 16/189,993 is a continuation-in-part of application No. 16/124,129, filed on Sep. 6, 2018.
(60) Provisional application No. 62/612,570, filed on Dec. 31, 2017.
(60) Provisional application No. 62/612,568, filed on Dec. 31, 2017.
(60) Provisional application No. 62/612,568, filed on Dec. 31, 2017.
(60) Provisional application No. 62/612,571, filed on Dec. 31, 2017.
(60) Provisional application No. 62/612,573, filed on Dec. 31, 2017.
(60) Provisional application No. 62/612,576, filed on Dec. 31, 2017.
(60) Provisional application No. 62/612,578, filed on Dec. 31, 2017.

(51) Int. Cl. G06Q 30/02; G06Q 30/06; H04L 29/08; H04L 12/58; G06N 3/04

(52) U.S. Cl. CPC G06Q 30/0269; G06Q 30/0255; G06N 3/0454; H04L 67/306; H04L 51/14; G06Q 30/0631

(57) ABSTRACT

Mobile devices with multiple radios create an opportunity for retail venues to present new messaging channels to visitors, even visitors who do not subscribe to or do not activate a venue app. Venue operators are uniquely situated to aggregate data before a visit and to track a user during a visit, because their sole objective is to increase overall venue traffic and conversion to sales, without favoritism among tenants.

### CROSS-REFERENCE TO OTHER APPLICATIONS

This application is a Continuation-in-Part of the following applications: U.S. Non-Provisional application Ser. No. 16/124,129, filed 6 Sep. 2018, entitled “SYMBIOTIC REPORTING CODE AND LOCATION TRACKING INFRASTRUCTURE FOR PHYSICAL VENUES” (Attorney Docket No. PYME 1002-2), which claims the benefit of U.S. Provisional Application No. 62/612,568, filed 31 Dec. 2017, entitled “SYMBIOTIC REPORTING CODE AND LOCATION TRACKING INFRASTRUCTURE FOR PHYSICAL VENUES” (Attorney Docket No. PYME 1002-1); and U.S. Non-Provisional application Ser. No. 16/189,993, filed 13 Nov. 2018, entitled “MACHINE LEARNING-BASED SYSTEMS AND METHODS OF DETERMINING USER INTENT PROPENSITY FROM BINNED TIME SERIES DATA” (Attorney Docket No. PYME 1003-2), which claims the benefit of U.S. Provisional Application No. 62/612,570, filed 31 Dec. 2017, entitled “MACHINE LEARNING-BASED SYSTEMS AND METHODS OF DETERMINING USER INTENT PROPENSITY FROM BINNED TIME SERIES DATA” (Attorney Docket No. PYME 1003-1). These priority applications are hereby incorporated by reference for all purposes.

Applicant hereby claims the benefit under 35 U.S.C. 119(e) of U.S. Provisional Application No. 62/612,571, filed 31 Dec. 2017, entitled “USING MACHINE LEARNED VISITOR INTENT PROPENSITY TO GREET AND GUIDE A VISITOR AT A PHYSICAL VENUE” (Attorney Docket No. PYME 1004-1), U.S. Provisional Application No. 62/612,573, entitled “PROVIDING GENDER AND AGE CONTEXT FOR USER INTENT WHEN BROWSING OR SEARCHING” (Attorney Docket No. PYME 1005-1), U.S. Provisional Application No. 62/612,576, entitled “GENERATING AN INDIVIDUALIZED ENSEMBLE OF COMPLEMENTARY ITEMS IN COMPLEMENTARY ITEM CATEGORIES” (Attorney Docket No. PYME 1006-1); and U.S. Provisional Application No. 62/612,578, entitled “SYSTEMS AND METHODS OF INDIVIDUALIZED INCENTIVES TO MODIFY SHOPPER BEHAVIOR” (Attorney Docket No. PYME 1007-1). These priority provisional applications are hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Visitors to venues can download a venue specific application and get a map or narrative of what they are viewing. They can scan a code to bring up a web page, if they have the right software. But the present tools are clumsy and do not make a physical visit engaging in the same ways that online visits are engaging.

Mobile devices have been engineered to reduce their abilities to track and give users explicit control over the sharing of data from location services. This can make it clumsier for a user to set up their mobile device to assist them during a journey. It also makes it more difficult for a venue operator to interact with a user, virtually propelling the venue operator to build their own app to run on a wide variety of mobile devices.

Recommendation engines in mobile apps are primitive, compared to their online counterparts. Data sources from which to generate recommendations are generally not available to physical location operators in the same way that they are available to search engines that touch so many aspects of an online visitor's life at and outside work.

Discerning user intent has grown very refined for search engines. For instance, hundreds of patents have issued in international class G06F covering nuances of discerning user intent. Visitors to a physical venue have not yet experienced the benefits of efforts to discern their intent and assist them in their journey. The tools of big data have yet to be a practical application for the journey of visitors through physical venues such as museums, galleries, historical structures, and malls.

An opportunity arises to leverage mobile device tracking capabilities, big data, intent discovery and recommendation engines to improve visitors experience, both when visiting a physical venue and when exploring online venues, including virtual realities. Improved visitor experience and engagement, higher satisfaction and retention, and conversion of interests may result.

### BRIEF DESCRIPTION OF THE DRAWINGS

In the drawings, like reference characters generally, refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram that shows various aspects of the technology disclosed.

FIG. 2 illustrates the tracking of a visitor's journey through tenant locations of a physical venue in accordance with one implementation. In other implementations, the tenant locations are store locations of an independent retailer store that is not in a tenant-landlord relationship.

FIG. 3A depicts location-based infrastructure of beacons deployed to the physical venue of FIG. 1, and a server beacon resolver configured to determine visitor location based on receipt of beacon messages by a mobile device carried by the visitor.

FIG. 3B depicts location-based infrastructure of registered visitor Wi-Fi access points deployed to the physical venue of FIG. 1, and a server Wi-Fi resolver configured to determine visitor location based on receipt of MAC address identifiers by the mobile device carried by the visitor.

FIG. 4 shows one implementation of an aggregated profile with a master identifier (ID) created for the visitor.

FIG. 5 lists some examples of retailer-related attributes that are included as binned profile data in the aggregated profile of FIG. 4.

FIG. 6 lists some examples of venue-related attributes that are included as binned profile data in the aggregated profile of FIG. 4.

FIG. 7 shows some examples of shopper propensities that are included in the aggregated profile of FIG. 4.

FIG. 8 illustrates a distribution server that uses the aggregated profile of FIG. 4 to send sales recommendations, gender context, dynamic pricing, and/or arrival/exit notifications to participating tenants of the physical venue in response to tenant requests. In other implementations, the participating tenants are participating independent retail stores that are not in a tenant-landlord relationship.

FIGS. 9, 10A and 10B show a conversion engine that uses the aggregated profile of FIG. 4 to identify in-retailer and overall purchase propensities for converting shoppers to in-retailer purchases.

FIG. 11 depicts one implementation of a dashboard that graphically presents various venue intelligence metrics to a venue operator.

FIG. 12 illustrates one implementation of a dashboard that graphically presents various visitor activity metrics to a venue operator.

FIG. 13 is one implementation of a dashboard that graphically depicts various shopper attributes across a plurality of shopper stratums.

FIG. 14 illustrates a message modifier that uses the aggregated profile of FIG. 4 to determine shopper intent and propensities, and in response modify messages and engagement schemes used by the tenants to interact with the shoppers. In other implementations, the tenants are independent retail stores that are not in a tenant-landlord relationship.

FIG. 15 is a message sequence chart of determining an incentive offer for a shopper using the aggregated profile of FIG. 4 and using the incentive offer to cause the shopper to return goods at a physical location instead of returning online.

FIG. 16 shows one example of the incentive offer described in FIG. 15.

FIG. 17 is a message sequence chart of determining an incentive offer for a shopper using the aggregated profile of FIG. 4 and using the incentive offer to cause the shopper to pick up goods at a physical location rather than request shipping.

FIG. 18 shows one example of the incentive offer described in FIG. 17.

FIG. 19 depicts a message sequence chart of enhancing a user browsing experience using an ensemble engine that generates product recommendations based on a shopper's purchase history, intent and propensity data identified in the aggregated profile of FIG. 4.

FIGS. 20A and 20B show one example of how the user browsing experience is enhanced by the ensemble engine of FIG. 19.

FIG. 21A shows one implementation of a training stage in which machine learning-based models are trained on training data to output user intent and propensity information.

FIG. 21B shows one implementation of a production/inference stage in which trained machine learning-based models from FIG. 21A are used to evaluate production data and output user intent and propensity information.

FIG. 22 is a message sequence chart of using the aggregated profile of FIG. 4 to make personalized recommendations to a shopper.

FIG. 23A shows one implementation of a shopper profile accessible to a retail store operator.

FIG. 23B is one implementation of an interface that can be used by a retail store operator to request new or updated shopper profiles.

FIG. 24 illustrates a first step of iteration using first, second and third beacons

FIG. 25 shows second and third steps, completing one iteration using three beacons.

FIG. 26 illustrates a method to set a reporting threshold for interested store operators at a mall.

FIG. 27 illustrates a chart of percentages of beacon circumferences captured within uncertainty distance range buckets, for 930 scans.

FIG. 28 shows a histogram and a chart evaluating alternative path loss exponents, based on numerous readings in a handful of malls, leading to selection of 4.5 as an exponent for a mall during store operating hours.

FIG. 29 shows a chart with results from six useful options for the convergence algorithm.

FIG. 30 shows a block diagram of a purchase propensity predictor that produces user purchase propensity scores.

FIG. 31 shows a simplified diagram of a gradient tree boosting algorithm.

FIG. 32 shows a block diagram for an LSTM algorithm.

FIGS. 33A, 33B, 33C and 33D show four implementations of LSTM-based classifiers used by the propensity predictor.

FIG. 34 shows classification results for the gradient tree boosting implementation of the classifier.

FIG. 35 shows evaluation statistics for the gradient tree boosting implementation of the classifier.

FIG. 36 shows a system diagram for sending messages to a visitor to a venue.

FIG. 37 is a message sequence chart for sending messages to a visitor to a venue.

FIG. 38 illustrates a chart showing a message sequence for sending object recommendations to a user based on gender and age context.

FIG. 39 shows a user interface for an online portal 3905 that displays gender context recommendations.

FIG. 40 shows a system diagram for an ensemble engine that generates product recommendations based on a shopper's purchase history, intent and propensity data identified in the aggregated profile.

FIG. 41 depicts a message sequence chart of enhancing a user browsing experience using the ensemble engine.

FIG. 42 shows a diagram of an incentive determination system

FIG. 43 shows a block diagram illustrating information transfers among the components of the incentive determination system.

FIG. 44 is one implementation of a computer system that can be used to implement the technology disclosed.

### DETAILED DESCRIPTION

### Introduction

Retail venues, now called “brick and mortar”, face stiff competition from online portals, which are perceived as having lower prices, better selection, and delivery. Portals have the further advantage of ease of use, when well designed, and powered by recommendation engines.

Mobile devices with multiple radios (even if software defined) create an opportunity for retail venues to present new messaging channels to visitors, even visitors who do not subscribe to or do not activate a venue app. Venue operators are uniquely situated to aggregate data before a visit and to track a user during a visit, because their sole objective is to increase overall venue traffic and conversion to sales, without favoritism among tenants.

Structural safeguards and contractual commitments allow a venue operator to aggregate individualized visitor data across tenants of numerous venues and combine tenant data with other retailer data for analysis. Anonymized aggregate data, in the sense that contributions to individual visitor aggregates cannot be reverse engineered, can be stored side-by-side with retailer-specific data, without risk of leakage between retailers. This involves careful architecting of database structures and access routines.

On the data collection side, physical control of venue common space allows the venue operator to combine membership-based free WiFi with symbiotic software loops in active background applications, which report encrypted BLE beacon messages for decryption, to accurately track a visitor's journey through an indoor venue, while respecting user permissions. Cooperation with tenants allows the venue operator to extend hyper-location tracking beyond entry into a tenant's space, beyond the common areas. This involves substantial physical infrastructures. With this overview in mind, additional detail is more easily understood.

Access to point of sale and online sale data, at a SKU/UPC level and across retailers who view themselves as competitors, allows a venue operator to predict aggregate purchasing propensities, as well as retailer specific purchasing patterns. For instance, artificial intelligence systems can be trained with data that ordinarily could not be aggregated. Separate models can be trained with the aggregated and retailer-specific data. Training models on binned data is more efficient and practical than training on of individual purchase events. Binning requires creation and maintenance of a SKU hierarchy that spans diverse product offerings of tenants and other retailers, because there are too many SKUs to train artificial intelligence systems using individual SKUs. Practically, the venue operator's SKU hierarchy should also be a Rosetta stone of sorts, providing two-way translation between the AI's hierarchy of categories and each retailer's own hierarchy of categories. The SKU hierarchy is structured to power an individualized recommendation engine (as opposed to look alike, collaborative filtering.) New applications of big data analytics to prediction of purchase propensities are possible with newly aggregated data, with binning facilitated by a cross-retailer SKU hierarchy. Pre-calculation from historical, binned data can be combined with location tracking indoors, within a venue, during a visitor's journey or “at a moment in time.”

Symbiotic software loops in a critical mass of active background applications can effectively report and decode encrypted beacons and other signal propagated indoors, within a venue that a visitor's mobile device otherwise would miss if the visitor did not activate the venue's app or subscribe to the venue's free Wi-Fi. Symbiotic software loops are developed using software developer kits (SDKs) adopted by popular applications that are interested in geo location of users. Symbiotic software code is called from the main processing loop of an application when the application is in the foreground or the active background. The active background operation is important, because applications are quickly displaced from the foreground into the background. Mobile device operating systems limit the number of background applications that are active, in order to conserve battery life. If a mobile phone, for instance, has 15 applications loaded in the background, a handful, perhaps four or five of those applications are in the active background. Applications in the active background continue to operate, without painting the display. Presence in the active background makes an application effective at listening for encrypted BLE beacon signals. When two, three or half a dozen social media, ride sharing, navigation and other location-aware applications on an individual mobile device implement symbiotic software loops, it is likely that one of the applications will be in the foreground or active background throughout a visitor's journey at the venue. By accepting active background processing, the portals that sponsors an application gains improved location resolution while the mobile device is indoors; symbiotically, the venue operator gains a new tool for tracking a visitor's journey. For instance, a ride sharing operator can tell which door at which level a visitor is approaching as they exit an airline terminal to catch a ride, even before the sky is visible to the mobile device's GPS. This encourages the application portal to adopt the symbiotic software loop, as one of multiple tracking approaches.

Membership based free Wi-Fi is another tool for location tracking, using access point infrastructure that reports data about connected mobile devices. Before a mobile device connects, its MAC address is likely to be obfuscated. Mobile devices have been engineered to obfuscate MAC addresses, prior to actual network connection, in order to defeat unauthorized location tracking. For instance, one manufacturer of popular cell phones rotates the obfuscated MAC address approximately every six hours. Its mobile devices use an obfuscated MAC address prior to actual connection to an access point. Membership based free Wi-Fi access provides an identifier, such as email address, that the links a connected MAC address to aggregated data for the mobile device. Upon connection, the MAC address becomes a unique identifier for following a visitor's journey, reported by access point infrastructure as the visitor moves through the venue. Without a connection, infrastructure can merely track the obfuscated MAC address, without being given a meaningful identifier of the mobile device.

Tracking and unveiling obfuscated MAC addresses is an opportunity afforded by venue infrastructure with multiple radio infrastructures. Prior to a Wi-Fi connection, symbiotic software loops can follow mobile device through the venue. Upon connection, a server can correlate location data from symbiotic software loops with tracking location data from the obfuscated MAC address. In some instances, the simple correlation between beacon location resolution and obfuscated MAC address location resolution can be provide a reliable correlation. In other instances, connection of the Wi-Fi in to an access point will strengthen the correlation enough to match obfuscated journey location information with beacon derived location data. Operation and coordination of the two infrastructures creates an opportunity for linking tracks independently generated from the mobile device.

Location data can be combined with periodically calculated propensity data to enhance a visit to a venue. The visitor's likely intent for a visit can be predicted upon arrival by accessing data that has been analyzed for patterns and propensities. When a visitor arrives at a venue, they can be identified and propensities retrieved, which have been pre-calculated on a periodical basis applying big data techniques to aggregated, binned, category-level SKU data. Profile and propensity data, including destination specific and aggregated propensity data can be fed to retailers at the venue.

The venue operator can solicit greeting messages for an identified visitor upon arrival. Greeting messages can featured products and include incentives, or provide friendly greetings. The venue operator can improve the user experience by prioritizing and/or grouping messages. The number and content of messages delivered can be determined by the venue operator to improve visitor experience, to avoid bombardment of the visitor with excessive, noisy messaging. This greeting protocol sometimes is enhanced by a strong indication of the visitor's intent.

Aggregation of data will sometimes allow a strong prediction of a visitor's primary and secondary intent immediately upon arrival, based either on recent behaviors or periodic patterns. For instance, a visitor who browsed online for repair services in the last hour may be headed to a repair shop at the venue; they may have an expected waiting time for completion of the repair. Recent browsing activity may suggest where to direct the user during their waiting time and what kind of messaging will enhance the visitor's journey. Periodic behavior, such as picking up coffee midmorning or eating lunch at the venue, also can be ascertain from the profile and the aggregated data, which can be combined when soliciting candidate messages.

Profiles created using aggregated and retailer-specific data also can be used to precipitate a visit, thereby increasing foot traffic in the venue. Two opportunities to bring an online user to a store are order fulfillment order and return of goods purchased online.

When a user buys from a retailer who has a physical presence at a location that the user visits, the online user may be converted to a visitor by offering to make the goods available immediately at a pick-up counter at a venue. This may require little effort for frequent visitors, as indicated by their retailer-specific profiles. Pick-up today caters to some of the same instincts that cause coffee buyers to pre-order and prepay their morning java dose, for pickup without waiting in line. A user who seldom visits the retailer's physical location may require an extra nudge.

Customized incentives to pick up goods by visiting a physical location can be crafted based on goods specific information and a user profile. While free shipping is enticing to buyers, it is not free to sellers. Part of a custom incentive can be funded by reduced shipping costs. Many shoppers buy a few more things when they happen to visit a venue, so an incentive can be fashioned for discounted purchases today, for instance, that increase the likelihood that a visit to pick up goods will convoy additional purchases.

Elasticity, as a factor in customization of pickup incentives, can be assessed using data aggregated across retailers, which will reveal users with a propensity to take advantage of pick-up today options. It also may reveal proven pick-up visitors who are not aware of a pick-up location that would be convenient for them to visit.

Return of goods purchased online is a further opportunity to precipitate a visit that increases foot traffic in the venue. Returns can be more expensive for an online retailer to process than fulfillments, when the return address is different than the fulfillment address. This is the case when fulfillment is directly from a manufacturer's warehouse, instead of a retailer's distribution center. A customized incentive can be offered to return or exchange goods in-store, potentially avoiding two way shipping costs. As with pick up of goods, part of a custom incentive can be funded by reduced shipping costs. Another part of an incentive can be based on a likelihood that a visit to pick up goods will convoy additional purchases. Elasticity can be assessed to gauge an amount of incentive that is likely to succeed in precipitating a visit.

During a visit, whether detected or precipitated, ensembles can be offered on an individualized basis. In general, recommendation engines typically are based on look-alikes, what other customers bought along with the current SKU/product. Current recommendation engines do not check size availability or take into account a particular online visitor's brand, color or style preferences. With a SKU category hierarchy, individualized visitor histories and binned profiles can be used to fashion product ensembles that are individualized. From look-alike data, ensembles of SKU/product categories can be assembled. Individual SKUs/products can be selected to fill the categories from individualized data. Product availability can be taken into account when an individualized ensemble is constructed. This approach can be applied both in store and online. In a store, a user who is browsing the retailer's app or the venue operator's app can receive from a server personalized ensemble recommendations. Or a personal shopping assistant or concierge can receive the recommendations and convey them to the shopper. Online, the user can receive the personalized recommendations as browsing and buying proceed.

Aggregated data can be utilized increase sales in underrepresented categories, both during physical and online visits and by direct marketing. Retailers tend to underestimate buying propensity for a sizable portion of their customers, when they make estimates based on retailer-specific purchases. In one sample, 18 percent of users had a higher overall purchase propensity for makeup than would be estimated from their retailer-specific history. At the point of sale, during a visit, a sales person can be given an overall propensity for SKUs/products in a department, for an ensemble, or across the store. Categories in which the overall propensity exceeds the retailer-specific propensity can be highlighted to a sales person to motivate efforts to convert the visitor to fulfill their intent in-store, instead of elsewhere. Incentives can be provided to help convert the visitor. Online, featured products can be selected based on the overall propensity and can be directed to conversion of intent to goods available from the online retailer's own site. Direct marketing also can take advantage of identified opportunities with messages and incentives designed to capture a larger share of a current customer's spend in a category that is more often fulfilled elsewhere.

During online visits, gender context intent can be determined from aggregate history data, including both online and physical history, based on Bayesian likelihood of within SKU/product categories, brand or retailer or based on recent browsing. Many households have a Chief Shopping Officer. In households of four people, some CSOs will shop for male and female adults and male and female dependents, plus friends and relatives. When they visit online looking for pants, are they looking on behalf of a male or female and on behalf of an adult or child? Binned profile data within a SKU/product category hierarchy can yield a Bayesian likelihood of gender context and/or age context. The Bayesian estimate is stronger when more factors are taken into account. Often, different retailers are visited to satisfy different gender contexts and or age contexts. Brands also can differentiate between gender and age contexts. Once gender and approximate age contexts are established, specific propensities and preferences, as discussed above regarding ensembles, can be brought to bear so the first array of products displayed have a substantial likelihood of matching the visitor's intent.

Considering again physical visits, extra attention can be directed to visitors who have a history of buying luxury goods. Retailers that have active customer service tend to sell at least some high priced or luxury goods. Selling high priced goods with a substantial margin pays for customer service and even for personal shopping service. Customer profiles can be used to identify luxury shoppers and big spenders when they start their journey through a venue. Journey tracking technologies described above can follow the visitor as they approach a particular retailer. Customer service, personal shopping or concierge staff can be alerted to the arrival of high value visitor. A picture can be provided from a profile, if available. A real time approach track, as available with ride sharing services, also could be provided from the BLE and/or Wi-Fi tracking infrastructures described above.

Overall, a combination of precise location tracking, without requiring visitor activation during a journey, and big data analysis of data aggregated across retailers/venues/platforms has many opportunities for brick and mortar retailers to recapture market share from online platforms by providing new services that have no online analog and by reproducing and adapting the best of online experiences for location based experiences.

During a visit, whether detected or precipitated, ensembles can be offered on an individualized basis. In general, recommendation engines typically are based on look-alikes, what other customers bought along with the current SKU/product. Current recommendation engines do not check size availability or take into account a particular online visitor's brand, color or style preferences. With a SKU category hierarchy, individualized visitor histories and binned profiles can be used to fashion product ensembles that are individualized. From look-alike data, ensembles of SKU/product categories can be assembled. Individual SKUs/products can be selected to fill the categories from individualized data. Product availability can be taken into account when an individualized ensemble is constructed. This approach can be applied both in store and online. In a store, a user who is browsing the retailer's app or the venue operator's app can receive from a server personalized ensemble recommendations. Or a personal shopping assistant or concierge can receive the recommendations and convey them to the shopper. Online, the user can receive the personalized recommendations as browsing and buying proceed.

During online visits, gender context intent can be determined from aggregate history data, including both online and physical history, based on Bayesian likelihood of within SKU/product categories, brand or retailer or based on recent browsing. Many households have a Chief Shopping Officer. In households of four people, some CSOs will shop for male and female adults and male and female dependents, plus friends and relatives. When they visit online looking for pants, are they looking on behalf of a male or female and on behalf of an adult or child? Binned profile data within a SKU/product category hierarchy can yield a Bayesian likelihood of gender context and/or age context. The Bayesian estimate is stronger when more factors are taken into account. Often, different retailers are visited to satisfy different gender contexts and or age contexts. Brands also can differentiate between gender and age contexts. Once gender and approximate age contexts are established, specific propensities and preferences, as discussed above regarding ensembles, can be brought to bear so the first array of products displayed have a substantial likelihood of matching the visitor's intent.

Aggregated data can be utilized increase sales in underrepresented categories, both during physical and online visits and by direct marketing. Retailers tend to underestimate buying propensity for a sizable portion of their customers, when they make estimates based on retailer-specific purchases. In one sample, 18 percent of users had a higher overall purchase propensity for makeup than would be estimated from their retailer-specific history. At the point of sale, during a visit, a sales person can be given an overall propensity for SKUs/products in a department, for an ensemble, or across the store. Categories in which the overall propensity exceeds the retailer-specific propensity can be highlighted to a sales person to motivate efforts to convert the visitor to fulfill their intent in-store, instead of elsewhere. Incentives can be provided to help convert the visitor. Online, featured products can be selected based on the overall propensity and can be directed to conversion of intent to goods available from the online retailer's own site. Direct marketing also can take advantage of identified opportunities with messages and incentives designed to capture a larger share of a current customer's spend in a category that is more often fulfilled elsewhere.

Considering again physical visits, extra attention can be directed to visitors who have a history of buying luxury goods. Retailers that have active customer service tend to sell at least some high priced or luxury goods. Selling high priced goods with a substantial margin pays for customer service and even for personal shopping service. Customer profiles can be used to identify luxury shoppers and big spenders when they start their journey through a venue. Journey tracking technologies described above can follow the visitor as they approach a particular retailer. Customer service, personal shopping or concierge staff can be alerted to the arrival of high value visitor. A picture can be provided from a profile, if available. A real time approach track, as available with ride sharing services, also could be provided from the BLE and/or Wi-Fi tracking infrastructures described above.

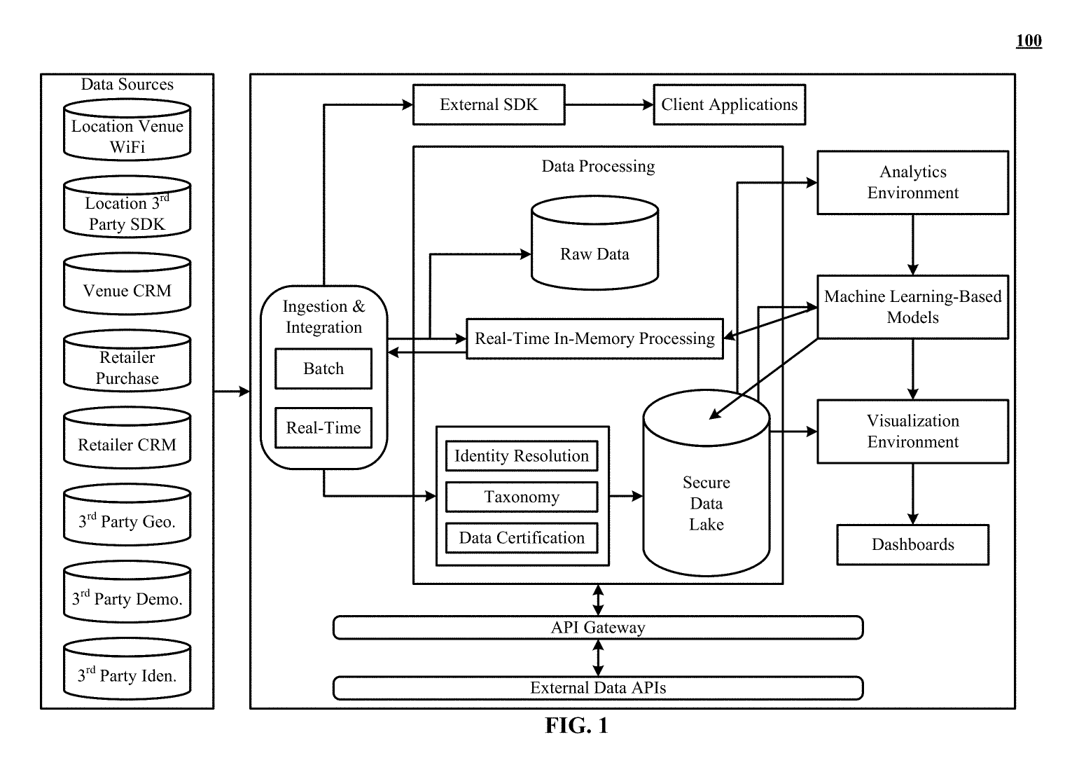

FIG. 1 is a block diagram that shows various aspects of the technology disclosed. FIG. 1 includes system 100. System 100 includes a plurality of data sources, such as WiFi-based location data from venue WiFi access points, beacon-based location data from 3^{rd} party SDKs, venue customer relationship management (CRM) data, retailer purchase data, retailer CRM data, 3^{rd} party geolocation data, 3^{rd} party demographics data and 3^{rd} party identity data.

System 100 also includes an ingestion and integration sub-system, which can provide batch processing (e.g., Hadoop or Storm) as well as stream or real-time processing (e.g., Spark). Both processing styles can use a messaging queue such as Kafka as a source and/or sink.

Data from the data sources and via the ingestion and integration engine is provided to a data processing sub-system. Data processing sub-system includes a real-time in-memory processing component which can use machine learning-based models to predict insights in real time. Examples of predictive insights include user intent and user propensities. Examples of machine learning-based models include logistic regression-based models, convolutional neural network-based models, recurrent neural network-based models (e.g., models that use long short-term memory networks or gated recurrent units), fully-connected network-based models, and multilayer perceptron-based models.

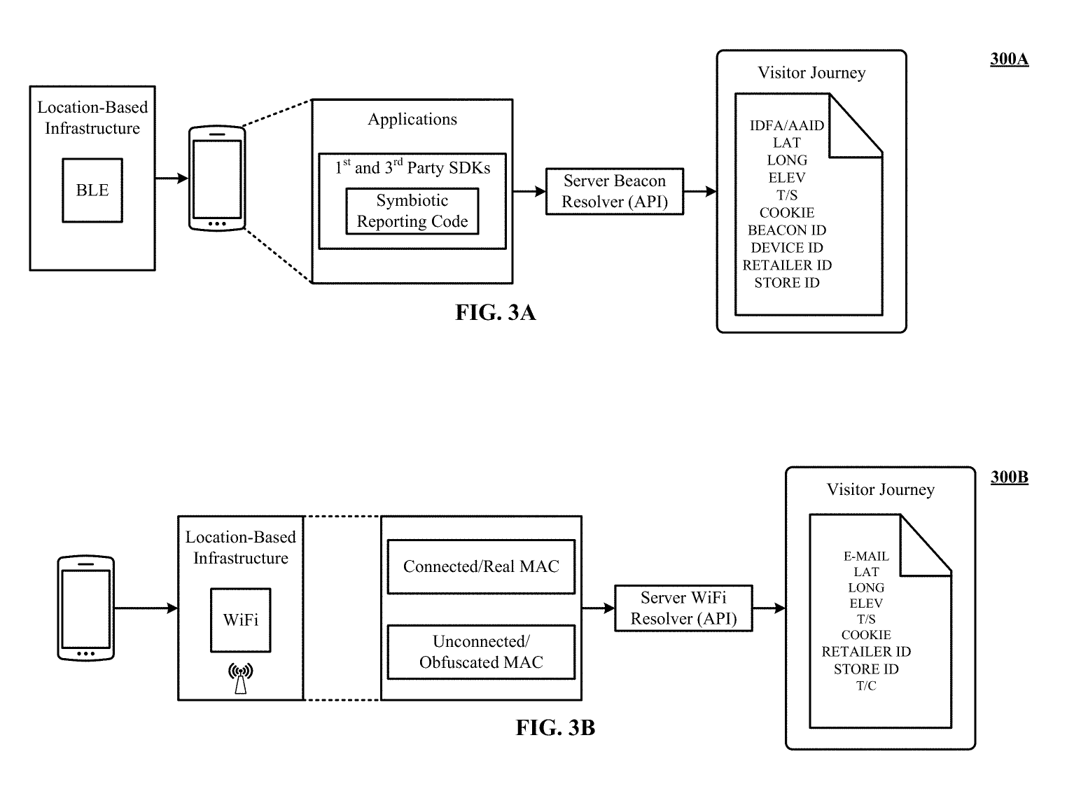

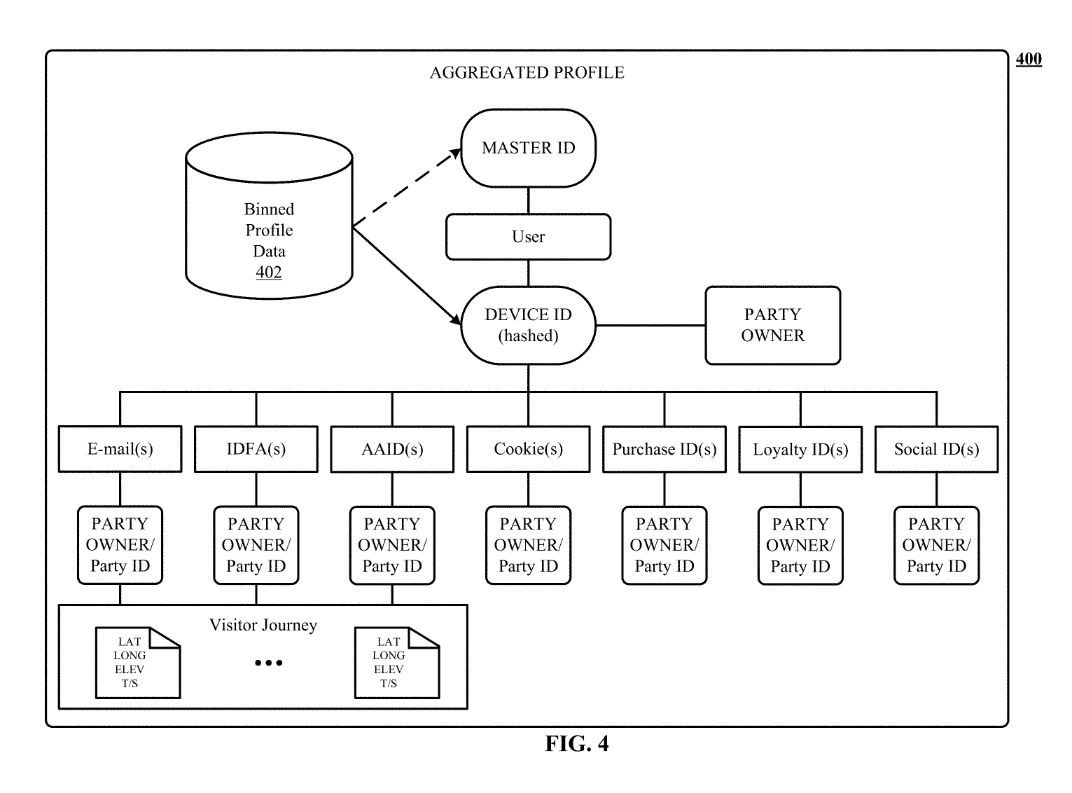

Data processing sub-system also includes an identity resolution component which performs entity disambiguation to populate and update aggregated profiles of user (or shoppers), as described later in this application with reference to FIGS. 3A and 3B. Data processing sub-system also includes a taxonomy component which normalizes product names across multiple retailers using unique product SKUs and creates a bi-directional taxonomy. The bi-directional taxonomy can be used by an analytics environment to determine product specific metrics across the multiple retailers and present such metrics on the frontend using product names that are specific to each of the retailers.

Data processing sub-system also includes a data certification component that enforces compliance of data processing and storage operations with data privacy and authentication regulations such as General Data Protection Regulation (GDPR). Certified data can be stored in a secure data lake. Secure data lake can also store outputs and predictions from the trained machine learning-based models. A visualization environment can access the secure data lake to present various retail and shopper metrics to store operators via dashboards.

Data processing sub-system can interact with the end users (or shoppers) using the external SDK running on client applications active on mobile devices of the end users. One example of such user interaction includes sending a coupon or product recommendation to a shopper. Unprocessed data from the data sources can be stored in the raw data database of the data processing sub-system. Data processing sub-system can use various APIs to communicate with external application servers belong to participating tenants or stores.

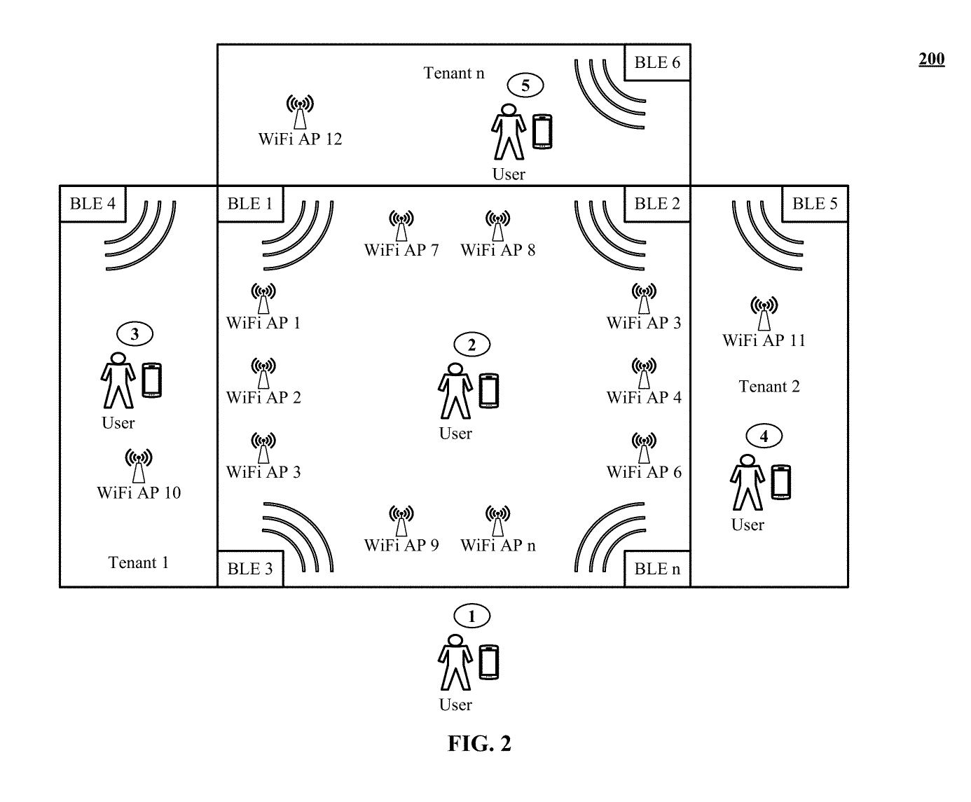

FIG. 2 illustrates tracking of a visitor's journey through tenant locations of a physical venue in accordance with one implementation. In other implementations, the tenant locations are store locations of an independent retailer store that is not in a tenant-landlord relationship. In the illustrated embodiment, physical venue 200 includes three tenants, tenant 1, tenant 2 and tenant three and the visitor's journey is tracked across the three tenants using location-based infrastructure deployed at the physical venue. Examples of location-based infrastructure include Bluetooth Low Energy-based beacons and WiFi access points.

At time 1, the visitor is tracked outside the physical venue 200, for example at a parking lot. At time 2, the visitor's arrival at the physical venue 200 is detected, as well as her departure from the parking lot. At time 3, the visitor's arrival at tenant 1's location is detected, as well as her departure from the tenant 1's location. At time 4, the visitor's arrival at tenant 2's location is detected as well as her departure from the tenant 12's location. At time 5, the visitor's arrival at tenant n's location is detected, as well as her departure from the tenant 2's location.

FIG. 3A depicts location-based infrastructure of beacons deployed to the physical venue of FIG. 1, and a server beacon resolver configured to determine visitor location based on receipt of beacon messages by a mobile device carried by the visitor. In FIG. 3A, symbiotic reporting code, running in active background applications (as part of 1^{st} or 3^{rd} party SDKs), reports and decodes encrypted beacons that the visitor's mobile device otherwise would miss if the visitor did not activate the venue's application or subscribe to the venue's free Wi-Fi. The beacon messages reported by the symbiotic reporting code are received by the server beacon resolver, which serves as an API. The beacon messages 300 include a payload which encodes the visitor journey using data such as IDFA (for iOS devices), AAID (for Android devices), location data such latitude, longitude, elevation, timestep, cookie, beacon ID, device ID, retailer ID, and store ID.

FIG. 3B depicts location-based infrastructure of registered visitor Wi-Fi access points deployed to the physical venue of FIG. 1, and a server Wi-Fi resolver configured to determine visitor location based on receipt of MAC address identifiers by the mobile device carried by the visitor. WiFi access points use real or obfuscated MAC addresses to send data payloads to the server WiFi resolver. These payloads also encode the visitor journey using data such as e-mail, location data such latitude, longitude, elevation, timestep, cookie, device ID, retailer ID, store ID, and terms and conditions.

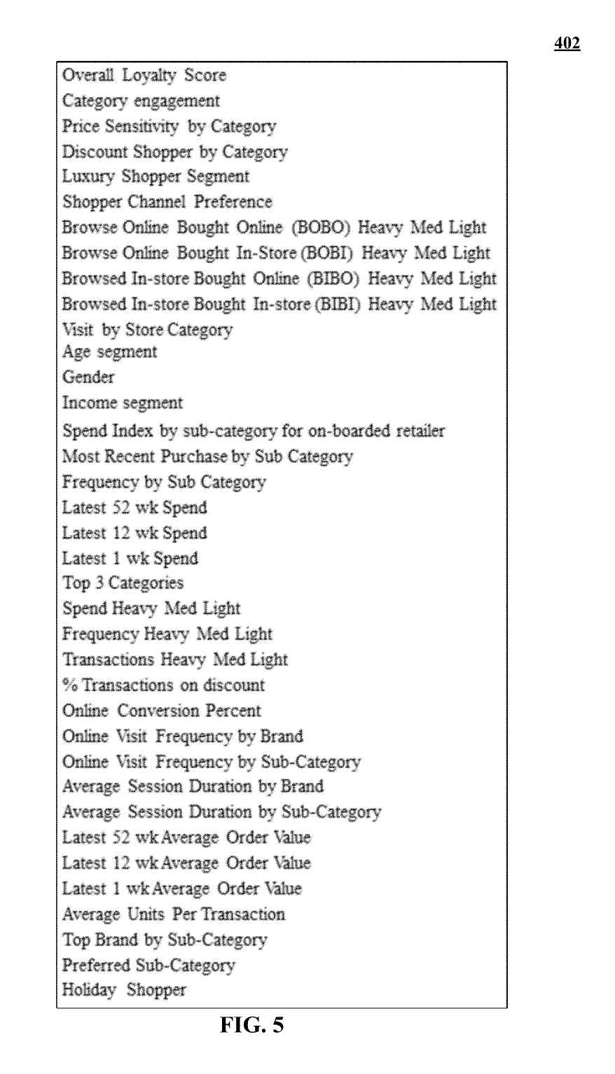

FIG. 4 shows one implementation of an aggregated profile 400 with a master identifier (ID) created for the visitor. When profile and/or location information about a user (or shopper or visitor) is received by the system 100 from one or more data sources, it is assigned a device ID and stored. Device ID uniquely identifies the user associated with the information. The device ID is further tagged with a party owner ID, which identifies the source of the information (e.g., the retail store that provide the information). In some implementations, device ID can be produced by hashing an internal ID used by the retail store to internally identify the user. This way the identity of the user is preserved and is not exposable via the system 100.

In addition, the system 100 assigns a master ID to the device ID. Master ID is used by the system 100 to manage the user's identity and information across many different data sources and retail stores. Binned profile data 402 is linked to the master ID.

Profile and/or location information about the user can be encoded using fields such as e-mail, IDFA, AAID, cookie, purchase ID, loyalty ID, or a social media ID. When the system 100 receives values for these fields, it identifies the source of the value using a party owner ID and also assigns a unique party ID to the value. In some implementations, multiple instances of the same value are received from different sources, such that each value is assigned a different party ID and a corresponding party owner ID.

Also, the e-mail, the IDFA, and the AAID fields are used to track the user's journey, according to some implementations.

The binned input data 402 is collected from online and offline purchases as well as online browsing and offline browsing, standardized using common identity resolution and product taxonomy. An example analysis period may be 12 months, with input data grouped into daily/weekly/monthly input time bins. Offline browsing data comprise data from personal devices with location sensing capabilities, such as smartphones and wearable devices. The location-specific data have detailed knowledge of a visitor's journey and visitation patterns in an indoor venue. The personal devices can estimate their locations through beacons, communications with one more GPS satellites, proximity to one or more WiFi sources, multilateration of radio signals between several nearby cell towers, IP addresses of the personal devices, and so on. The location-specific data may be collected by the indoor venue through beacons and WiFi access points inside the indoor venue. The location-specific data may also be obtained from third-party vendors.

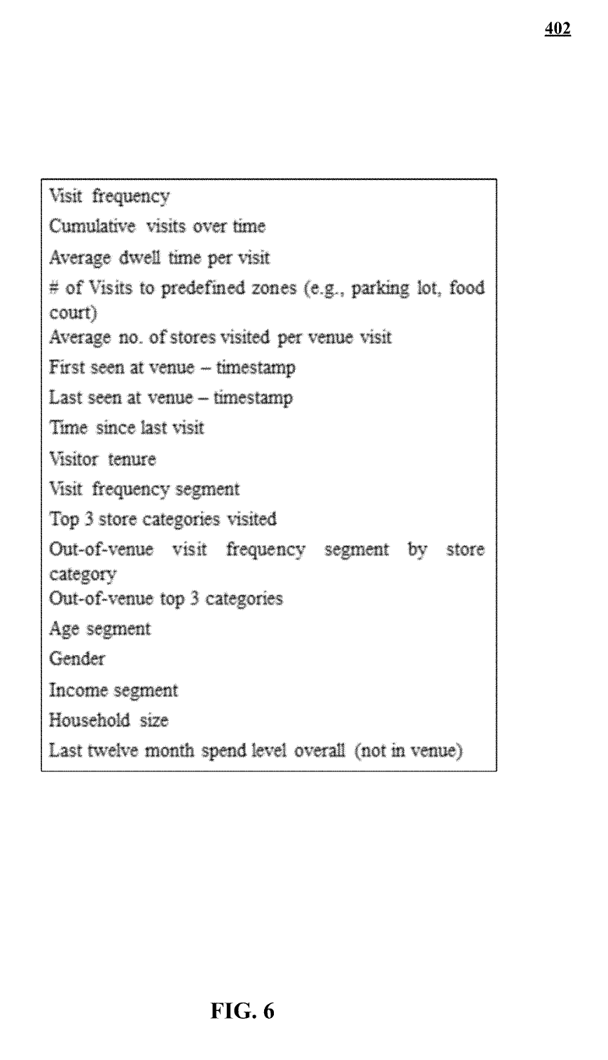

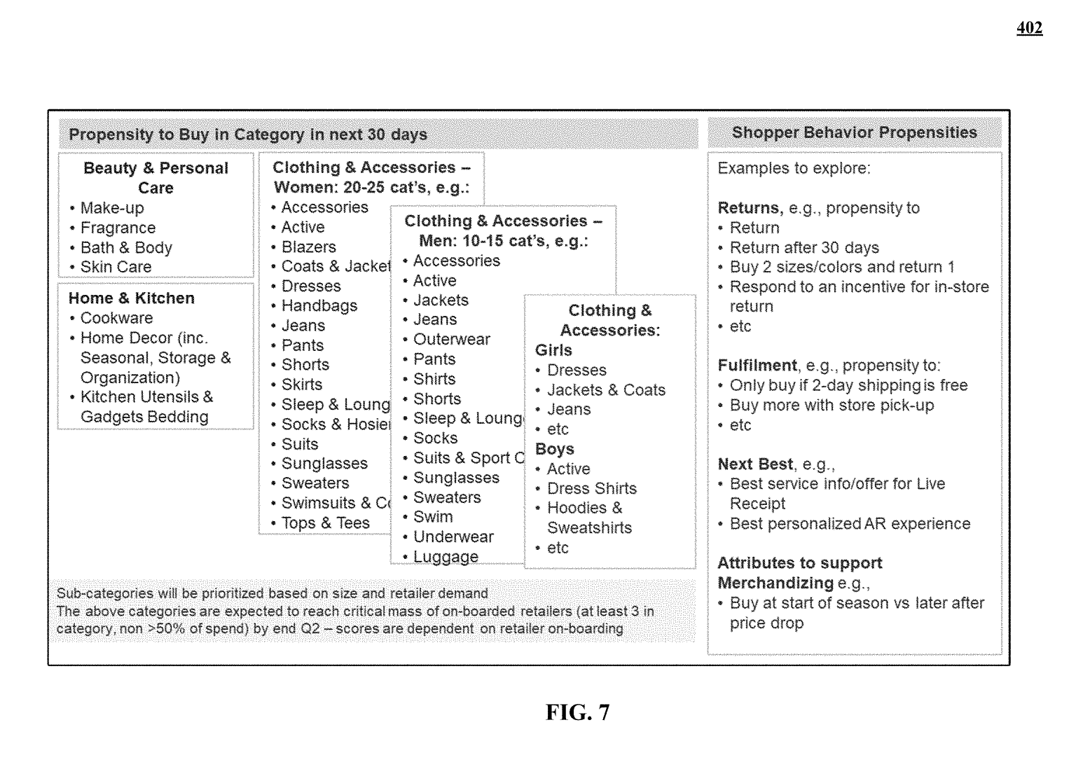

FIG. 5 lists some examples of retailer-related attributes that are included as binned profile data in the aggregated profile 400. FIG. 6 lists some examples of venue-related attributes that are included as binned profile data in the aggregated profile 400. FIG. 7 shows some examples of shopper propensities that are included in the aggregated profile 400.

Regarding the binned profile data 402, it includes tenant-specific binned data individualized for the visitors that represents time-based events in time window bins organized into event categories (e.g., most recent purchase by sub category in FIG. 5). It also includes aggregated binned data individualized for the visitors that also represents time-based events in time-window bins organized into event categories, aggregated across at least the tenants (e.g., latest 52 wk spend, latest 12 wk spend, latest 1 wk spend in FIG. 5). It also includes pre-calculated intent propensities organized by the event categories, generated from the tenant-specific and aggregate binned data (e.g., return propensity, fulfillment propensity, next best propensity in FIG. 7). The aggregated binned data individualized for the visitors further represents time-based events in time-window bins organized into event categories, collected from non-tenant entities (e.g., average dwell time per visit at a venue in FIG. 6). The aggregated binned data individualized for the visitors further includes individual visitor opt-in permissions for location tracking and for messaging organized by data source

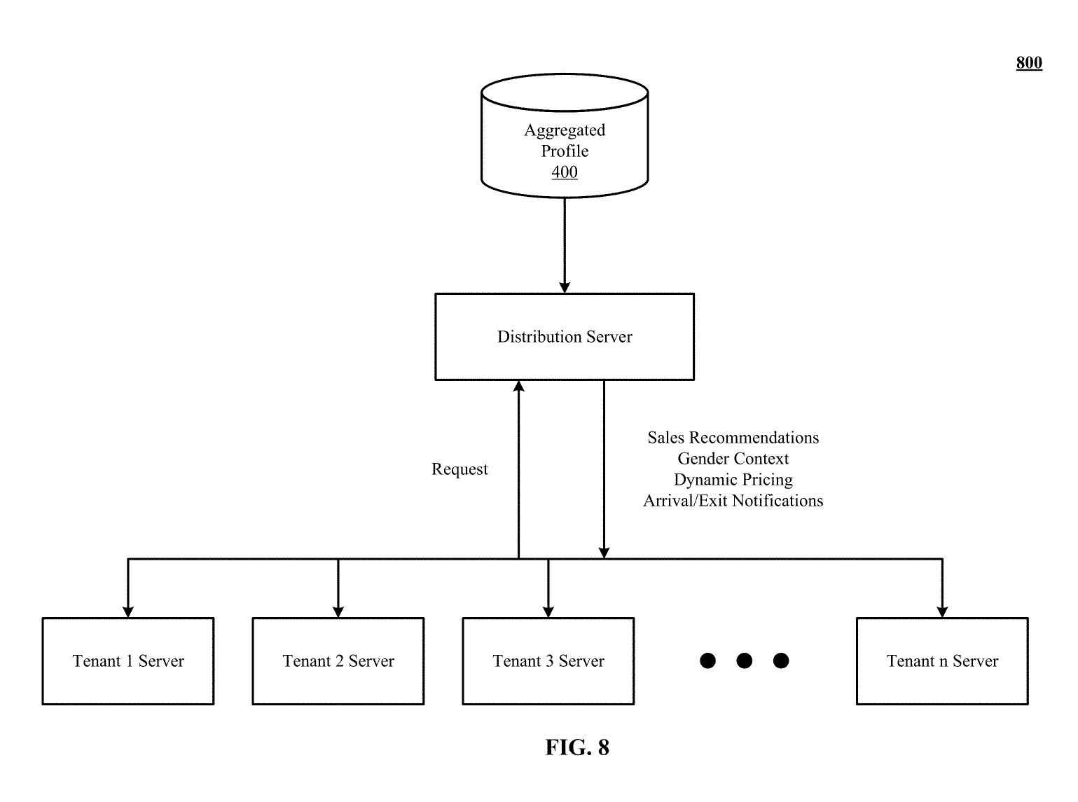

FIG. 8 illustrates a distribution server that uses the aggregated profile 400 to send sales recommendations, gender context, dynamic pricing, and/or arrival/exit notifications to participating tenants of the physical venue in response to tenant requests. In other implementations, the participating tenants are participating independent retail stores that are not in a tenant-landlord relationship. The distribution sever can use the visitor journey information encoded in the aggregated profile 400 to report to servers representing the participating tenants of arrival of the visitor, accompanied by a profile of the visitor and tenant-specific and aggregate intent propensity information. The reporting can include a visitor name and other personally identifiable information. The reporting can include a visitor photograph and other personally identifiable information. The reporting can include a unique identifier but not a visitor name or photograph.

As discussed above, binned profile data 402 also includes at least one identified intent of the visitor upon arrival at the venue. The distribution sever can use the intent information encoded in the aggregated profile 400 to report to servers representing the participating tenants of the identified intent. In other implementations, based on an entitlement being fulfilled at the venue, the distribution sever can use the intent information encoded in the aggregated profile 400 to report to servers representing the participating tenants of the identified intent.

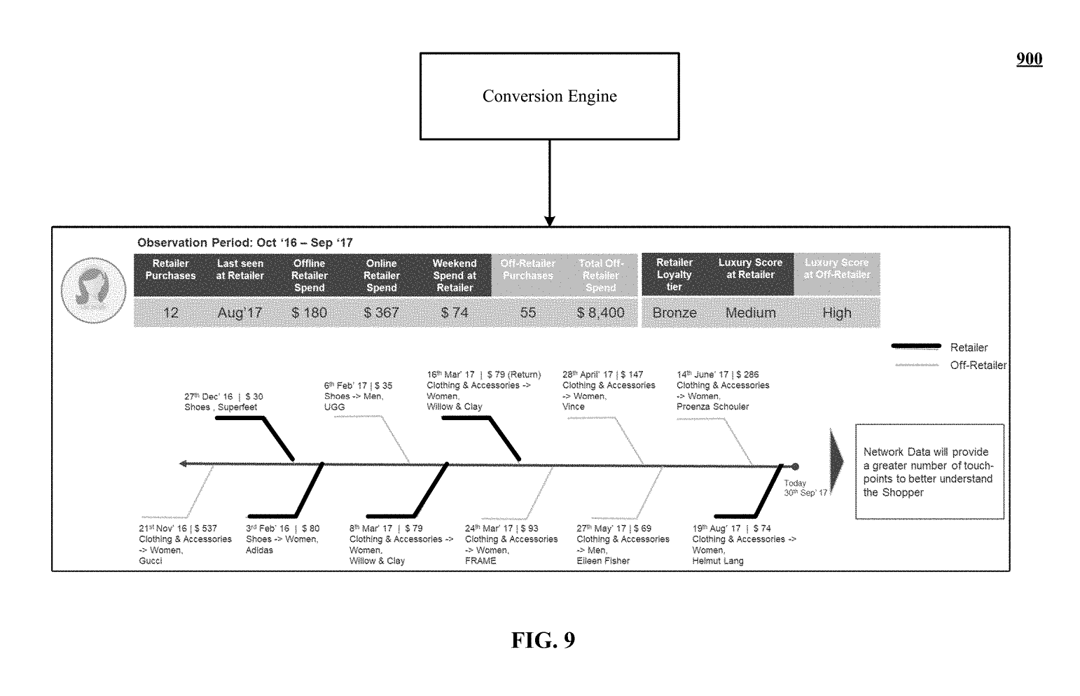

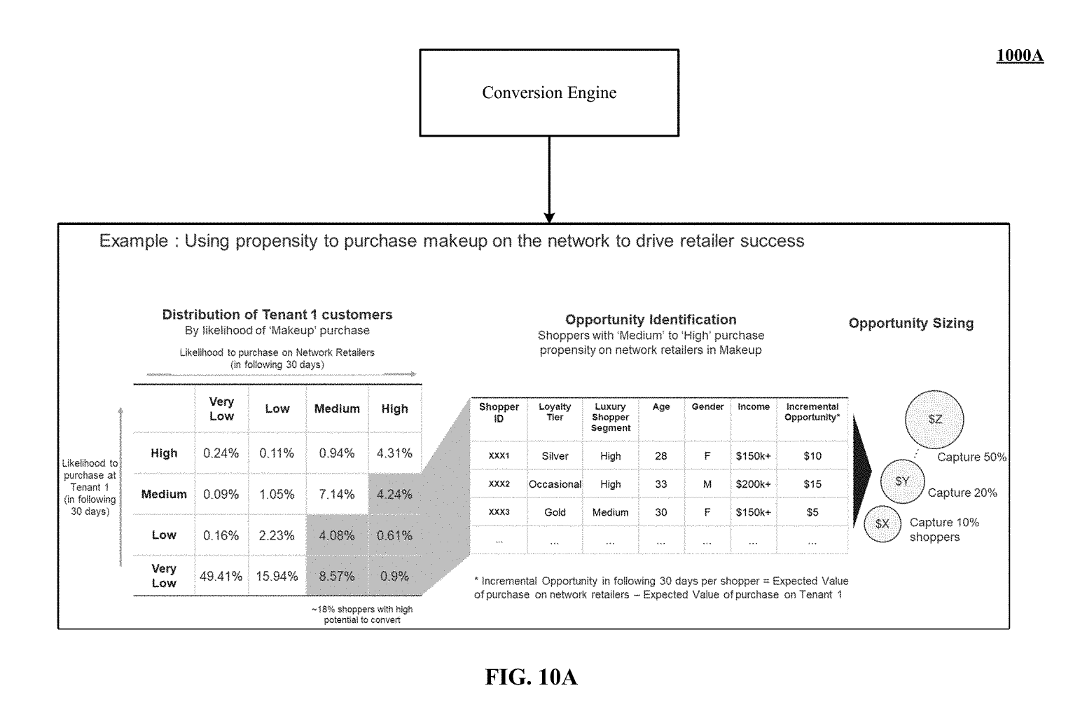

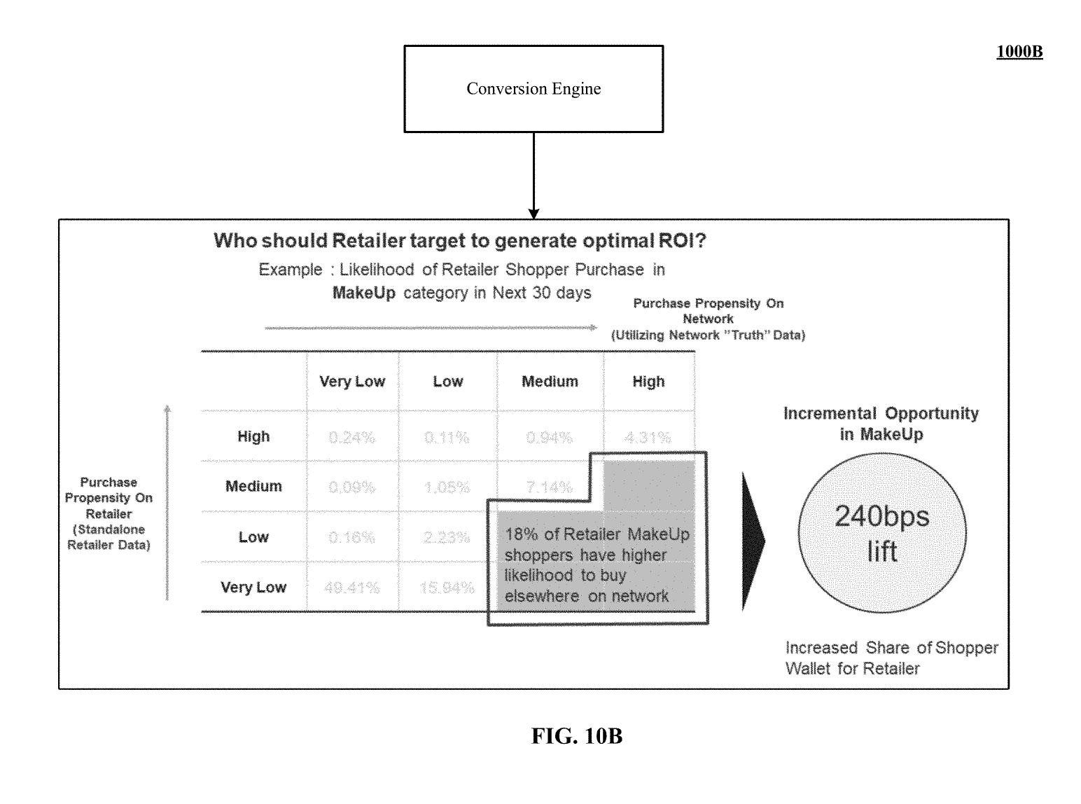

FIGS. 9, 10A and 10B show a conversion engine that uses the aggregated profile of FIG. 4 to identify in-retailer and overall purchase propensities for converting shoppers to in-retailer purchases. In the illustrated embodiment, the system 100 determined that the in-retailer categorization of the shopper is “bronze” based on the shopper's purchase history and spending patterns just at a given retailer. However, upon evaluation of the shopper's purchase history and spending patter at other retailers, the system 100 determines that the shopper is a “high” shopper who has spent much more at the other retailers. The given retailer is informed of this insight via the distribution server and given an opportunity to attend to or target the shopper with more vigor so as to capture more of the shopper's business.

In FIGS. 10A and 10B, system 100 identifies shoppers that have a high potential to convert to a given tenant. System 100 does this by determining that certain shoppers spend much more on a product (e.g., makeup) at other retailers and spend much less on the same produce at the given tenant. The given tenant can be informed of this insight via the distribution server and given an opportunity to attend to or target such shoppers with more vigor so as to capture more of the shopper's business. In implementations, such an insight is provided proactively using the shoppers' purchase history so that the given tenant can launch a marketing or advertising campaign aimed at such high-value shoppers.

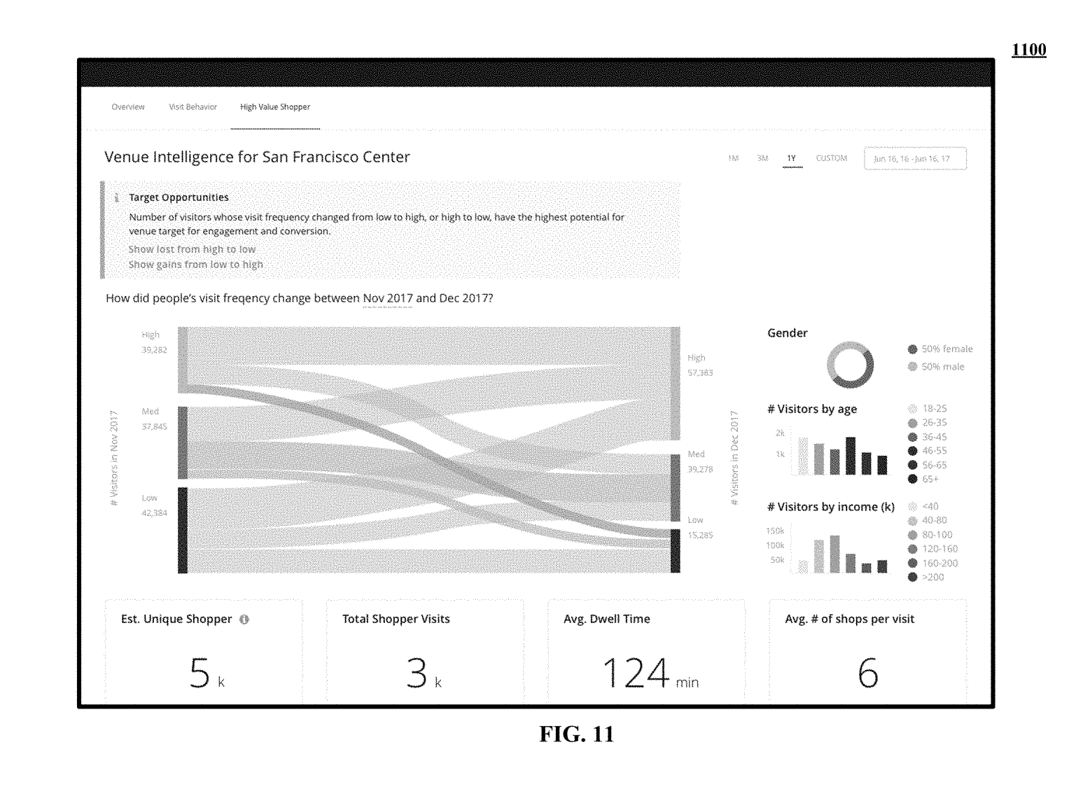

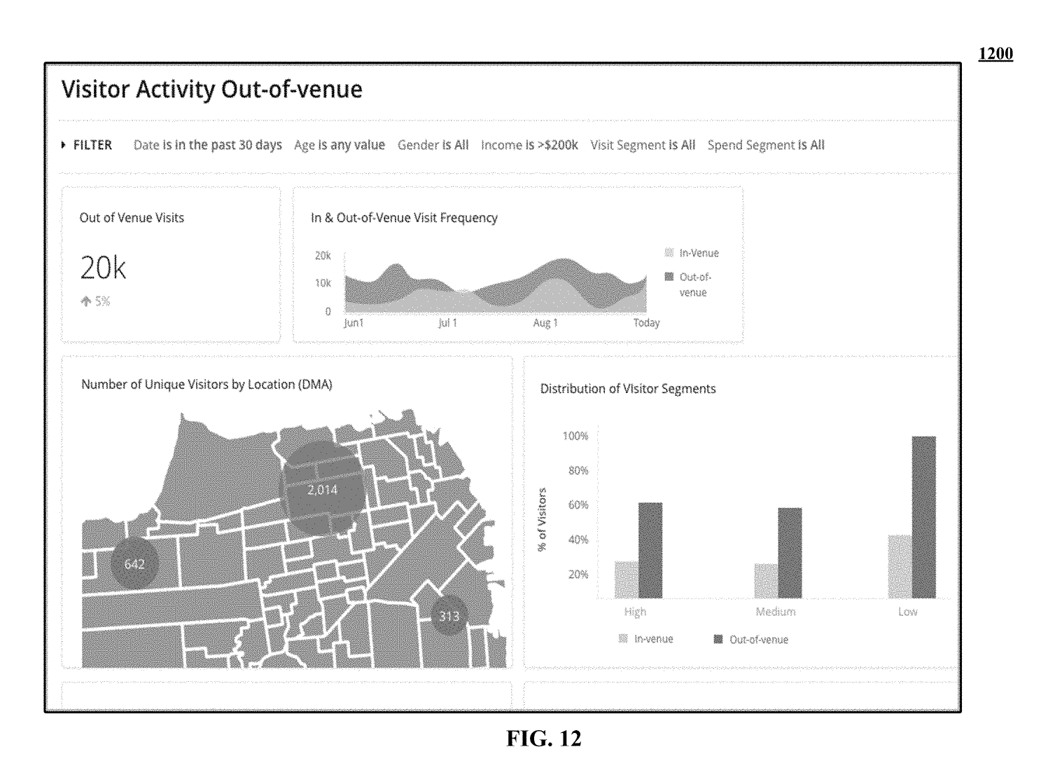

FIG. 11 depicts one implementation of a dashboard that graphically presents various venue intelligence metrics to a venue operator. The time period for this display is one year. The main graphic in the display shows how visit frequencies change between November, 2017 and December, 2017. The overall trend is that more visitors converted from the low to the high visitation frequency category, which would be expected with the approach of holidays. Additional graphics indicated the gender, age and income of visitors. Statistics across the bottom indicate the estimated number of unique shoppers, the total shopper visits, the average time at the venue, and the average number of shops visited per journey. Aggregated profiles for these 5000 shoppers can be configured to retain binned data of this sort. Alternatively, event records can be queried to produce this kind of display.

FIG. 12 illustrates one implementation of a dashboard that graphically presents various visitor activity metrics to a venue operator. This display compares in-venue to out-of-venue activity. This display is filtered by time and income. It reflects 20,000 out-of-venue visits in the past 30 days by persons who also visited the venue, which is a 5% uptick from an earlier month. A wave graph for June through December shows the relative frequency of in- and out-of-venue visits by these known visitors. The graph in the bottom left corner indicates where some of the visitors came from. The final graph indicates a distribution of visitor segments. Because this display shows daily or weekly frequencies, it is constructed from event records.

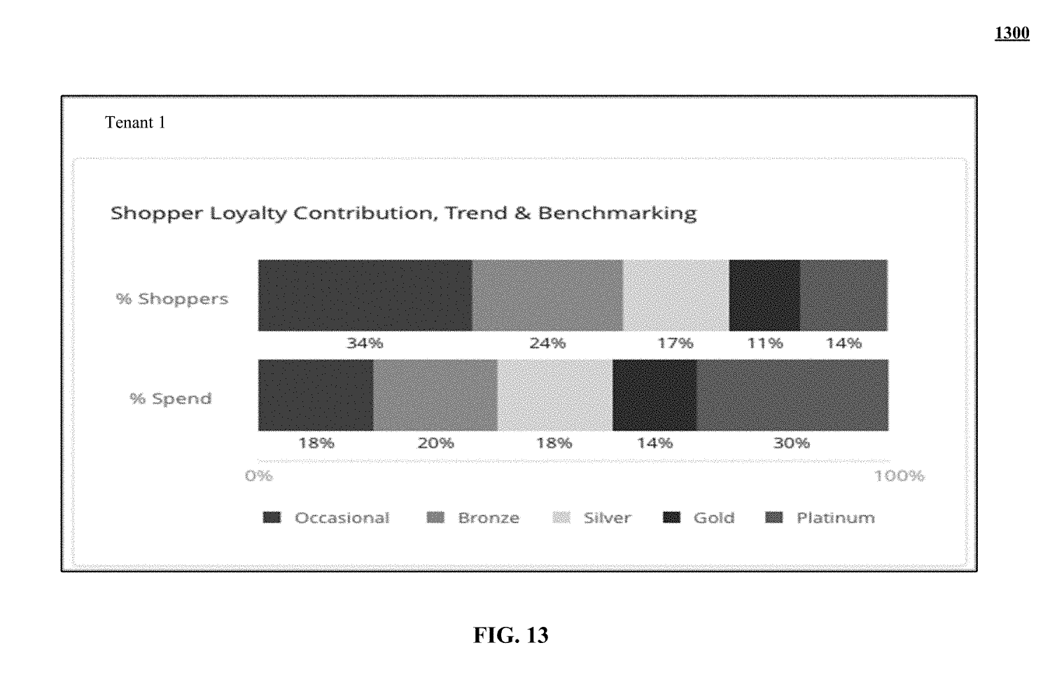

FIG. 13 is one implementation of a dashboard that graphically depicts various shopper attributes across a plurality of shopper stratums. This graph indicates the relative revenue produced by visitors with different ranks of shopper loyalty. This graph organizes shoppers by occasional, bronze, silver, gold and platinum categories. While the platinum category accounts for only 14% of the shoppers, those shoppers generate 30% of this retailer's revenue, at least at one location. A dashboard like this encourages devotion of extra attention to platinum shoppers.

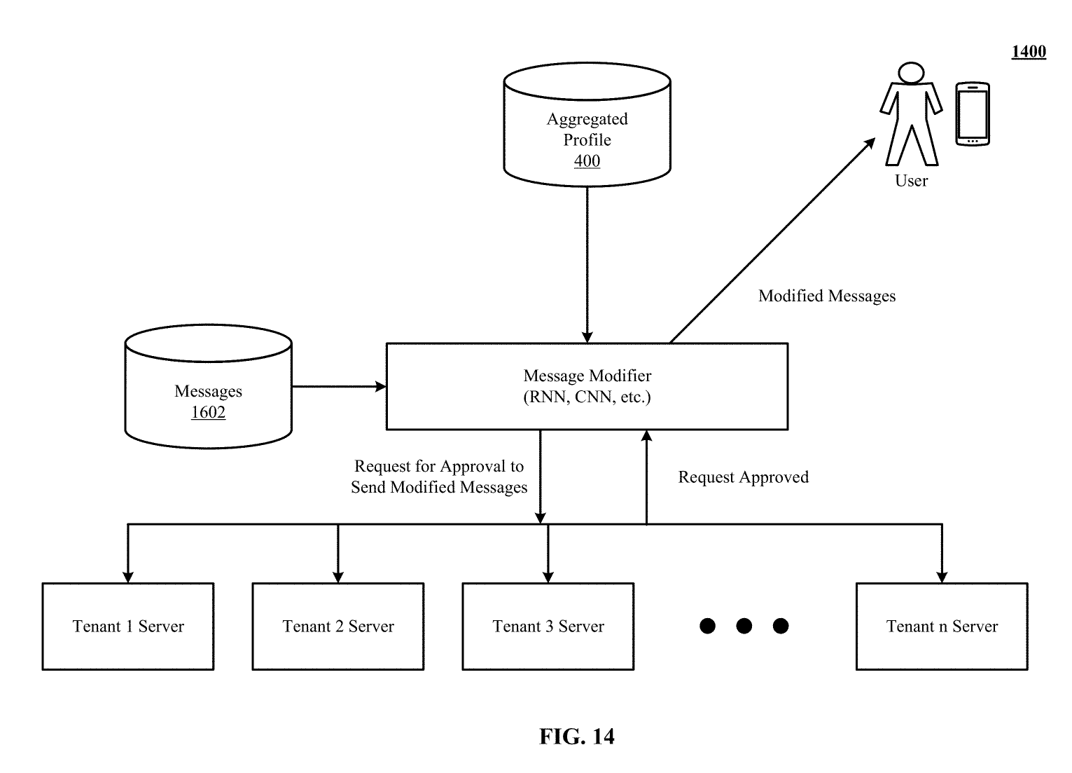

FIG. 14 illustrates a message modifier that uses the aggregated profile 400 of FIG. 4 to determine shopper intent and propensities, and in response, to modify messages and engagement schemes used by the tenants to interact with the visitors. The technology disclosed can be applied to tenants working with a common venue operator, or to independent retail stores in a shopping district who own their own buildings or have different landlords, or to sublocations within a single venue, such as exhibit areas in a museum or wings of an historic or public venue. Messages or message templates 1602 are selected or received by a message modifier. The identity of a target user or visitor is conveyed by the message modifier, along with information from the aggregated port profile 400, to servers representing multiple tenants at the venue. An artificial intelligence system may further process data regarding recent activity by the user, in view of binned data in the aggregate profile. This processing can modify intent propensities precalculated in the binned data to take into account the course of a journey or recent online browsing. Modified intent propensities can be part of the data conveyed to the servers representing multiple entities. The message modifier determines which of the proposed or candidate messages from tenant servers will be sent as modified messages to the user or visitor.

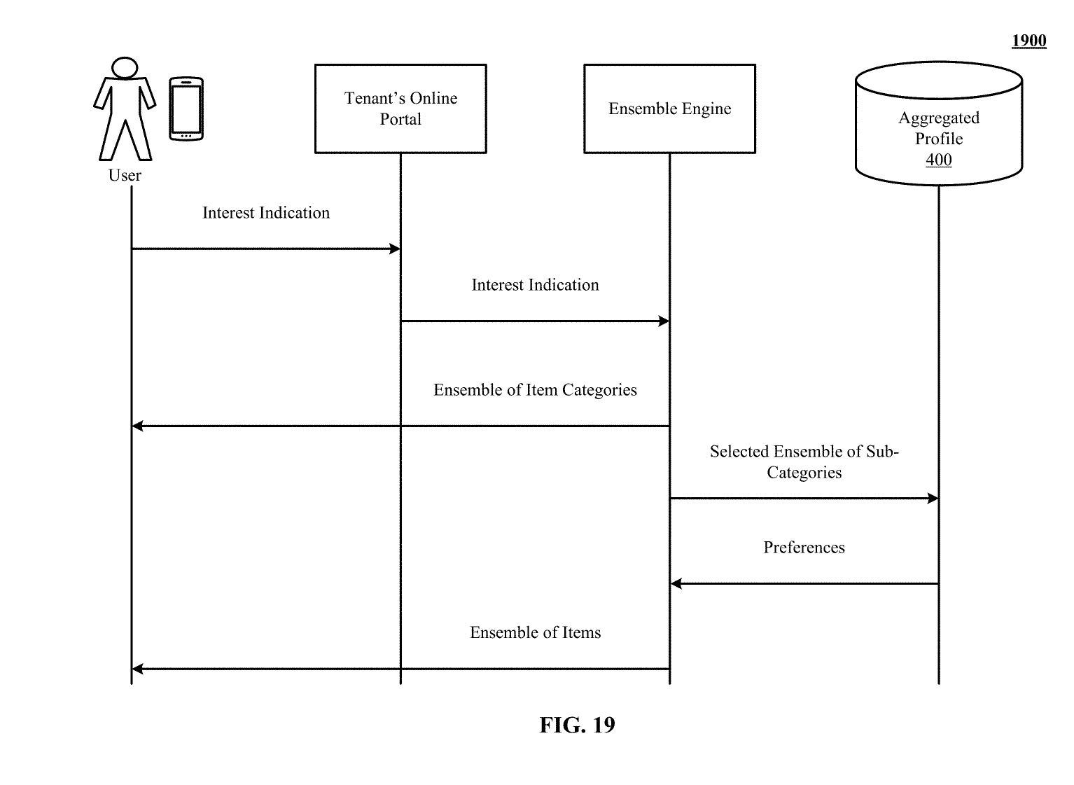

FIG. 19 depicts a message sequence chart of enhancing a user browsing experience using an ensemble engine that generates product recommendations based on a shopper's purchase history, intent and propensity data identified in the aggregated profile 400. When the user access a tenant's online portal (e.g., website) and indicates an item of interest, the portal pings an ensemble engine with with the item of interest. In response, the ensemble engine provides to the user, via the portal, an ensemble of item categories that complement the item of interest. Based on the user's selection of certain ensemble of sub-categories, the ensemble engine looks up the sub-categories in the aggregated profile 400 and retrieves for user preferences. These include category preferences of the user among recommended categories in the ensemble of item categories, feature preferences of the user that apply to the recommended categories, and feature preferences to select items. The ensemble of items selected using the determined category and feature preferences of the user are then presented to the user by the ensemble engine via the portal.

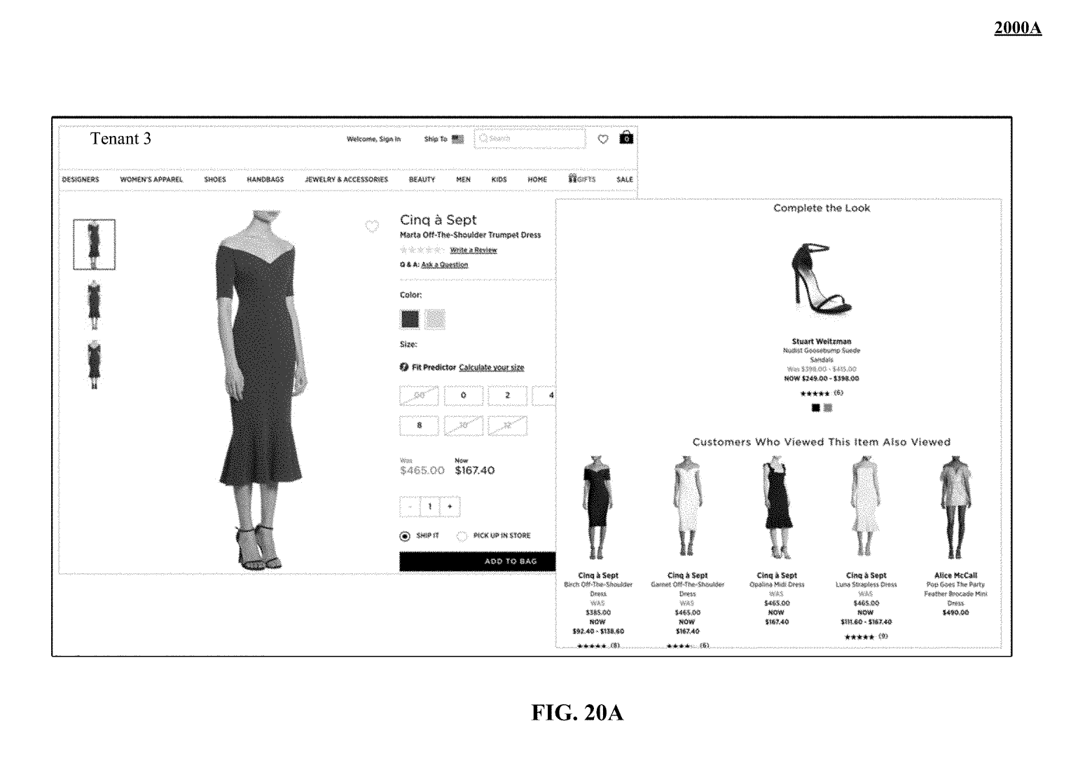

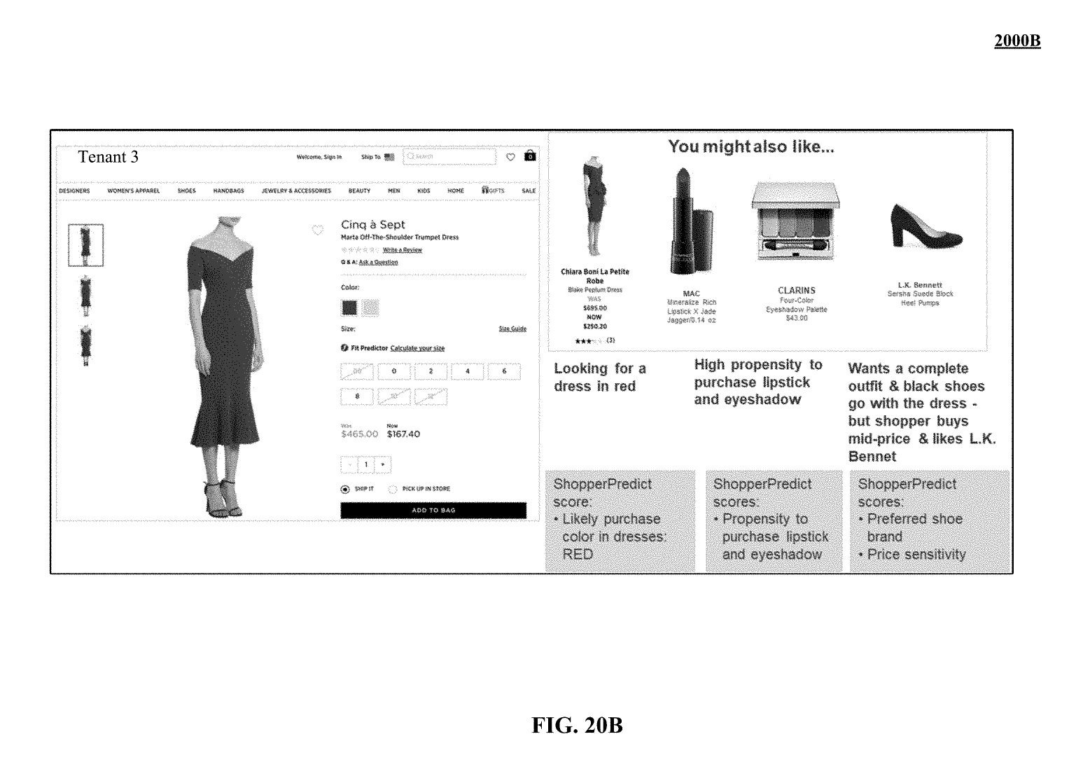

FIGS. 20A and 20B show one example of how the user browsing experience is enhanced by the ensemble engine of FIG. 19. In FIG. 20A, user experience without use of the ensemble engine is shown. In FIG. 20A, the user selected a red dress and is recommended a high heel shoe to complement the red dress. In FIG. 20B, the user experience is enhanced by invoking the ensemble engine. Upon invocation, the ensemble engine determines from the aggregated profile 400 that the user prefers low heel shoes and some other make up accessories (e.g., lipstick, preferred shoed brand, price sensitivity). Based on this information, the recommendations to the user are revised to include product that match the user's preferences.

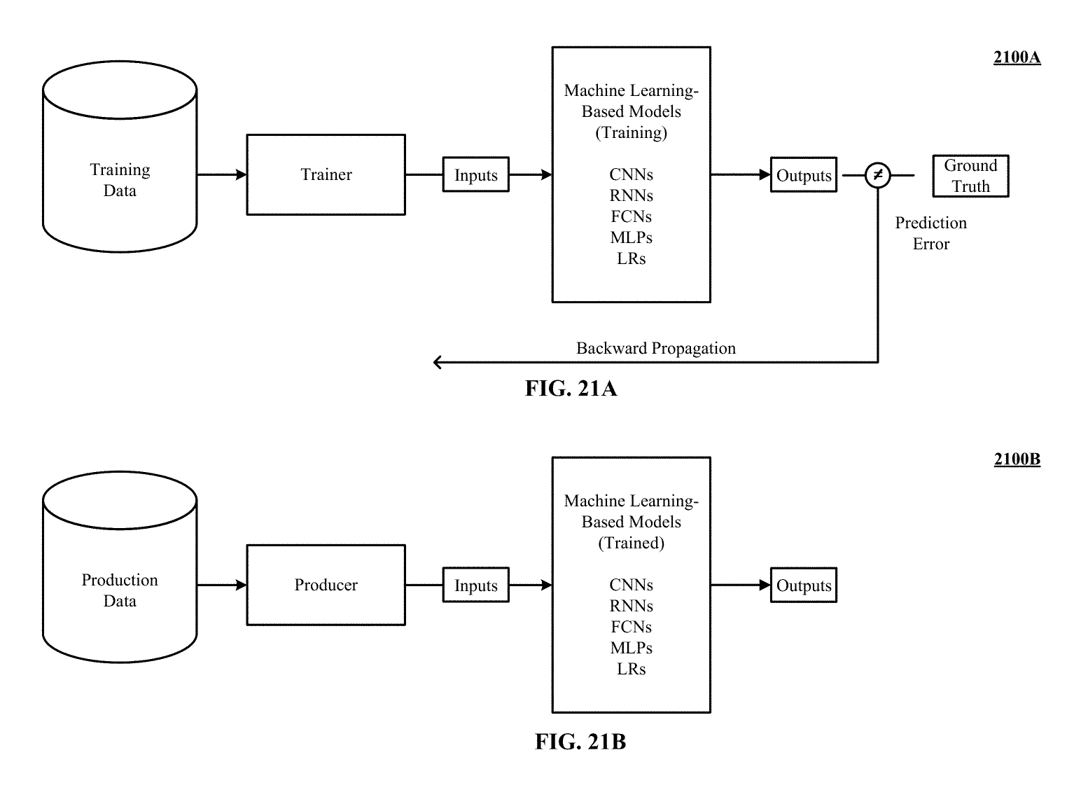

FIG. 21A shows one implementation of a training stage 2100A in which machine learning-based models are trained on training data to output user intent and propensity information. FIG. 21B shows one implementation of a production/inference stage 2100B in which trained machine learning-based models from FIG. 21A are used to evaluate production data and output user intent and propensity information. Examples of machine learning-based models include logistic regression-based models, convolutional neural network-based models, recurrent neural network-based models (e.g., models that use long short-term memory networks or gated recurrent units), fully-connected network-based models, and multilayer perceptron-based models. The training data may be the binned profile data 402 in FIG. 4. The binned profile data consists of online and offline purchases as well as online browsing and offline browsing, standardized using common identity resolution and product taxonomy. An example analysis period may be 12 months, with input data grouped into daily/weekly/monthly input time bins. The propensity score 3012 predicts a purchase occurring within a result time bin. For the analysis period of 12 months, the result time bin may be a current month. Offline browsing data comprise data from personal devices with location sensing capabilities, such as smartphones and wearable devices. The location-specific data have detailed knowledge of a visitor's journey and visitation patterns in an indoor venue. The personal devices can estimate their locations through beacons, communications with one more GPS satellites, proximity to one or more WiFi sources, multilateration of radio signals between several nearby cell towers, IP addresses of the personal devices, and so on. The location-specific data may be collected by the indoor venue through beacons and WiFi access points inside the indoor venue. The location-specific data may also be obtained from third-party vendors.

In implementations, the machine learning-based models are trained to predict user intent and propensity. The training stage 2100A includes transforming time series of event data using a processor to form a training set (or data). Transformation includes binning hyper-location information by user from physical browsing by the user at a venue having multiple sublocations in time-oriented product category bins, further binning online browsing and consequent conversion history information of a user in time-oriented category bins, and further binning point-of-sale (POS) terminal information by user in the time-oriented category bins. The category bins can be hierarchically arranged from at least dozens of main categories through hundreds or thousands of conversion-specific items. The models are then trained on a combination of the binned online browsing and consequent conversion history, the PoS terminal information, and the hyper-location information to output category intent propensities on a per user basis. In some implementations, the binned purchase amount information is combined with the category purchase propensities and the models are trained using the combination to output an expected product category purchase value on the per user basis. In some implementations, the outputs are generated in dependence upon account seasonal factors.

At the production stage 2100B, the trained models are used to evaluate the production data and output intent and propensity data such as category intent propensities on a per user basis and expected product category purchase value on the per user basis.

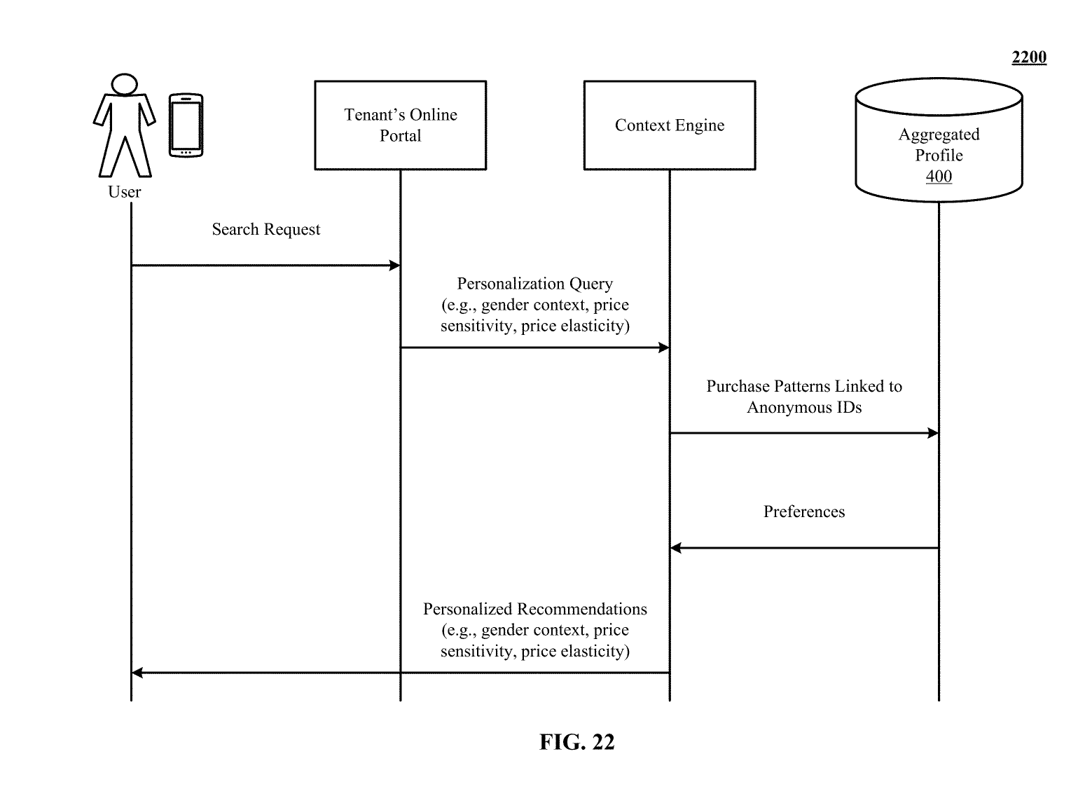

FIG. 22 is a message sequence chart of using the aggregated profile 400 to make personalized recommendations to a shopper. When the user access a tenant's online portal (e.g., website) and searches for a product through a search request, the portal pings a context engine with a personalization query to request some additional context about the user. Examples of user context include gender context (i.e., the user is male or female), price sensitivity context (i.e., what price ranges the user usually makes purchase in), and price elasticity context (i.e., what kind of discounts will propel the user to make a purchase). In response, the context engine access the aggregated profile 400 using purchase patterns linked to an anonymous ID of the user and retrieves purchase preferences of the user from the aggregated profile 400. The context engine then determines personalized recommendations for the user, which are presented to the user via the portal.

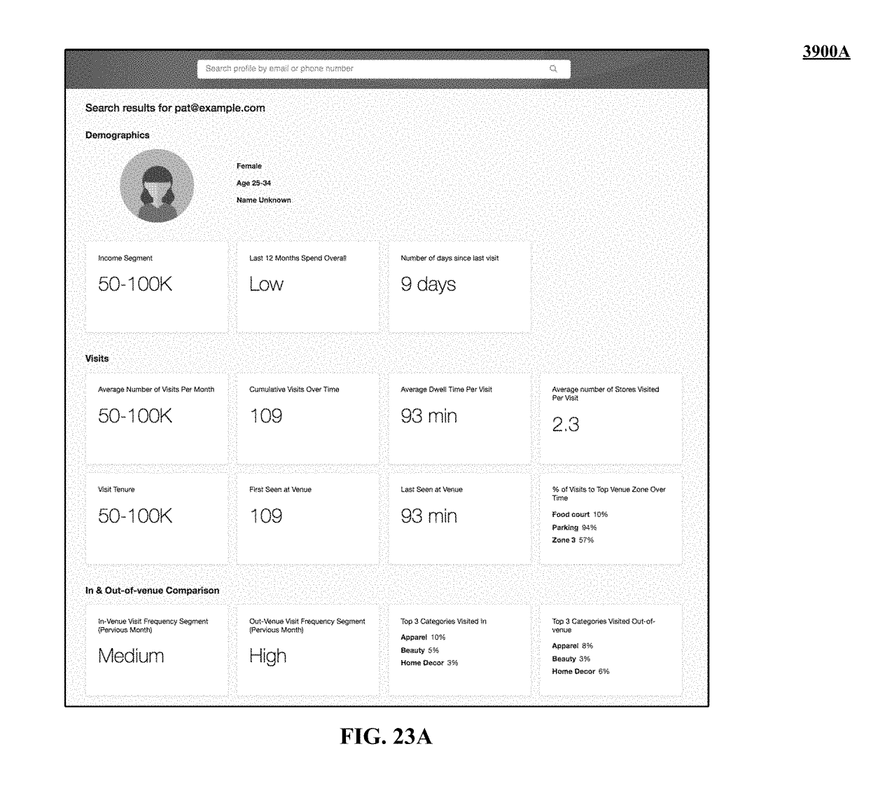

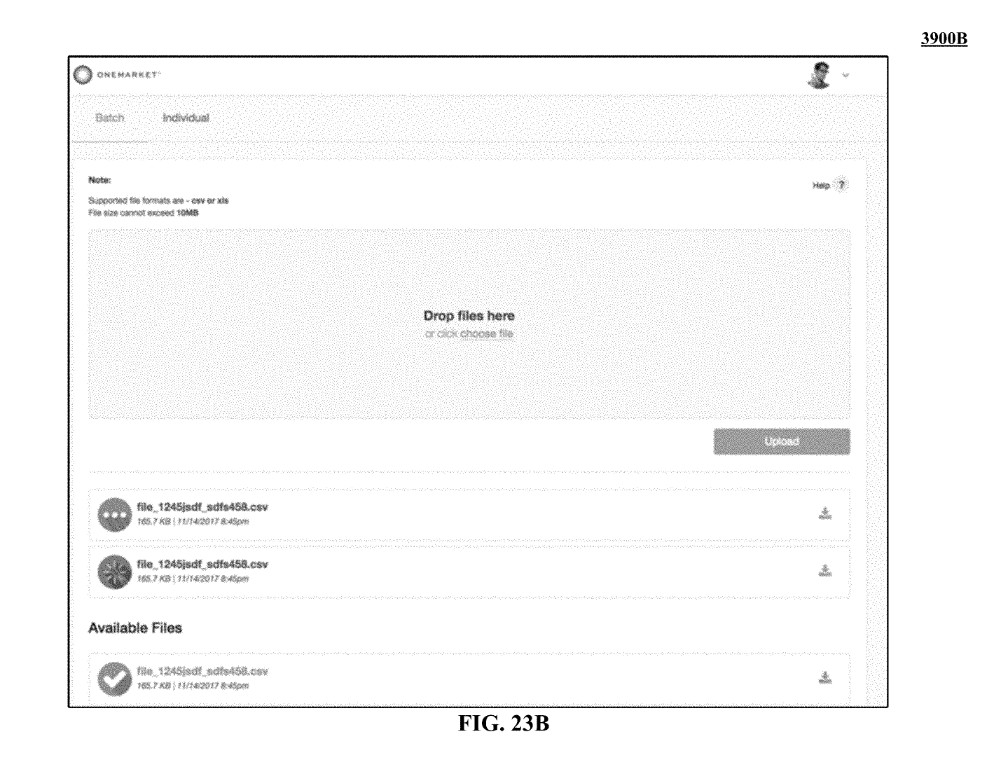

FIG. 23A shows one implementation of a shopper profile 2300A accessible to a retail store operator. Shopper profile 2300A includes various shopper metrics such as biographic information about the shopper, the shopper's income segment, the shopper's purchase history, the shopper's visit history, etc. FIG. 23B is one implementation of an interface 2300B that can be used by a retail store operator to request new or updated shopper profiles. In one implementation, the store operator can use a drag and drop feature to upload a list of shopper to the system 100. In response, system 100 can generate new or recent shopper profiles (such as shopper profile 2300A) for the shoppers identified in the uploaded list and present them to the store operator. The retrieval of a shopper profile can also be for an individual shopper, without the upload requirement.

Location Tracking Using Multilateration from BLE Beacon Signals

The convergence algorithm disclosed combines distance estimates based on measured RSSI of three or more beacons with iterative convergence on a final estimated location of the mobile device. The stronger the signal, the closer the device is to a beacon. A similar approach can be applied to WiFi access points having known or announced transmission power. A beacon's RSSI value is inversely proportional with the negative logarithm of its distance from the mobile device. Accuracy of a location estimate is evaluated after convergence to determine the extent to which the estimate is actionable. A calculated path loss exponent of 4.5 was used to relate measured RSSI to distance for certain beacons in urban malls, using data collected from hundreds of points in several malls. Alternative path loss coefficients can be calculated for other signal sources, such as access points, and for other environments, such as downtown shopping districts or strip malls. A PLE of 4 to 4.7 or of 3.5 to 4.8 also could be used, with lower PLEs applicable to more open environments such as shopping districts. Different signal sources, uniquely identified or categorically identified, can have different path loss exponents. Signal sources with variable power can have different path loss exponents at different times.

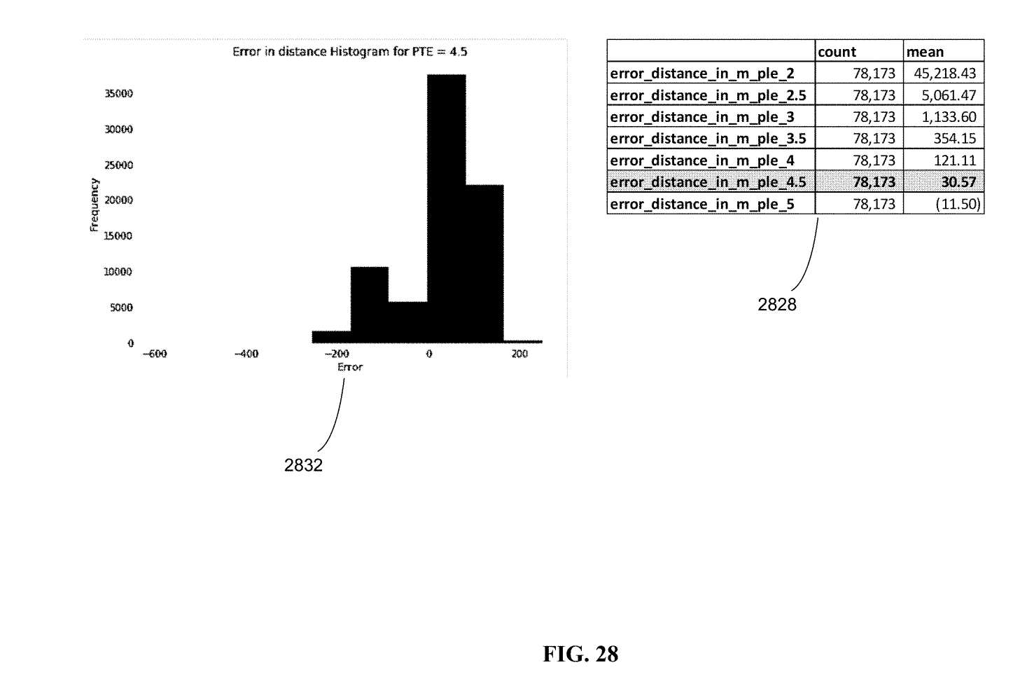

FIG. 28 shows a histogram 2832 and a chart 2828 evaluating alternative path loss exponents, based on numerous readings in malls during store operating hours, leading to selection of 4.5 as an exponent for certain circumstances. We provide the following example of how to set a path loss exponent, PLE. Being a measure of signal attenuation, the PLE varies depending on the environment as well as the objects placed in the environment. A PLE value of 2 is has been reported for free space, while larger PLE values are found in environments with more attenuation. Potential PLE values were evaluated for use in the equation:

RSSI=−10 n ln(d)+A

The development team substituted alternative PLE values into this equation to calculate beacon distances. They then calculated RMS differences from error variances between these calculated distances and distances calculated by a location SDK running on the mobile device. The location measurement made by the location SDK for indoor locations was more noisy and less accurate than the estimated device location calculated by the convergence algorithm, but could be useful for evaluating PLE values.

The chart 2828 shows what we call an average uncertainty distance RMS measure, labeled RMS difference values (in meters), for PLE values ranging from two to five. Calculation of an uncertainty distance RMS measure (not to be confused with an uncertainty distance) relates an estimated location to circumferences drawn around each of the beacons, as described below. Although the mean RMS difference for the PLE value of 4.5 was larger than that for a PLE of 5, the PLE of 4.5 was chosen for the mall because a PLE of 5 would overestimate the amount of signal attenuation. The convergence algorithm disclosed converges better with an underestimate of signal attenuation than with an over estimate, with an overestimate of distance from a beacon than an underestimate of distance. The histogram 2832 shows a distribution of different RMS values for a PLE of 4.5.

The mobile device can filter a set of beacons to the same floor (or plane) as the mobile device, for instance, in a multi-level mall. It can use the RSSI values of in a filtered set. In some implementations, all beacons visible on the same floor are used. Beacons with zero or saturated signal strength can be filtered out. In some implementations, filtering also can reduce the set to a maximum number of beacons or just a portion of the beacons with the strongest signal. For instance, a maximum of 5, 10 or 15 beacons can be used or a range of 5 to 10 or 5 to 15 beacons. Alternatively, an RSSI threshold could be set and applied if more than 5 or 10 or 5 to 10 beacons satisfy the threshold. Or, a proportion of strongest beacons can be used, such as half or two thirds of the beacons visible or of the beacons that satisfy the RSSI threshold. Multilateration begins with a set of beacons that have measured RSSIs.

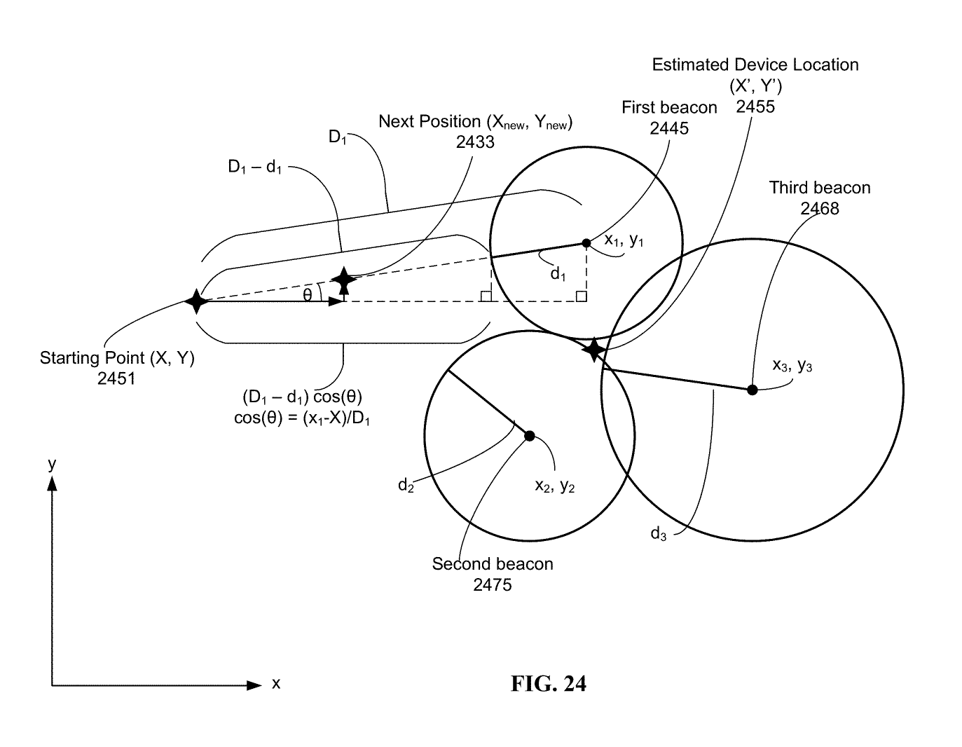

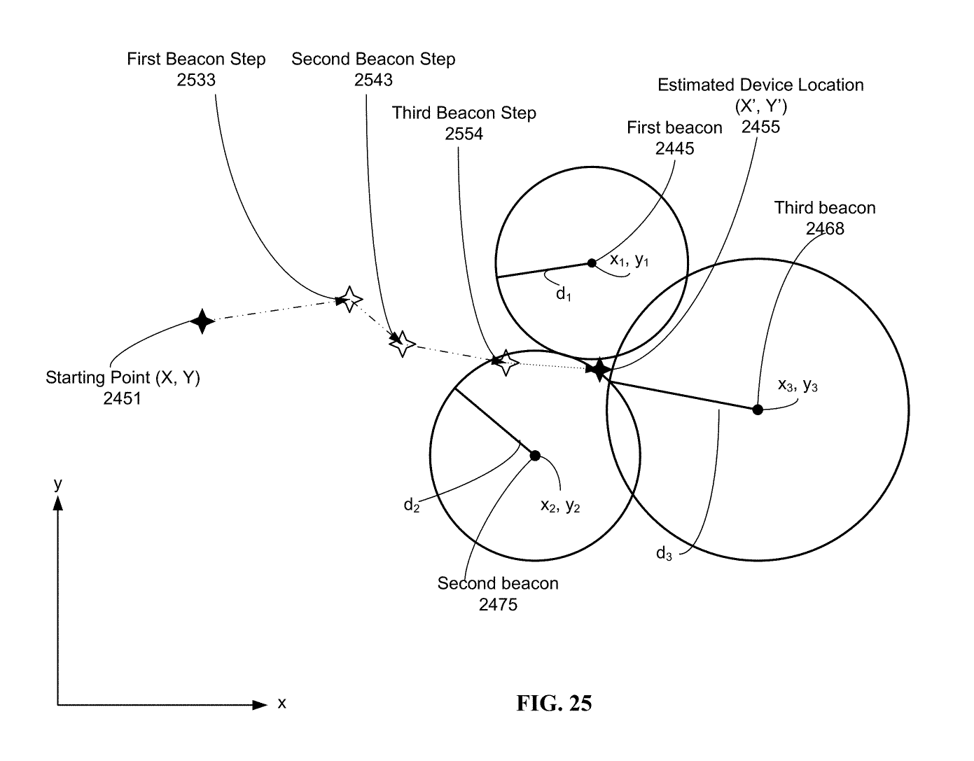

When performing convergence, a starting point is chosen, for instance outside all of the measured distances from the beacons or at a centroid of beacons being used in the particular calculation. The convergence algorithm successively moves the current estimate toward individual beacons. One convergence iteration include steps that move the current estimate toward each beacon, in turn, that is being used for multilateration. FIG. 24 shows a first step, towards a first beacon. FIG. 25 shows second and third steps, completing one iteration using three beacons.

FIG. 24 illustrates a first step of iteration using first, second and third beacons 2445, 2475 and 2468. The beacons have the coordinates (x₁, y₁), (x₂, y₂), and (x₃, y₃). A starting point 2451 is located at (X, Y), and a final estimated position 2455, after convergence is located at (X′, Y′). The starting point 2451 may be arbitrarily chosen. In one implementation, the starting point 2451 is the centroid of all the beacons used during the scan within the scan area. In the figure, the starting point is to the left of circumferences, with radii d₁, d₂, and d₃, drawn around the beacons. In other implementations, the starting point 2451 is chosen to be the point (0, 0) on a coordinate system. Preferably, the starting point is outside the circumferences drawn around the beacons, but convergence can be achieved even when the starting point is within a circumference, recognizing that the starting point is inside circumference(s) and adjusting a parameterized step rate accordingly. The parameterized step rate controls the magnitude of a movement towards a beacon.

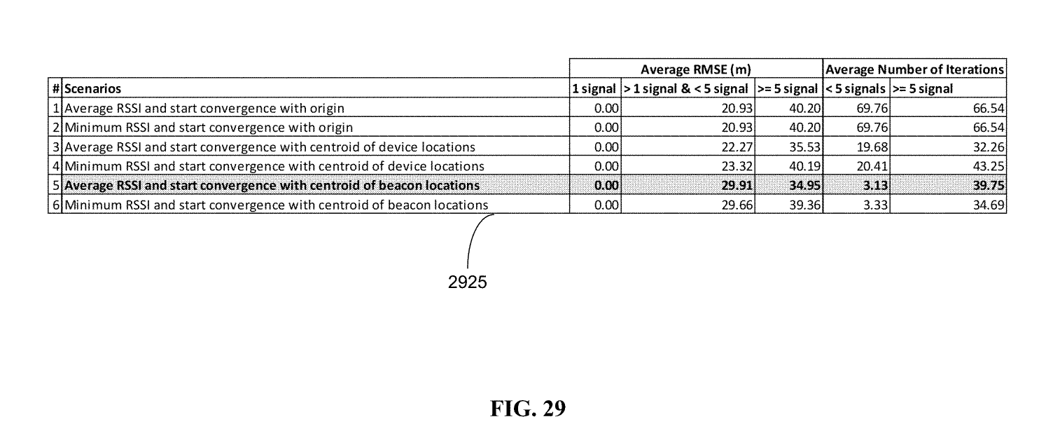

The distances d₁, d₂, and d₃ are derived from measured RSSI values using the PLE in the formula above. In FIG. 24, distances derived from RSSI values are depicted as circles with radii d₁, d₂, and d₃ drawn around the respective beacons. The device sometimes measures multiple RSSI values for one beacon during a scan period. A scan period of six seconds was used in development. A shorter or longer scan period can be used, depending on the frequency of beacon broadcasts and the efficiency of the mobile device in processing scans. For instance, a scan period can be 2, 4, 6, 8 or 10 seconds or in any range between two of these values. When multiple measurements are received from a beacon during a scan, the mobile device can use the beacon's average RSSI value, its minimum value, or its maximum value as input to the iterative convergence. FIG. 29 shows a chart 2925 with results from six useful hyperparameter options for the convergence algorithm, combining two rules for handling multiple RSSI readings from the same beacon with three alternative starting estimate positions from which to converge on a final estimated location.

FIG. 24 further illustrates movement by a selected distance towards a beacon in each step, beginning from a starting point 2451. In this implementation illustration, the selected distance is half the distance between the current estimate and a closest point on the circumference of a circle around beacon n with a radius of dₙ. For example, the starting point 2451 first moves toward the first beacon 2445. The distance moved is half the distance between a current estimated location and the circumference of the circle, which we sometimes call the uncertainty distance (not to be confused with an uncertainty distance RMS measure). The vector of movement can be along a segment connecting the current estimate with the center of the circle. The distance moved can be expressed as ½(D₁−d₁), where D₁ is the distance between the starting point 2451 and the first beacon, (D₁−d₁) is the uncertainty distance, and ½ is the parameterized step rate. In one implementation, x and y components are processed separately. The x and y parts of the distance can be calculated using cosine and sine functions of the angle θ with the x-axis. Or, a difference in coordinate positions can be calculated by subtraction. Substituting the expressions

$$sin θ = ( \frac{{y}_{1} - Y}{{D}_{1}} ) and cos θ = ( \frac{{x}_{1} - X}{{D}_{1}} )$$

yields the equations that step the device's estimated position from the initial position 2451 to the next position 2433. One formula that can be applied without sine and cosine functions is:

$$\begin{matrix}{X}_{new} = X + \frac{1}{2} ( \frac{{x}_{1} - X}{{D}_{1}} ) ( {D}_{1} - {d}_{1} ) & ( 1 ) \\ {Y}_{new} = Y + \frac{1}{2} ( \frac{{y}_{1} - Y}{{D}_{1}} ) ( {D}_{1} - {d}_{1} ) & ( 2 )\end{matrix}$$

Successive steps of convergence repeats these calculations for additional beacons.

In other implementations, the parameterized step rate may be less than or greater than ½. Choosing a fraction less than ½ may result in a more accurate position estimate, but will increase the number of iterations of the algorithm. Conversely, choosing a fraction greater than ½ will decrease the number of iterations of the algorithm, but may result in a less accurate position estimate.

FIG. 25 continues the iteration that began in FIG. 24. In the second step 2543, the current estimate steps halfway toward the circumference around the second beacon 2475, which has a radius d₂. In the third step 2554, the current estimate steps halfway toward the circumference around the third beacon 2468. The algorithm iterates until the estimated device location 2455 reached when a convergence condition is satisfied. Iteration can be terminated after a maximum number of iterations without reaching convergence. A limit such as 100 or 1,000 or 5,000 iterations can be set, or in a range of 100 to 1,000 or 100 to 5,000. The range selected can relate to resource consumption, including battery drain and control loop time.

The convergence algorithm concludes iteration when it meets a convergence condition. For instance, a convergence condition can be satisfied when an RMS margin is less than a meter or one-tenth of a meter. Calculation of an uncertainty distance RMS measure is explained below. The RMS margin is the difference between uncertainty distance RMS measures in successive iterations. Another convergence condition that can be used is when the RMS average distance to beacon circumferences calculated by the convergence algorithm falls below a threshold. One example of a threshold may be 30 meters. Other example thresholds are 20 meters and 10 meters or in a range of 10 to 30 meters or 20 to 30 meters.

One convergence condition is the distance moved over the course of an iteration cycle is less than a predetermined threshold. A movement threshold of 0.1 m (10 cm) has been used as the convergence condition. A threshold in a range of 0.01 m (1 cm) through 1 m (100 cm) could be used. A variety of thresholds could be chosen, as modest resources needed to perform one or a hundred iterations.

Another convergence condition that could be used is an uncertainty distance RMS measure, mentioned above. A convergence condition could be satisfied when the uncertainty distance RMS measure is less than a threshold, such as 30 m or 5 m. This condition, which produces a good enough result, could be combined with a movement threshold condition that produces a result not likely to improve much. Or, a convergence condition could be satisfied when a change in uncertainty distance RMS measure between iterations is less than a threshold.

When the algorithm has reached a convergence condition, the convergence algorithm returns the x and y coordinates obtained during its final iteration. These coordinates represent the estimated device location 2455 for the mobile device's position.

Returning to the mechanics of calculations, the uncertainty distance RMS measure is an RMS-like value. It is an RMS average of distances from an estimated position to circumferences drawn around beacons used in the multilateration. The following measure was used in selection of a PLE and can be used to determine the degree to which a final multilateration result is actionable:

$$\sqrt{\frac{1}{k} {\sum }_{i = 1}^{k} {( Distance [ ( {x}_{i} , {y}_{i} ) , ( {X}_{new} , {Y}_{new} ) ] = {d}_{i} )}^{2}} \qquad ( 3 )$$

In formula (3), k represents the number of beacons used in multilateration. In FIGS. 24-25, k=3. The function (Distance [(xᵢ, yᵢ), (X_{new}, Y_{new})]), also symbolized as Dᵢ, represents the distance from an estimate location to a beacon i at the center of a circumference of radius dᵢ. We previously represented (Distance [(xᵢ, yᵢ), (X_{new}, Y_{new})]−dᵢ)=Dᵢ−dᵢ, the uncertainty distance. The convergence algorithm also can calculate an RMS margin, as a difference between the current iteration's uncertainty distance RMS measure and the previous iteration's uncertainty distance RMS measure.

During an iteration, the convergence algorithm can use gradient descent to direct motion of the estimated location toward a beacon. In one example of gradient descent, the convergence algorithm calculates a quadratic cost function for an individual beacon i using the expression Dᵢ−dᵢ:

Costᵢ=(Dᵢ−dᵢ)²=(Xᵢ−xᵢ)²(Yᵢ−yᵢ)² (4)

where Dᵢ is a vector with x and y components <Xᵢ, Yᵢ>, and dᵢ is a vector with x and y components, <xᵢ, yᵢ>. Cost function (4) calculates the square of a discrepancy vector between the estimated location and the beacon circumference. The average of all beacon costs per iteration reflects the accuracy of the location estimate, and is equal to the square of equation (3):

$$Average cost = \frac{1}{k} {\sum }_{i = 1}^{k} {( {X}_{i} - {x}_{i} )}^{2} + {( {Y}_{i} - {y}_{i} )}^{2} \qquad ( 5 )$$

A smaller average cost means that estimated location is, on average, closer to each beacon circumference, and, thus, more accurately multilaterated. Gradient descent iteratively reduces the average cost, improving the estimate. The algorithm takes the gradient of the cost function (4)

$$\begin{matrix}\frac{\partial }{\partial {X}_{i}} [ {( {X}_{i} - {x}_{i} )}^{2} + {( {Y}_{i} - {y}_{i} )}^{2} ] = 2 ( {X}_{i} - {x}_{i} ) & ( 6 ) \\ \frac{\partial }{\partial {Y}_{i}} [ {( {X}_{i} - {x}_{i} )}^{2} + {( {Y}_{i} - {y}_{i} )}^{2} ] = 2 ( {Y}_{i} - {y}_{i} ) & ( 7 )\end{matrix}$$

and, for each beacon during an iteration, uses it to calculate a new position estimate.

X₍ᵢ₊₁₎=Xᵢ+γ×2(Xᵢ−xᵢ) (8)

Y₍ᵢ₊₁₎=Yᵢ+γ×2(Yᵢ−yᵢ) (9)

where γ is a learning rate, and 2γ is the parameterized step rate. Multiplying the gradient term by the learning rate ensures that the algorithm converges correctly. As the algorithm iterates, the discrepancy (Dᵢ−dᵢ) shrinks in magnitude, lowering the average cost per beacon. As described above, iteration concludes when the algorithm reaches a convergence condition. Equations (8) and (9) closely resemble equations (1) and (2) for a parameterized step rate 2γ=1/2, where

$$( {X}_{1} - {x}_{1} ) = ( \frac{{x}_{1} - X}{{D}_{1}} ) ( {D}_{1} - {d}_{1} ) and ( {Y}_{1} - {y}_{1} ) = ( \frac{{y}_{1} - Y}{{D}_{1}} ) ( {D}_{1} - {d}_{1} ) .$$

As discussed earlier, a smaller parameterized step rate may result in a more accurate position estimate, but requires more iterations of the algorithm. A larger parameterized step rate requires fewer iterations of the algorithm, but may result in a less accurate position estimate.

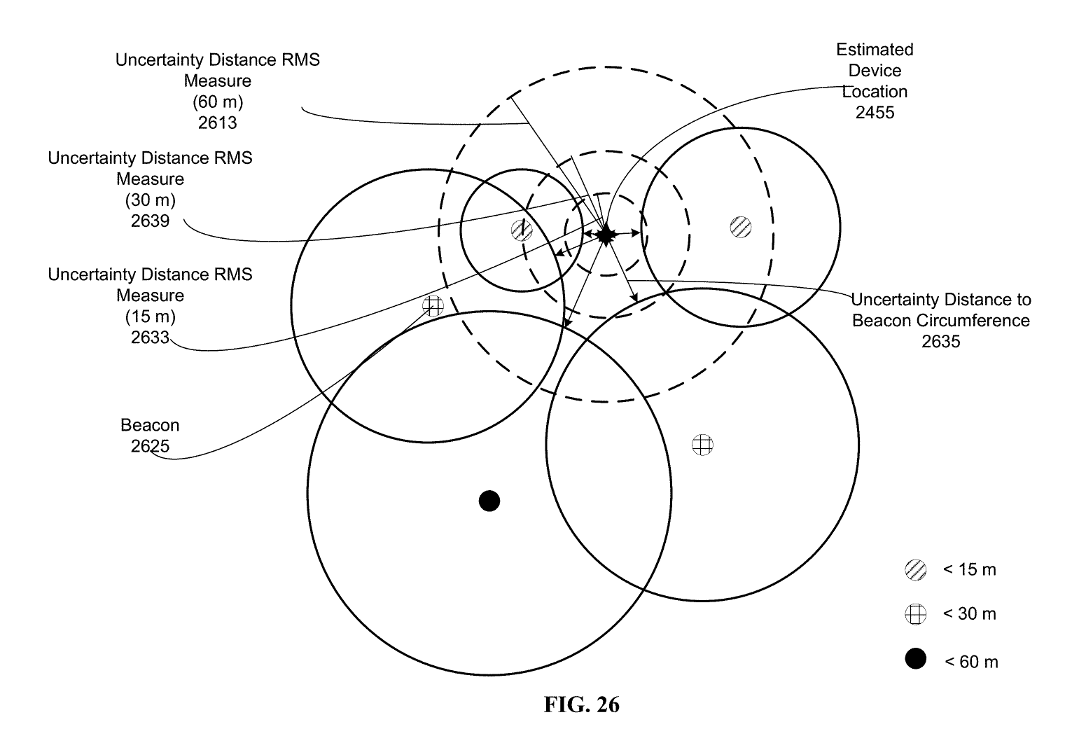

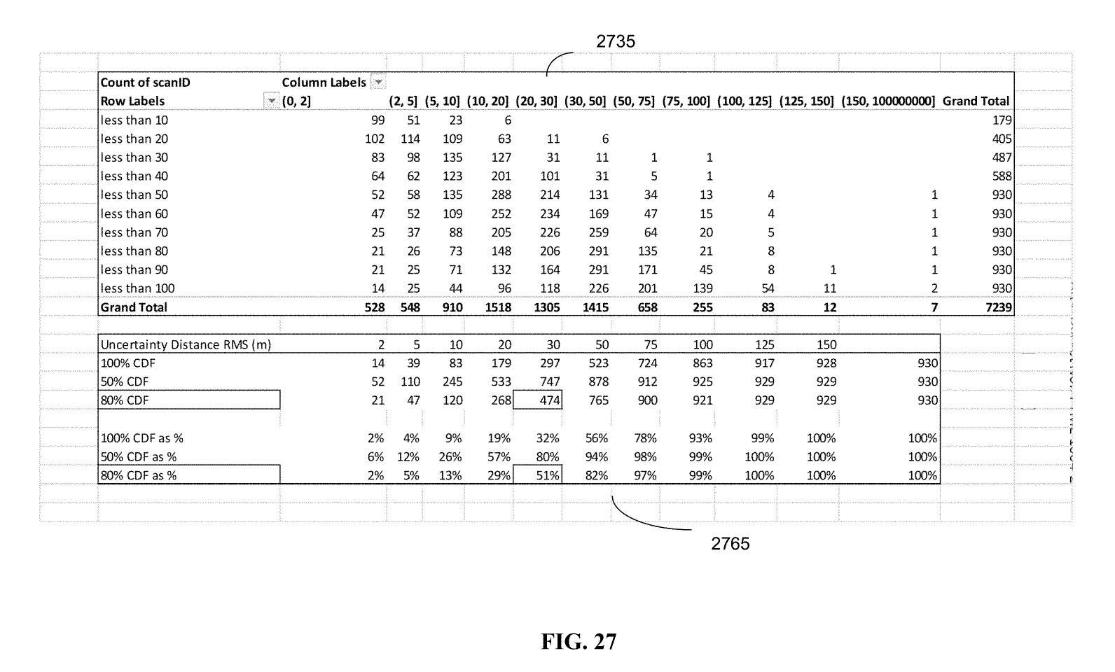

During development, uncertainty distance measures were calculated between individual final estimates and circumferences around individual beacons used in the multilateration. The uncertainty distance measure between a final estimate and a beacon i is the magnitude of the uncertainty distance between them and is expressed \sqrt{(Dᵢ−dᵢ)²}. Distributions of beacon counts were compiled in uncertainty distance range buckets such as (20 to 30] meters. In most rows of FIG. 27, there are 930 observations. There are uncertainty distance range buckets such as (20 to 30] meters. Consider the less than 80 percent row. Buckets in the 80 percent row represent the minimum uncertainty distance from the final estimate needed to capture circumferences of up to 80 percent of the beacons used in the multilateration. For instance, in FIG. 26, with five beacons used, of which four had uncertainty distances less than or equal to 30 meters 2623. One beacon, to the bottom left, had an uncertainty distance greater than 30 meters. The estimated device location 2455 would belong in the less than 80%, (20-30 m] bucket and in a bucket in the 100%, (30-40 m] bucket. The distribution represented by buckets in the less than 80 percent row also can be expressed as a cumulative distribution function, as shown below the main table in counts and percentages.

FIG. 27 should be considered with integer division in mind, as not all rows have 930 observations. In the less than 10 percent row, only 179 observations had enough observed beacons, more than 10, to produce a distribution of uncertainty distances such that less than 10 percent of the beacons (at least one beacon) fell into a particular distribution range. There were not any observations in which less than 10 percent of the beacons used (e.g., one or two beacons) had uncertainty distances were calculated to be more than 20 meters.

In the less than 80 percent row of FIG. 27, the cumulative distribution function (CDF) for up to 30 meters has 474 of 930 observations in buckets up to 30 meters, for 51 percent. That is, in slightly more than half of the observations, up to 80 percent of the beacons were in buckets of uncertainty distances less than or equal to 30 meters. This led to a selection of 30 meters uncertainty distance, applied to 80 percent of calculations involving observed beacons, as a threshold for reporting a visitor's location to interested store operators at the mall. Estimates that have uncertainty distances worse than this criteria can be withheld from visitor location reporting to interested stores at the mall. This does not exclude a visitor from location reporting, as new scans are frequent, such as every six seconds, and the calculations resulting from successive scans are independent of one another. Nor does it exclude the estimated location from all uses, as time in a mall is of interest, even when a location is inaccurate. Location during an inaccurate scan can, for dwell time and other purposes, be interpolated to reasonably accurate calculated locations.

Other thresholds can be used, which combine a CDF distance and percentage of beacons, or which are selected based on experience. For instance, a distance of 10, 15, 20, 25, 30, or 35 meters can be used or in a range between any two of these distances. A percentage of beacons with an uncertainty distance less than (or equal) to the selected distance can be 60, 70, 80 or 90 percent or in a range between any two of these percentages.

Unlike closed form solutions, the technology disclosed multilaterates a location estimate for the mobile device from an arbitrary number of beacon signals, even in the face of inconsistent data. Inaccurate distance estimates would confound a closed form solution. Once four or more signals are used, inconsistent estimated distances are virtually certain to arise, because only three distance measurements are needed to trilaterate a position in 2D space. Using the convergence algorithm's numerical method instead, a device position can be multilaterated in many types of environments with different factors affecting signal attenuation. In addition, the convergence algorithm can be modified to include different methods of filtering beacon signals and to stop iteration when it meets different convergence conditions. These factors make the disclosed technology more adaptive than closed-form multilateration methods.

Determining User Intent Propensity from Binned Time Series Data

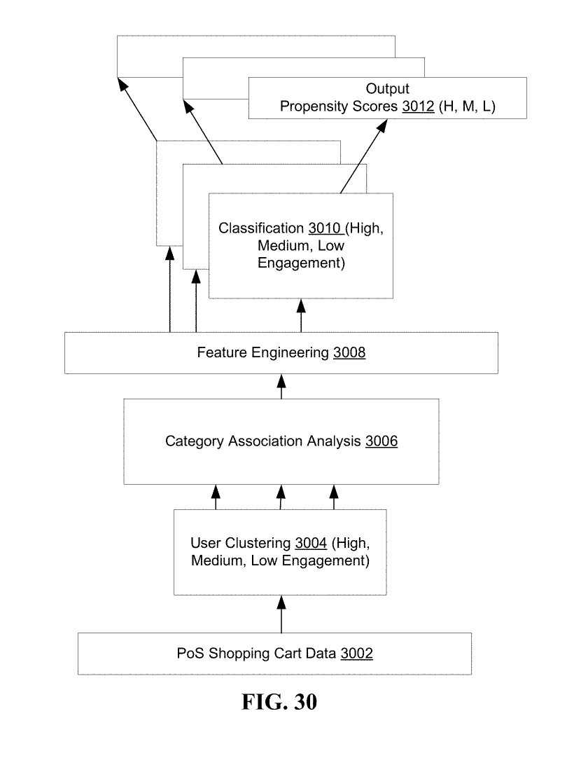

FIG. 30 shows a block diagram of a purchase propensity predictor that produces user purchase propensity scores. A user propensity score is likelihood that a user will purchase an item from a dependent category at a future time. The predictor uses time binned input data, collected from PoS terminal shopping cart data 3002 during an analysis period, to predict the propensity score 3012. The binned input data comprise data from online and offline purchases as well as online browsing and offline browsing, standardized using common identity resolution and product taxonomy. An example analysis period may be 12 months, with input data grouped into daily/weekly/monthly input time bins. The propensity score 3012 predicts a purchase occurring within a result time bin. For the analysis period of 12 months, the result time bin may be a current month. Offline browsing data comprise data from personal devices with location sensing capabilities, such as smartphones and wearable devices. The location-specific data have detailed knowledge of a visitor's journey and visitation patterns in an indoor venue. The personal devices can estimate their locations through beacons, communications with one more GPS satellites, proximity to one or more WiFi sources, multilateration of radio signals between several nearby cell towers, IP addresses of the personal devices, and so on. The location-specific data may be collected by the indoor venue through beacons and WiFi access points inside the indoor venue. The location-specific data may also be obtained from third-party vendors.

The propensity predictor of FIG. 30 has four stages: empirically derived user clustering 3004 for customer segmentation, category affinity analysis 3006 to inform variable reduction, feature engineering 3008 for pattern recognition, and finally classification 3010 for purchase likelihood prediction. In the implementation of FIG. 30, user clustering 3004 is performed prior to category affinity analysis 3006. The output of the user clustering is used for category and variable reduction/selection in category affinity analysis. In other implementations, user clustering may be performed after category affinity analysis. Two classification implementations are described in this specification: an extreme gradient tree boosting implementation (XGBoost) and a long short-term memory (LSTM) network implementation.

During the user clustering stage, users are clustered using a method called Recency, Frequency, Transaction Purchase interval (RFT) Analysis by implementing k-means clustering algorithm. By this method, users are given Recency, Frequency, and Purchase interval scores based on purchase and browsing information the retailer collects from the users over the analysis period. A user's recency score is equal to a count of time bins from the result time bin back to a most recent time bin within the analysis period in which the user made a purchase. For example, if data is binned monthly, and a user bought a dress during the current month, that user's recency score would equal zero. If the user hadn't made a purchase in four months, the user's recency score would equal four. A user's frequency score is the number of transactions that user has completed since the beginning of the analysis period. Lastly, a user's purchase interval score is the average time in days between purchases through a period of time, for example over twelve months, over six months and so on. Based on these RFT scores, the users are clustered into engagement groups of high engagement, medium engagement, and low engagement users based on their scores in all three areas, in this case done using KMeans clustering.

In one implementation, RFT clustering produces engagement groups with the following characteristics. High engagement customers have recency scores within the ˜50^{th} percentile range of scores (the highest 50% of R scores), purchase interval scores within the ˜50^{th} percentile (the highest 50% of F scores), and frequency scores above the 25^{th} percentile (the highest 25% of M scores). Medium engagement customers have recency scores between the 1^{st} and 49^{th} percentiles, purchase interval scores between the 1^{st} and 49^{th} percentiles, and frequency scores between the 1^{st} and 24th percentiles. The remaining customers are placed in the cold start group comprising of customers that have not previously bought in the category of interest.

The category affinity analysis stage helps in determining independent categories of items that are used for variable reduction and subsequently determine features analyzed by the classifier to produce a propensity prediction for the dependent category. Treated as an extension of market basket analysis in order to accommodate physical as well as digital shopper behavior, category affinity analysis first identifies shopper who have purchased in a dependent category. The category affinity analysis then looks at their other purchases at a transaction level in other categories across different time horizons, and picks the optimal time horizon based on the decrease in net new categories. Then, based on the category association score, independent categories are identified for input into feature engineering. Independent categories are categories of items which most strongly lift sales for items from the dependent category. For example, if the dependent category is dresses, independent categories may include categories within the parent Womens Clothing category such as skirts, rompers, capris, evening attire, and blazers or in other parent categories such as Mens Clothing, Home and Kitchen etc. The propensity predictor chooses independent categories by calculating the lift values of the individual independent categories with the dependent category, and selecting a predetermined number of highest-lift independent categories.

For any two categories A and B, the lift is calculated using the formula:

$$Lift = \frac{supp ( AB )}{supp ( A ) \times supp ( B )}$$

The supp( ) term refers to the support, or proportion of purchase transactions (irrespective of distinct SKUs), for items in each category: supp(A) represents the proportion of purchases containing items from category A (or support of A), supp(B) represents the proportion of purchases containing items from category B, and supp(AB) represents the proportion of purchases containing items from both categories.

The lift between two categories implies whether or not probabilities for purchasing items from the two categories are independent of one another, based on the observed support for items in both categories. If two categories have a lift greater than one, the probabilities of purchasing items from both categories are implied to be dependent. In other words, items from categories with large lift values are more likely to be bought together. For example, rompers have a high lift with dresses. Both types of garments have similar functions, so users who purchase rompers are likely to also purchase dresses.

During the feature engineering stage, the propensity predictor determines features for the machine learning model using category-specific shopping cart data from the dependent and independent categories, as well as cross-category shopping cart data and customer level features. The selected features are tabulations that represent user characteristics that relate to retail transactions. Features may include purchases, browsing, returns, and discounts received.

Some features are time-binned, or grouped based on specific time intervals (within the analysis period) into which they fall. For example, for a set of monthly time bins, a purchase occurring on February 26 would be placed in a February time bin. Cross-category time-binned features include total dollars spent last July, number of transactions last May, and total monthly discount amounts on all items purchased last December. Category-specific time-binned features include February spending on dresses and number of skirts purchased last September.

Some time-binned features relate specifically to user browsing. Browsing is done in-store or online. Browsing data features are used as inputs to both the extreme gradient boosting and the LSTM classifier implementation. Browsing data may be category-specific or cross-category. Examples of browsing data include visits to the women's shoe department four weeks ago, or total web page visits three weeks ago.

Other features are not time-binned, but summarize user characteristics for the whole analysis period. These features may also be either category-specific or cross-category features. Examples of these features include how recently a user visited a retailer, a user's average time interval between dress purchases, discount versus luxury shopper etc.

The classifier calculates purchase propensity scores for users in an engagement group by analyzing the input features. A propensity score may be expressed as a probability between zero and one. Values close to one indicate that users are likely to purchase items from the target category in the prediction period. Values closer to zero indicate that users are unlikely to purchase items from the target category in the prediction period. The probabilistic value may be transformed using a scaling function which could render the final score between 0 and 1000 for example. Scaling is a cosmetic transformation of the probabilities output by the machine learning algorithm to make the scores easier to consume by the end user.

The classifier is trained in order to be able to make accurate predictions. During training, the classifier calculates a propensity score for the dependent category by analyzing a set of training data. Training data may include time-binned as well as not time binned input features. The calculated propensity score is evaluated against a ground truth or observed values. The ground truth for the classifier may be a binary value representing whether or not a user made a purchase during the result time bin. For example, a ground truth may be equal to zero or it may be equal to one, for a binary classifier outputting propensity scores between zero and one. Training may be performed for several epochs, or iterations of analysis of all of the input features, and may include extensive hyper tuning of machine learning parameters to best predict likelihood to buy in a dependent category. After training is completed, the model calculates a purchase propensity score for a dependent category from a test set of feature data, in order to predict a dependent category purchase during the result time bin. The model is then validated with both an out of sample and out of time dataset.

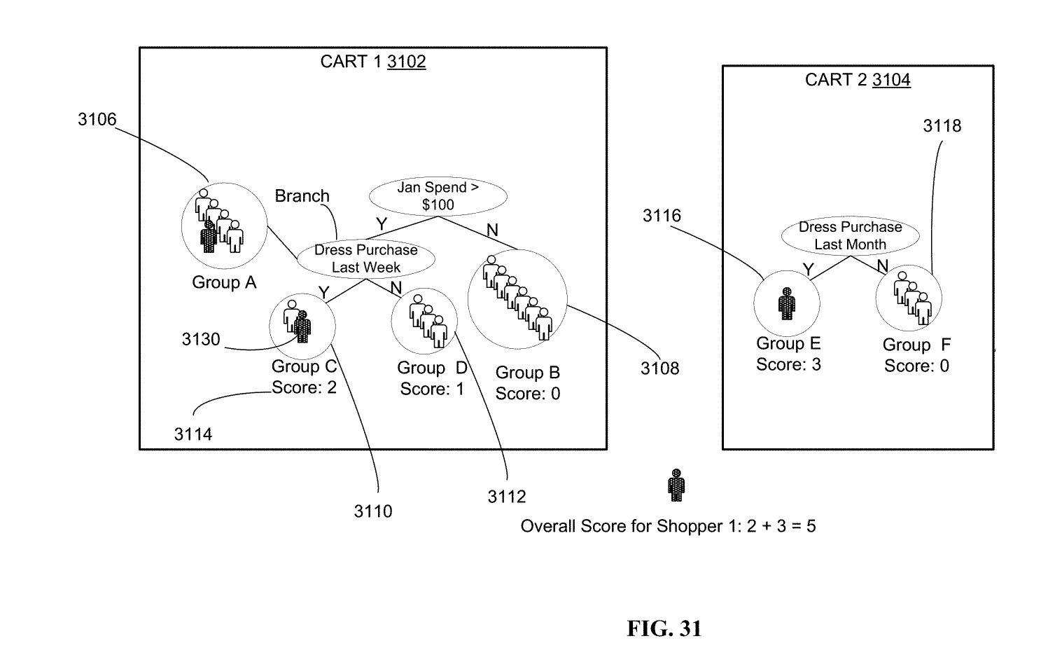

FIG. 31 shows a simplified diagram of a gradient tree boosting algorithm used by the classifier to calculate a user's purchase propensity score for the dependent category. This algorithm uses an ensemble of classification and regression trees (CARTs). Each CART calculates its own purchase propensity score for the user, and the algorithm adds the scores from all of the CARTs together to create an overall purchase propensity score for the user.

A single CART splits users into multiple groups using decision rules. Each split forms a branch of the tree. Each branching decision creates new nodes in the CART, called leaves. Terminal leaves are given scores, applied to all users in that leaf, which are used to classify the users.

The classifier does not use a single CART because the number of user input features being analyzed is too large. Using a single CART on such a large set of data requires a complex tree structure with many branches and leaves. An overly complex machine learning model is likely to overfit data after it is trained, resulting in a model with little predictive power. In addition, such a complex model is more likely to make unstable predictions, as larger models have larger variance.

Gradient tree boosting mitigates these problems by minimizing error in estimation and then calculating propensity scores from many CARTs. Gradient tree boosting configures each CART's size to balance prediction accuracy and complexity, which both increase as new leaves are added. Before a branching decision is made for a CART in order to add new leaves, the classifier calculates the additional accuracy and complexity that would be produced by adding the new leaves. If the increase in complexity is larger than the gain in accuracy, the leaves are not added to the CART. Instead, the classifier retains the CART's scores and builds a new CART, applying the same accuracy-complexity criteria to grow the new CART and determine additional CART scores. Once all of the CART scores are calculated, they are added together to produce an overall user score. An activation layer then converts the overall user scores to purchase propensity scores. Using this method of gradient tree boosting results in a classifier that has high predictive power and low complexity.

In this implementation, the features analyzed by the gradient tree boosting algorithm are monthly, weekly and daily time-binned user characteristics. Additional cumulative monthly features are calculated to be analyzed by the classifier. For example, a “last four months' spend” category is calculated by summing individual user spending values from the four input time bins prior to the result time bin. The classifier analyzes the time-binned features during a single input cycle in order to produce a propensity score.

FIG. 31 shows a simplified example of gradient tree boosting being used to calculate a shopper's purchase propensity for a dress. FIG. 31 shows two CARTs, with an overall score for Shopper 1 3130 determined by summing a score for Shopper 1 from CART 1 3102 with a score for Shopper 1 from CART 2 3104. CART 1 3102 has two decision branches. CART 1 splits the population of users into leaf A 3106 if they spent more than $100 on clothes in January, and into leaf B 3108 if they spent less than $100 on clothes in January. Then, CART 1 splits the leaf A users into two leaves: C 3110 and D 3112, where group C users purchased a dress last week and group D users did not. The users in leaves B, C, and D are assigned CART scores 3114 of 0, 2, and 1, respectively. Shopper 1 receives a score of 2. CART 2 3104 has one decision branch, splitting users into groups E 3116 and F 3118 based on whether or not they purchased a dress last month. Shopper 1 is in Group E, and receives a score of 3. Shopper 2's overall score is calculated by summing his scores from CARTs 1 and 2. Shopper 2 receives a score of 5. In order to classify Shopper 1, the classifier uses activation layer to convert Shopper 1's score into a propensity score between 0 and 1.

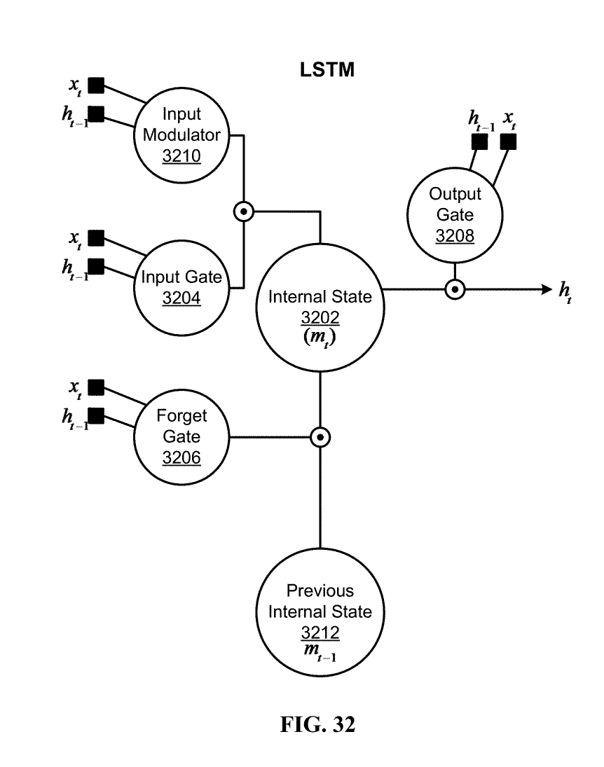

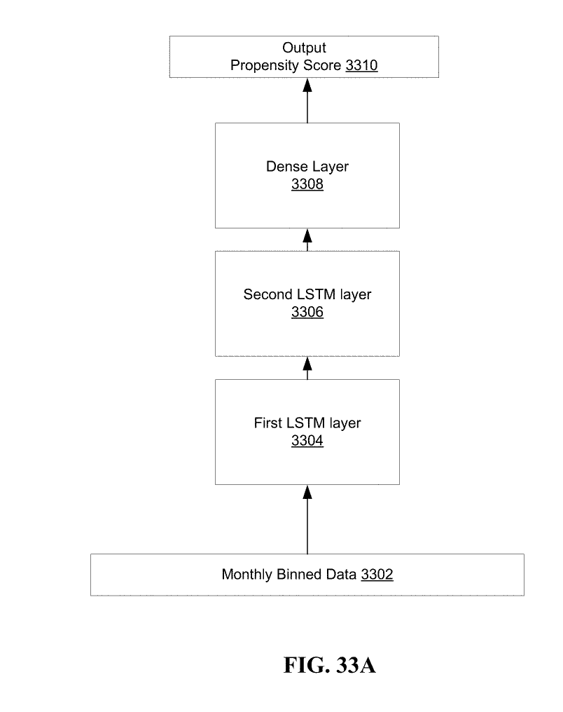

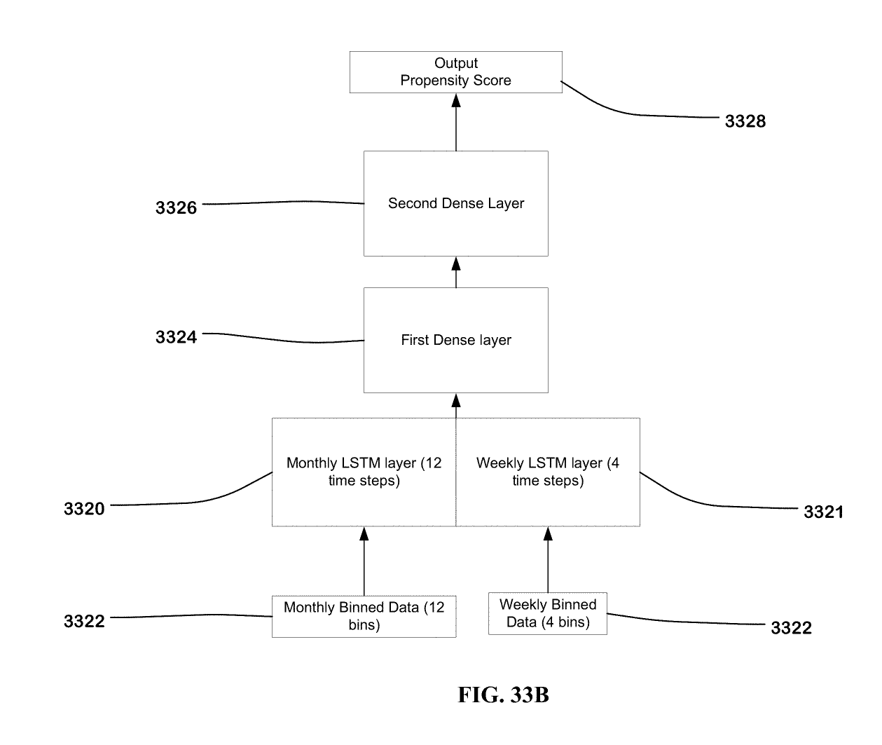

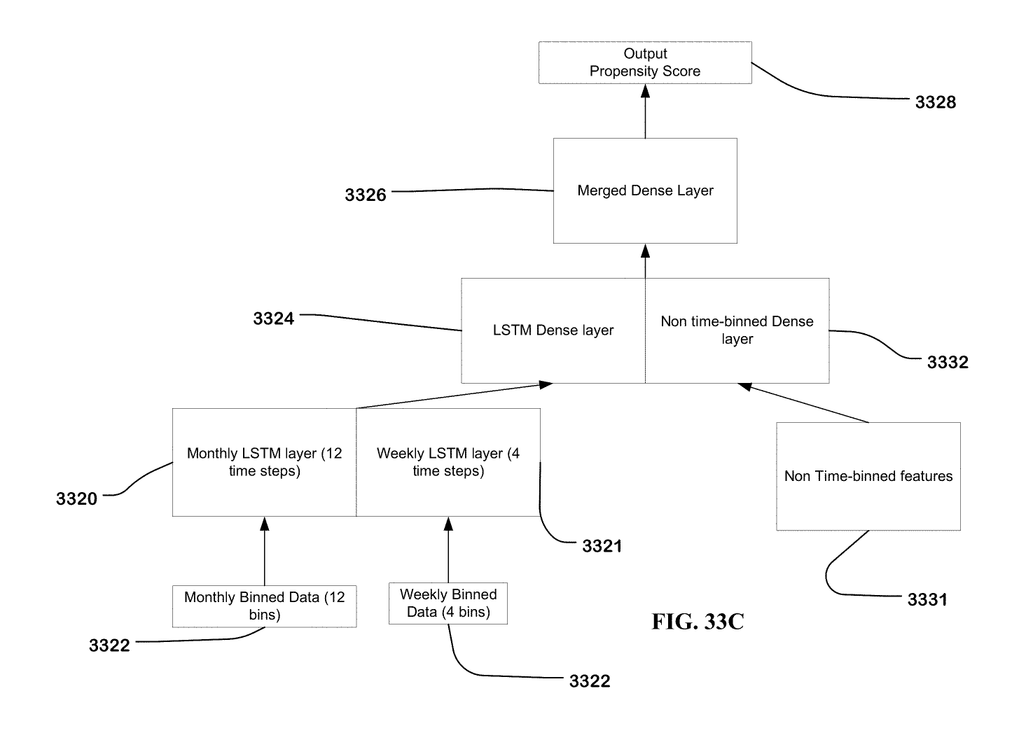

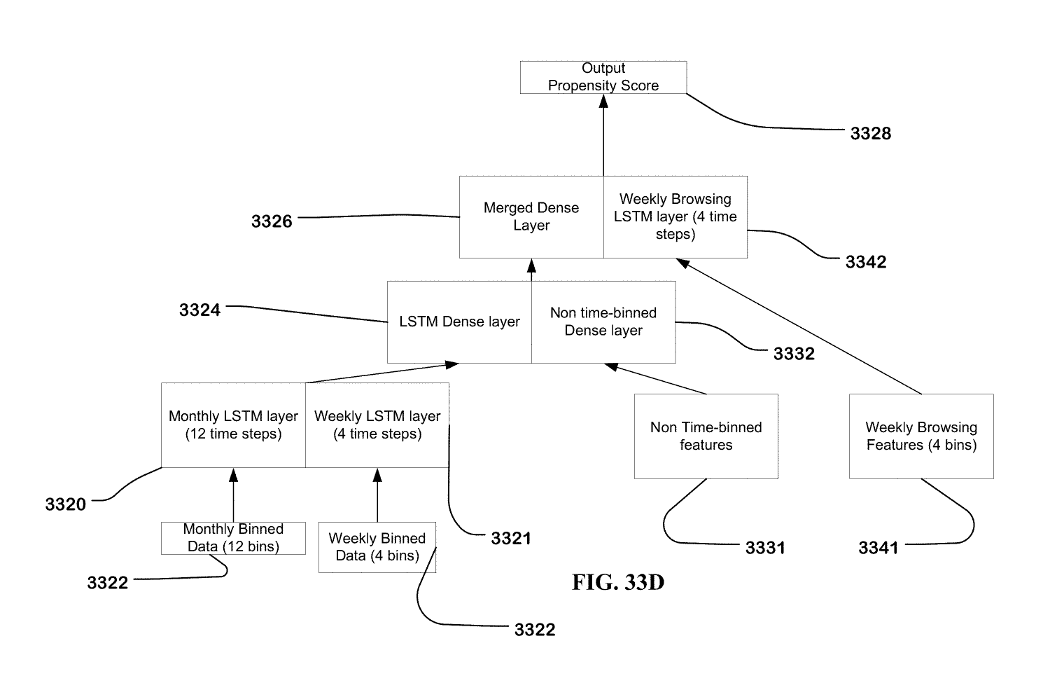

FIGS. 32 and 33A-D show diagrams for a classifier using one or more recurrent neural networks (RNNs) made up of long short-term memory (LSTM) blocks. Unlike other types of RNNs, an LSTM network can selectively “remember” information over arbitrary intervals of time. This property makes the LSTM network a powerful classifier when used to calculate purchase propensities using time series data. For example, the LSTM network can be used to calculate a propensity score for a user to purchase a Santa hat in December. The user purchases a Santa hat every December, shortly before Christmas. Although the user does not purchase Santa hats often, the user has a high propensity to purchase the hat this December because of the Christmas season. While a different classifier may predict a low propensity to purchase the Santa hat because the user has not purchased such a hat in 12 months, the LSTM network can “remember” the context in which the Santa hat was last purchased and make a more accurate prediction.

FIG. 32 shows a block diagram for an LSTM algorithm. Like all RNNs, LSTM networks are formed from chains of cells, where a particular cell has a time step. Time binned feature data is analyzed by the LSTM in multiple input cycles, with features belonging to a time bin analyzed during a corresponding LSTM time step. Each cell in an LSTM network has an internal state 3202, which stores information and is analogous to “long-term memory”. The internal state is propagated through the LSTM network. An LSTM cell outputs a hidden state, which is information from the internal state that is immediately relevant for making a prediction for the cell's corresponding time step. Information from the internal state that is not immediately relevant may become relevant during a future time step, and can be passed to the hidden state when it does become relevant. Thus, the hidden state is analogous to the LSTM network's “short-term memory”. Like the internal state, the hidden state is also propagated through the network.

In each LSTM cell, information is selectively committed to memory by adding and removing information from the internal state. Information is added and removed using structures called gates. An input gate 3204 controls which information from the time-binned feature data and previous cell's hidden state is allowed to contribute to the LSTM cell's internal state. In other words, the input gate controls which new information for the time step needs to be committed to long-term memory. A forget gate 3206 controls which information from the previous internal state 3212 is allowed to contribute to the cell's internal state. In other words, the forget gate controls which previous state information to “remember” and which previous state information to “forget”. An output gate 3208 controls which information from the cell's internal state is used to contribute to the cell's hidden state. In other words, the output gate determines which information is immediately relevant for making a prediction. An input modulator 3210 enables the LSTM network to learn more quickly.

FIGS. 33A-D show four implementations of LSTM-based classifiers used by the propensity predictor. Some of the classifiers analyze only time binned transaction features, while others use combinations of time binned transaction features, time binned browsing features, and non-time binned features.

In some of the implementations, the classifier stacks LSTM layers to create a deeper neural network. In this arrangement, each stacked layer processes a different portion of the classification task. Stacking LSTM layers allows each individual LSTM layers to require fewer neurons, increasing training speed.

Dense layers, or fully connected layers, are used in the classifier both to create intermediate features between classifier layers and to produce output propensity scores. Dense layers configure the network to make predictions using all of the parameters within each network cell. This makes the output purchase propensity a function of all of the feature inputs.

In the implementation of FIG. 33A, the classifier uses 12 monthly time bins for a yearlong analysis period, in order to predict a purchase propensity for a 13^{th} month result time bin. The monthly binned feature data 3302 is analyzed by a first LSTM layer 3304 over 12 time steps, or input cycles. For each cycle, 23 time-binned cross-category and category-specific features are analyzed by the first LSTM layer. The category-specific features include features collected from shopping cart data for the dependent category and five independent categories. In this implementation, the first LSTM layer 3304 outputs 12 hidden state vectors, one for each input cycle. The 12 vectors are intermediate inputs for a second LSTM layer 3306, which outputs an additional vector of intermediate inputs to a dense layer 3308. The dense layer analyzes these intermediate inputs to produce the purchase propensity score 3310, using an activation function.

The inventors created several additional implementations of the LSTM classifier. In each of the additional implementations, layers with different sets of inputs 3322 were merged together. After each merge, a dense layer 3324 was used to create an intermediate layer, that was then analyzed by successive layers 3326 in the classifier. In the implementation of FIG. 33B, the classifier merged a 12 monthly time bin LSTM layer 3320 with a four weekly time bin LSTM layer 3321, in order to predict a purchase propensity 3328 for a fifth week result time bin. In the implementation of FIG. 33C, non-time binned summary data 3331 was added as an additional layer 3332 to the second implementation's network, following the monthly monthly/weekly LSTM layer. In the implementation of FIG. 33D, added an additional LSTM layer 3342 including weekly binned site visit feature data 3341 to the third implementation's network.

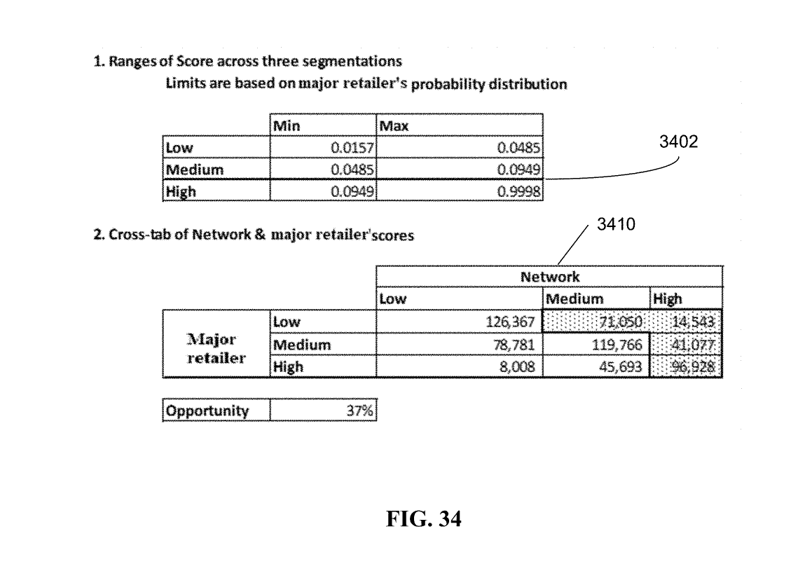

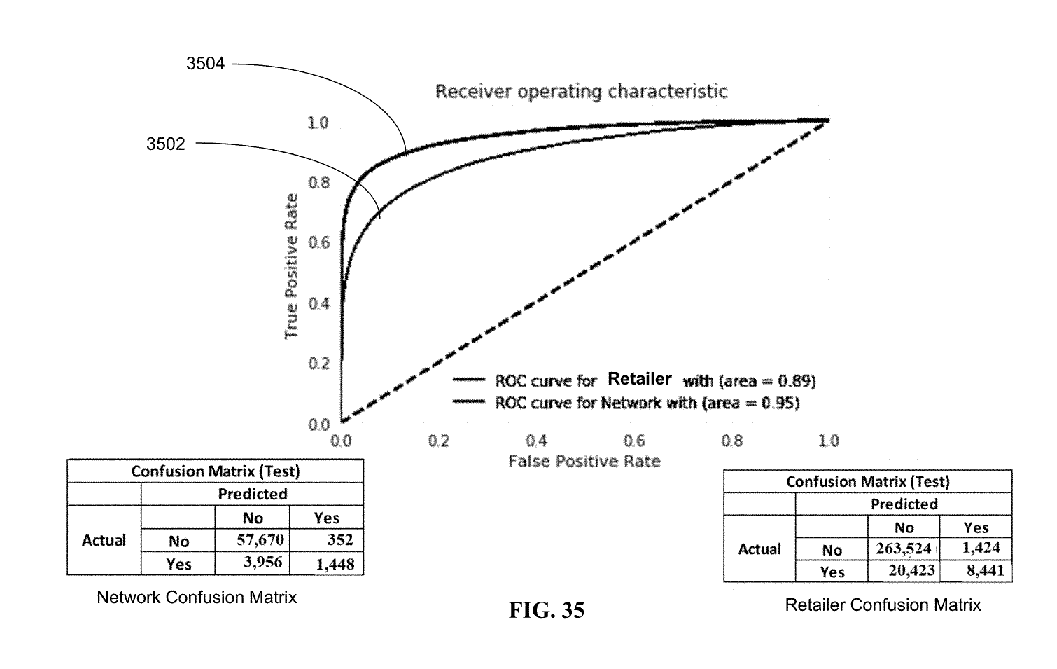

FIGS. 34 and 35 show classification results and evaluation statistics for the gradient tree boosting implementation of the classifier. Evaluators can use the same methods to test the performance of the LSTM implementation, as both classifiers output purchase propensity scores for dependent categories.

FIG. 34 shows a set of results used by a retailer to make a targeting decision based on user purchase propensity results from the gradient tree boosting machine learning model. Table 1 3402 shows cutoff ranges for propensity scores for highly engaged users, with ranges for low propensity, medium propensity, and high propensity to purchase dresses. Table 2 3410 shows a target selection table for a distribution of a major retailer customers with low, medium, and high propensities to purchase dresses both at the major retailer's stores and at other stores in the network, based on the cutoff ranges from the top table. For example, the 96,926 users in the bottom right-hand corner had purchase propensity scores for dresses between 0.0949 and 0.9998 for both the major retailer's stores and other network stores. But the 14,543 users in the top right hand corner had scores between 0.0949 and 0.9998 for network stores, but scores between 0.0157 and 0.0485 for the major retailer. The shaded cells show users that the major retailer is likely to target in order to drive those users to the major retailer's store to purchase dresses. The opportunity number shows that these users make up 37% of users that shop both at the major retailer's stores and other network stores.

FIG. 35 shows performance evaluation statistics for the machine learning model using gradient tree boosting. FIG. 35 shows confusion matrices for the major retailer and other network's customers and receiver operating characteristic (ROC) curves for the customers.

The confusion matrices in FIG. 35 show performance evaluation statistics for high-engagement users. In general, the performance of the classifier is evaluated based on the percentage of user purchasing decisions it correctly predicts. The model predicts a positive or negative user decision using a positivity threshold. For example, for a positivity threshold of 0.5, all users with scores above 0.5 are predicted to purchase a dress in the result time bin (a predicted positive), and all users with scores below 0.5 are predicted to not purchase a dress during the result time bin (a predicted negative). The confusion matrices show numbers of accurate and inaccurate predictions for the high-engagement users. The upper-left hand corner (No/No) shows the true negatives (TN), users correctly predicted to not purchase dresses during the result time bin. The upper-right corner (No/Yes) shows the false positives (FP)—users whom were predicted to purchase a dress but did not do so. The bottom-left corner (Yes/No) shows the false negatives (FN)—users who were predicted not to purchase dresses but actually did purchase dresses. The bottom-right corner (Yes/Yes) shows the true positives (TP), users whom were correctly predicted to purchase dresses during the result time bin. The accuracy of the model is measured using the following formula.

$$Accuracy = \frac{TP + TN}{TP + TN + FP + FN}$$

The accuracy expresses the proportion of the total number of users whose dress purchase behavior was accurately predicted, whether or not the users actually purchased dresses. For the major retailer's customers, the calculated accuracy of the model is 92.56% for high-engagement users. For network users, the calculated accuracy of the model is 93.21% for high-engagement users.

The receiver operating characteristic (ROC) graphically depicts the accuracy of the classifier's positive predictions as the positivity threshold is varied. For a positivity threshold, the receiver operating characteristic calculates a true positive rate (TPR) and a false positive rate (FPR), expressed using the following formulae:

$$TPR = \frac{TP}{TP + FN}$$

$$FPR = \frac{FP}{TN + FP}$$

The TPR is the proportion of users that was correctly predicted to purchase a dress by the classifier. The FPR is the proportion of users that was incorrectly predicted to purchase a dress by the model. The ROC is a graph of (FPR, TPR) points plotted for different positivity thresholds. A perfect receiver operating characteristic would be the vertical line FPR=0, signifying that, for any positivity threshold, the model predicts the decisions of 100% of the dress purchasers accurately and does not incorrectly predict any whom did not purchase a dress to have purchased one (100% true positives, no false positives). A diagonal line with slope TPR=FPR, on the other hand, signifies that, for any positivity threshold, true positives and false positives are equally likely. In other words, the classifier predicts no better than a person making random guesses. More accurate predictors thus have steeper slopes than the line TPR=FPR. The classifier's accuracy can also be expressed by measuring the area under the ROC curve (AUC). For the ROC with line TPR=FPR, the AUC is only 0.5, and for the vertical line ROC, the AUC is 1. Accurate classifiers thus have AUCs close to 1. The ROCs produced for both the major retailer and other network stores are curves that are above and to the left of the TPR=FPR line. The AUC for the major retailer ROC 3502 is 0.89 and the AUC for the network ROC 3504 is 0.95. The shapes of the ROCs and their AUCs signify that the classifier's positive predictions are accurate. In addition, the F1 Score can be used as a measure of the model's accuracy. The F1 score is the harmonic mean between the precision and the recall metrics, and may be used in cases where the training data has unbalanced classes. An F1 score of 1 is considered as the best prediction where both the precision and recall metrics are 1.

### Greet and Guide a Visitor at a Physical Venue

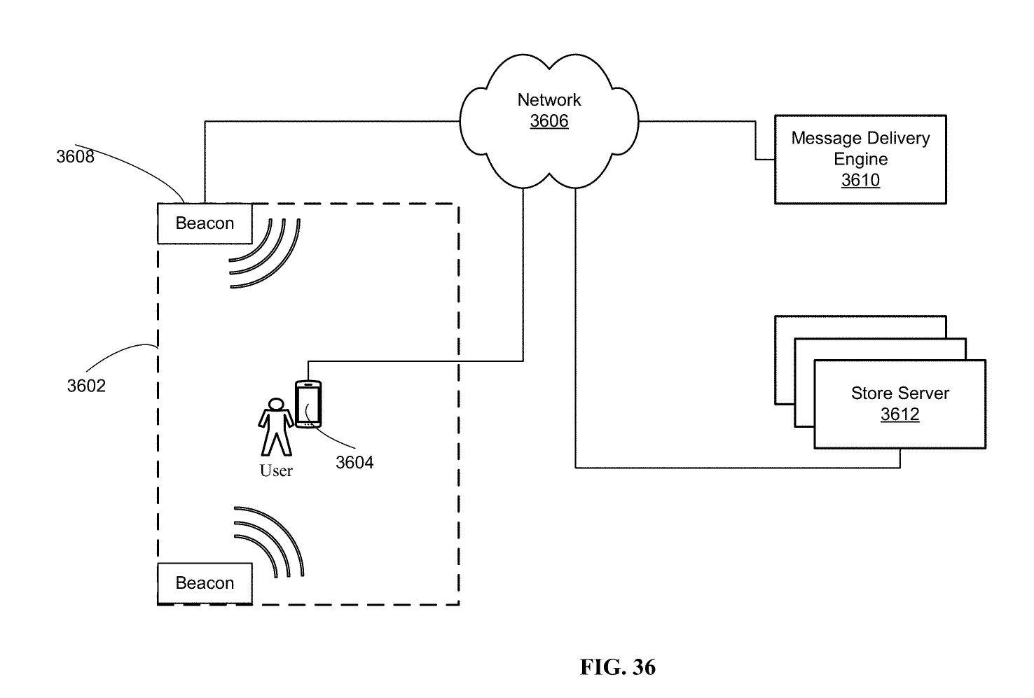

FIG. 36 shows a system diagram for sending messages to a visitor to a venue 3602. A visitor to a venue has a connected mobile device 3604 that is able to determine its location using signals from beacons 3608. The mobile device is connected to a network 3606. Also connected to the network is a message delivery engine 3610 and one or more store servers 3612.

The mobile device 3604 is a computing device, such as a smartphone, tablet or laptop computer. In some implementations, the mobile device may have an application associated with the venue installed on it. This application allows the mobile device to capture location signals from beacons and use the captured signals to multilaterate its position. The application may be the social media application, a navigation application, or a ridesharing application. The application may be running in a foreground mode or an active background mode. Location signals are captured from one or more beacon 3608 when beacons send encrypted messages to the mobile device. The location information from the application is used by merchants to assess whether to send the mobile device messages or promotions relating to merchandise within the venue.

The message delivery engine 3610 evaluates messages or message template and selects messages for presentation to the user based on criteria via the mobile device 3604. The criteria include profile information for the user as well as intent propensity information for the user stored by the venue. Intent propensity information is determined from user profile information as well as information about user behavior collected by the venue. The message delivery engine 3610 uses machine learning techniques to perform semantic analysis to analyze messages stored on servers and determine whether the messages are suitable for presentation to the visitor's mobile device.

The store servers 3612 are owned by the venue. Store servers may be hosted at the location of the venue or may be distributed servers. Store servers store messages and message templates as well as venue-specific profile and propensity information about visitors.

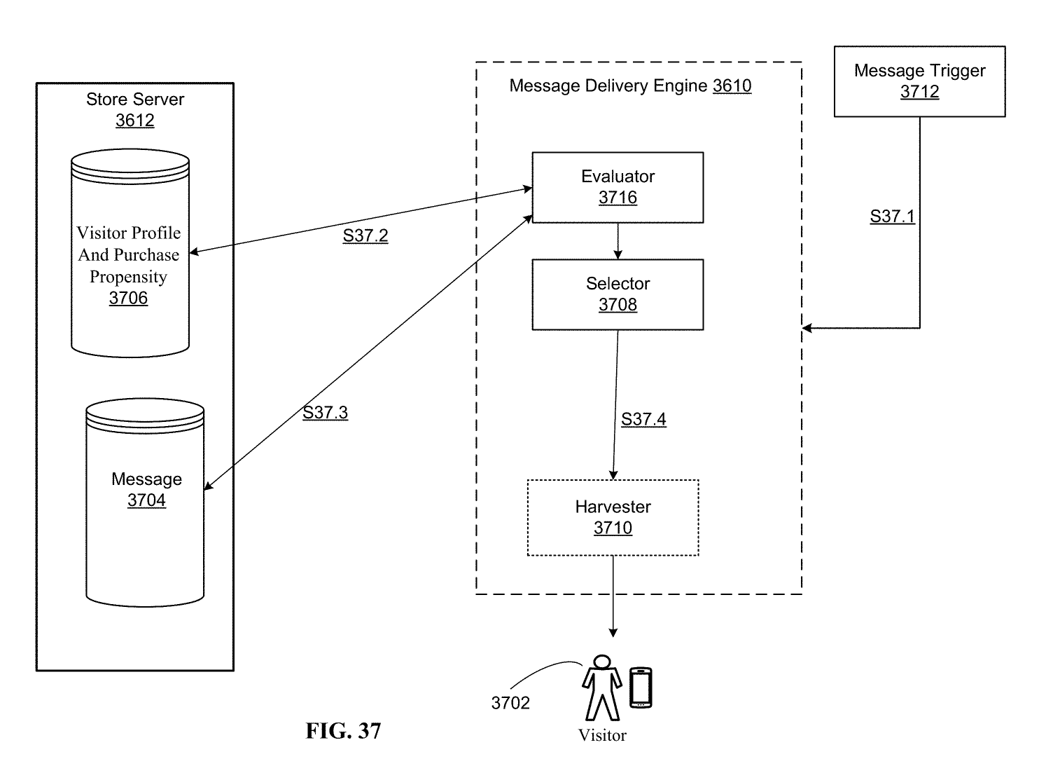

FIG. 37 is a message sequence chart for sending messages to a visitor 3702 to a venue. The store server 3612 includes a message database 3704 and a visitor profile and purchase propensity scores database 3706.

The visitor profile and purchase propensity scores database 3706 stores profile information for the visitors. The profiles may be the aggregated profile 400. The profile store may store visitor identifiers retrieved from the visitor's mobile device, such as IDFA, AAID, tracking cookies, email addresses, MAC addresses, and shopper loyalty information. The profile may also include personally identifiable information such as a visitor photograph, a visitor name, or another unique identifier. The visitor propensity score is the likelihood that a user will purchase an item from a merchandise category at a future time. The visitor's propensity scores may be calculated using input data including procurement histories for users binned by month, object type, object class, purchase price, and total amount spent. Intent propensities of visitors can be calculated using machine learning models, exemplified by convolutional neural networks or recurrent neural networks.

The message database 3704 stores messages that the message delivery engine 3610 provides to visitors when they enter the venue. The messages may identify procurement schemes available for objects or categories of objects provided to the visitor by the tenant. Procurement schemes may include discounts, sales, product offers, promotions, or other incentives for users to procure objects. Messages may be generic templates into which user profile information is inserted in order to customize the message. Messages may greet users as they enter venues or inform them whether sales assistants are available to assist them. Even when a user has not entered the venue, messages may be presented to the user as the user enters the shopping center in order to entice the visitor to visit the specific store.

The message delivery engine 3610 also includes an evaluator component 3716 and a selector component 3708. The evaluator component 3716 evaluates messages from a message database 3704, and the selector 3708 selects one or more of the evaluated messages for presentation. A harvester 3710 may optionally be included to process the selected messages.

The message evaluator 3716 evaluates messages from the message database 3704. The message evaluator evaluates the messages for presentation to the visitor based at least in part on visitor profile data and intent propensity scores stored in the visitor profile and purchase propensity scores database 3706. The message evaluator may use time or date information to evaluate messages based on when or which procurement schemes for objects may be available to visitors. For example, messages may be sent when certain objects are in season or in stock. Further, visitor information may indicate that the visitor is more likely to procure specific items or categories of items at different times during the year.

Criteria for message evaluation may include the location of the visitor within the venue. For example, a message that is relevant to objects from a particular class may be presented when the visitor is in the department of the venue relating to that class of objects. Evaluating the proposed messages may be done using an attention mechanism. For example, the attention mechanism may identify which portions of the message specifically relate to an object which the visitor is most likely to procure, based on visitor profile information and the visitor intent propensity information.

Evaluated messages suitable for presentation may be arranged in a queue. The size of the queue may be based predetermined limit on the number of messages. Queued messages may be temporarily stored while the visitor is within the venue, and selected for presentation at different points during the user's journey. The queue may be retained after the visitor leaves the venue, or may be discarded and replaced by a different queue during the visitor's next visit to the venue.

The message selector 3708 presents to the visitor of the venue one or more messages from the evaluated messages. For example, the message selector may present a message at the front of the queue of evaluated messages. The selected message may be presented to the mobile device within five minutes of the visitor's arrival at the venue. For example, a message may be sent greeting the visitor as the visitor enters the venue. When a visitor reaches a department of interest, the visitor may be presented with a message describing procurement schemes for objects within the department. Visitors may also be presented with information regarding which sales assistant are available to assist the visitor and which cashiers are available.

Selected messages may be plain text messages. An optional harvester 3710 may process the selected messages for presentation on the mobile device. The harvesting component may embed message text into code in order to present the selected message on a landing page or as a pop-up notification.

FIG. 37 also shows message flow among the store server 3612 and the message delivery engine 3610. At step S37.1, a message trigger 3712 initiates the message presentation process. The message trigger may be a location-based trigger that registers the location of the mobile device. The location may be registered when symbiotic reporting code running on the mobile device application provides the message delivery engine 3610 with the location of the mobile device. It may initiate the presentation process when determines that the mobile device is within the venue. The message trigger may also initiate the presentation process when the visitor enters the shopping center itself, as a means for enticing the user to visit the venue on the user's journey. At step S37.2, visitor profile data and propensity score data from the profile and purchase propensity scores database 3706 is accessed by the evaluator 3716. In step S37.3, the evaluator 3716 uses this data, in part, to evaluate messages from the message database 3704. The evaluator 3716 queues evaluated messages suitable for presentation. In step S37.4, the message selector 3708 selects messages for presentation. Optionally, the message selector deploys the messages to the harvester component 3710, which processes them for presentation to the visitor.

In some implementations, when a visitor is detected at a venue through his mobile device, the message delivery engine 3610 may opt not to send any messages to the visitor.

In some implementations, the message delivery engine 3610 selects messages based on an objective function where the goal of the objective function is to increase the likelihood of a visitor responding to messages and that a response to the messages will result in a sale in one of the retailers or in the venue or that the expected value of the transaction, which considers both the likelihood of response to a product category and the price of items in that category. To avoid conquesting within the retailer network, one solution will be to only provide messages to the visitor if he/she has a prior relationship with a retailer or the venue. Even so, the goals of the objective function may be in conflict with each other (sale in a particular retailer over another), and a potential solution to the conflict may fall within the realm of digital advertising, where the highest bidding retailer or venue gets their message prioritized for the visitor. In some implementations, the objective function of the message delivery engine 3610 is based on the location of the visitor. Messages from retailers in the proximity of the visitor will be selected to be presented to the visitor.

In some implementations, the message delivery engine 3610 may detect a “response fatigue” in a visitor. The response fatigue is the likelihood of the visitor has indicated to not respond based on the set of recommendations recently delivered. There can be instances where response fatigue has the highest contribution to an individual's recommended action, based on which no action will be taken at the time of detection in the venue or possibly just a welcome message without any associated dollar value transactional action is sent to the visitor.

In some implementations, the message delivery engine 3610 may take recent purchases of the visitor into account across the network of retailers, so that messages related to the item or category purchases or similar items are not selected for the visitor. Selecting messages based on recent purchases may be unique to a single retailer.

The message delivery engine 3610 can use recommender systems for selecting messages to be delivered to the mobile devices of the visitors. The recommender systems used in the engine 3610 can be memory based collaborative Filtering, context-based filtering or genetic algorithm-based recommender systems (GARS). In some implementations, the recommender systems in engine 3610 can utilize the structure of genetic algorithms in conjunction with collaborative filtering. The feature inputs to the classifier can be the visitor profile data and propensity score data, and the visitor's current location. The engine 3610 will evaluate each message probability (e.g., type of action or ad, no action) along with the net benefit of the messages to identify the best messages at that time for that particular visitor.

In one implementation, the engine 3610 can use memory based recommender systems for selecting messages to be delivered to the mobile devices of the visitors. A memory-based recommendation system tries to find shoppers that are similar to a particular visitor, and uses their preferences to predict ratings or recommendations for the particular visitor. The memory-based recommendation system may use K-Nearest Neighbors non-parametric classification to predict recommendations. The features engineered in the memory based recommendation system based on the visitor's behavior in independent product sub-categories are used to find similar shoppers with similar profiles based on Vector Similarity.

Recommendation for the visitor in a sub-category of interest is performed in three stages: (i) by deriving profiles of similar shoppers based on the parent category as an input to a feature vector, (ii) reducing dimensionality reduction of the feature vector and (ii) by measuring the cosine similarity index.

For the independent child or sub-category of interest, shopper profiles are created for an input time period based on data points available for the parent product category. The shopper profiles are created from input training data such as the binned profile data 402 in FIG. 4. The input training data includes the POS and online purchase data, online and offline browsing history from retailers and venues in the network, as well as third party data. Features in the shopper profiles may include online, and offline spending, discounts, and search frequencies for product categories and sub-categories, and well as shopper level attributes that are aggregated across data points. In order to convert the features into low dimension axes without losing the ability to explain the overall variance, feature set transformation is required from possibly correlated variables into a set of values of linearly uncorrelated variables in order to reduce the scope of exaggeration of similarity and optimize the operational efficiency. In one implementation, the Pearson correlation coefficient is used to determine the linear correlation between the two features. The value of the Pearson correlation coefficient varies from +1 for total positive correlation to −1 for total negative correlation. One of the features out of the pair of features depicting a strong correlation of more than 0.8 can be dropped. In addition, methods such as reducing features that have very low fill rates in the data may be implemented. Given the very large dimensionality of the input training data, it is critical to reduce features before calculating the nearest neighbors. The set of features for all shoppers is transformed into vectors in an n-dimensional space where n is the number of features. Cosine similarity, which measures normalized dot product between two non-zero vectors is calculated for the visitor against the rest of shoppers. In a positive space, cosine outcome ranges from [0, 1] with higher values depicting more similarity. Finally, products purchased by the identified similar shoppers through the calculated index can be recommended to the visitor.

In some implementations, the engine 3610 can recommend messages for the visitor by taking the context of the visitor's interaction using Context based Collaborative filtering. In such implementations, the observable context-based features will include the location of the visitor with respect to the venue or mall, the product categories sold at the venue, the retailers in the venue, the brands in the venue, the time of the visit, recent purchase history and recent search history. The context features in this implementation are observable but dynamic. The recommended messages are based on user, relevant category/product behavior as well as the context for the recommendation.

As a visitor proceeds in a journey through the venue having multiple tenants, the location of the visitor's position can be detected intermittently within a 1-5 meters accuracy to determine the path of travel as well as the retailers that are in proximity to the visitor's current location. The candidate message queue can be updated based on the current location of the visitor in the venue. The messages in the updated message queue can then be used to inform/alert the visitor on procurement schemes available for objects or categories of objects provided to the visitor by retailers near the visitor's current solution. Procurement schemes may include discounts, sales, product offers, promotions, or other incentives for users to procure objects. In addition, the updated messages can be from retailers that the visitor has either purchased from previously, visited previously (in or out of that venue location) or browsed at.

For unknown visitors with no visitor profile data and propensity score data in the profile and purchase propensity scores database 3706, the message evaluator 3716 evaluates messages from the message database 3704 on dependence upon the visitor's current location. The message evaluator may use time or date information to evaluate messages based on when or which procurement schemes for objects may be available to visitors. For example, messages may be sent when certain objects are in season or in stock.

Gender and Age Context for User Intent when Browsing or Searching

During online visits, a gender context can be determined from aggregate history data, including both online and physical history, based on Bayesian likelihood of within SKU/product categories (object classes), brand or retailer or based on recent browsing. Many households have Chief Shopping Officer or a member in charge of shopping for merchandise for the family. In households of four people, the member in charge of shopping will shop for male and female adults and male and female dependents, plus friends and relatives. When the member browses online looking for pants, he or she may be looking on behalf of a male or female and on behalf of an adult or child. Binned profile data within an SKU/product category hierarchy can yield a Bayesian likelihood of a gender context and/or an age context. Often, the member will visit multiple retailers' website to satisfy different gender contexts and or age contexts in his or her household. Brands also can differentiate between gender and age contexts. Once gender and approximate age contexts are established, specific propensities and preferences can be brought in the first array of products displayed that have a substantial likelihood of matching the visitor's intent.

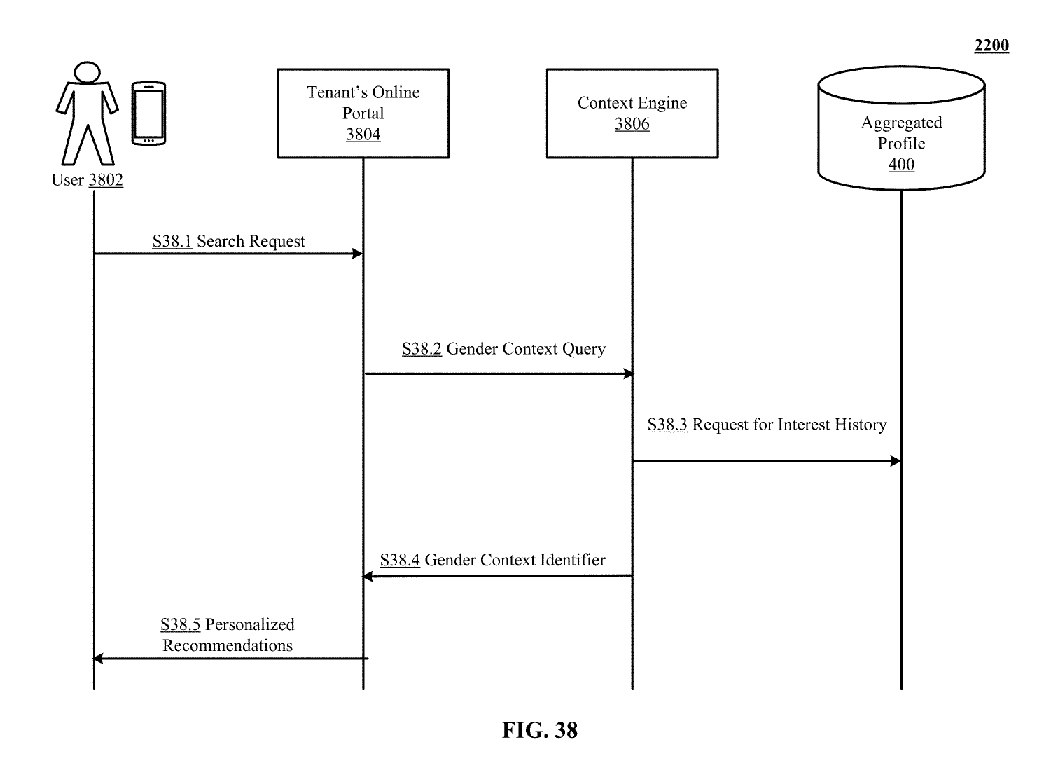

FIG. 38 illustrates a chart showing a message sequence for sending object recommendations to a user based on gender and age context. This chart describes a process allowing a user to receive object recommendations for an unidentified beneficiary, based on a predicted gender for the unidentified beneficiary. At S38.1, the user 3802 requests content on an online portal 3804 belonging to a tenant. The online portal enables a user to search for, view, and purchase retailer inventory items, and is accessible from a user's mobile device or from another computing device. Retail assistants may also access the online portal on in-store devices in order to assist shoppers with ensemble purchases. Retailer inventory information accessed through the web portal is stored on the tenant servers. At S38.2, the online portal page, upon receiving the content request, produces a gender context query and sends the query to a gender and age context engine 3806.

At S38.3, the gender and age context engine 3806 accesses the aggregated profile 400 in order to obtain an interest history for the user 3802. The interest history for the user includes pre-calculated clusters for the gender and age of the interest history for the user. These clusters include style information from the interest history.

The aggregated profile 400 maintains historical user information, including purchase histories, browsing histories, purchase propensity scores calculated using the purchase propensity predictor, and other user characteristics tabulated from shopping cart data.

At S38.4, the gender and age context engine 3806 classifies users by producing gender identifiers and age identifiers that are used to determine items to present to the user through the online portal. The gender and age context engine 3806 analyzes features from the aggregated profile, including propensity scores and historical purchase data, in order to classify users by gender. The gender identifier does not necessarily apply to the gender of the user purchasing the items, but the gender of the recipient of the purchased items. For example, a mother may purchase clothes primarily for her young son. In such an example, the mother's purchase history mostly contains boys' clothing, and she has high propensities to purchase boys' clothing. The gender and age context engine produces a male identifier from analyzing this purchase history. For example, it may output a score ranging from 0 to 1 and convert that into an M score indicating make or an F score indicating female using a threshold. In some implementations, the gender and age context engine may account for more than two genders.

The gender and age context engine 3806 receives feature data from the aggregated profile store. In order to produce the gender context identifier, the engine analyzes gender-specific feature data using a classifier. Gender-specific feature data may be item categories, such as dresses, skirts, and rompers. It may also include item department level categories, such as men's and women's. These tags may be found in the SKU label. The engine may also analyze item features for gender context, such as brand, color, shape, and size.

In order to customize the shopping experience for an active Chief Shopping Officer, the gender and age context engine 3806 first classifies the SKUs/categories of interest into the gender and age groups of his or her interest. For example, a mother can be interested in shopping for her young daughters and her husband. The mother is the Chief Shopping Officer in this case. Even though she is an adult female, her categories of interest are girls' clothing and menswear.

The gender and age context engine 3806 classifies the SKUs/categories of interest by: (i) labelling the age and gender attributes in the data at the SKU level using a combination of product taxonomy and Natural Language Processing (NLP) for the product/item descriptions; and (ii) predicting the classification of an unlabeled SKUs using text parsing for descriptions, URLs, brand etc. The labeling and predicting process essentially involve text-based filtering to predict the gender/age for each item. A separate prediction can be made for gender and age neutral categories.

In some implementations, content related features derived from SKU labels can be a differentiator to understand the general context of the gender of a product. The sentences or descriptions in SKU labels can be broken into word tokens and be interpreted as a bag of words. The words used more frequently by one of the gender group as compared to other can be used as features. All common words across genders can be removed. The frequencies of different N-grams in the descriptions are calculated. The gender and age context engine 3806 may further analyze the frequencies of different N-grams in the descriptions across products with already defined gender context. The top N-grams across each gender context can be matched with the undefined SKU labels to create a gender context identifier. A similar approach is developed to identify the age groups of undefined labels.

Based on the interest history, the context engine determines a gender context for the unidentified beneficiary. The context engine creates an identifier based on this context and returns the identifier to the tenant's portal page. The portal page uses this identifier to create a set of recommendations for the user to obtain for the unidentified beneficiary.

Using the same process, an age context can be determined for the unidentified beneficiary. The gender and age context engine 3806 may receive gender and age context queries at the same time from the portal and return both to the portal. The gender and age context engine 3806 may also combine recent browsing data from the aggregated profile 400 with a priori likelihood to determine the gender context and the age context for the unidentified beneficiary. The context engine then creates a gender identifier and an age identifier, and uses these identifiers to create a set of recommendations for the user to obtain for the unidentified beneficiary.

While the gender and age context engine 3806 may use a binary classifier to determine the gender context, determining an age context is a multiclass problem. Historical purchase data may be used to determine softmax probabilities for multiple age brackets. The age bracket with the highest number is chosen by the context recommendation engine. Age context may be revealed by looking at age-specific categories in the SKU tree. It may also be determined by looking at purchase history from specific stores. Different styles, brands, and colors may be used to determine age.

Age context may work in a similar way, with age brackets. Feature data of interest might be a large preponderance of children's clothing vs. men's or women's or other types of accessories only bought for children or adults. Features could include purchases at specific stores, some of which may be catered to teens. Feature information could be collected for sizes, styles, colors, etc. that are marketed to teens, adults, children.

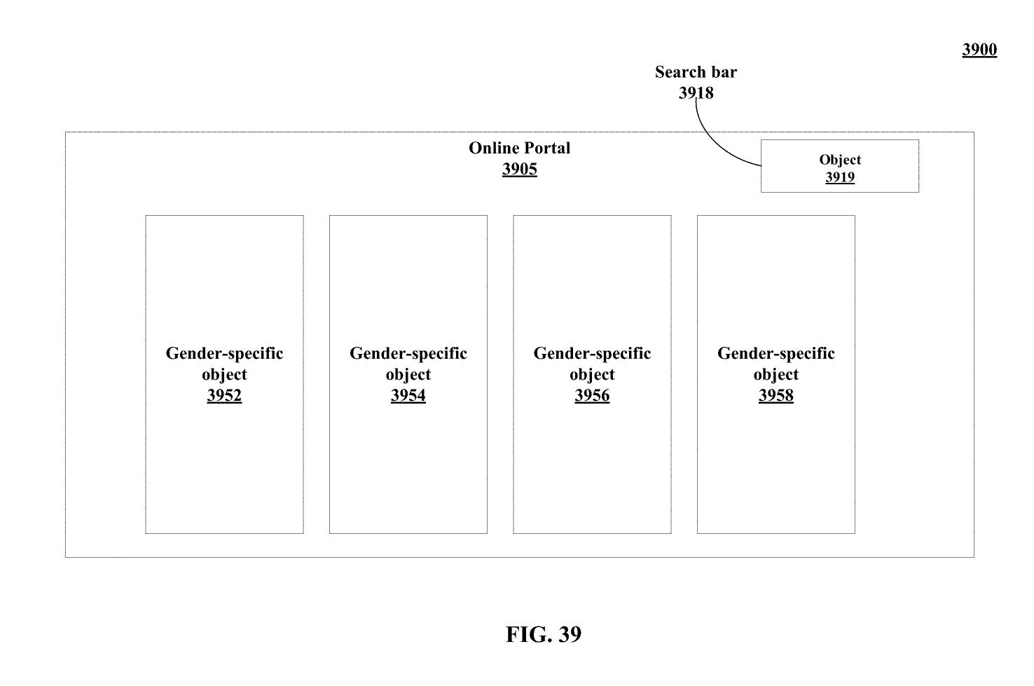

FIG. 39 shows a user interface for an online portal 3905 that displays gender context recommendations. A user searches for an object 3919 in the online portal's search bar 2318. The portal sends a personalization query to the context engine, which requests the interest history for the user. Based on the interest history, the context engine determines that the user is requesting objects for an unidentified beneficiary of a different gender. The context engine creates an identifier that is the gender of the beneficiary and sends the identifier to the online portal. The online portal returns to the user a page that displays gender-specific objects 3952, 3954, 3956, and 3958 that match the object 3919 that was initially searched for by the user.

### Generating an Individualized Ensemble of Complementary Items in Complementary Item Categories

During a visit, whether detected or precipitated, ensembles can be offered on an individualized basis. In general, recommendation engines typically are based on look-alikes, what other customers bought along with the current SKU/product. Current recommendation engines do not check size availability or take into account a particular online visitor's brand, color or style preferences. With an SKU category hierarchy, individualized visitor histories and binned profiles can be used to fashion product ensembles that are individualized. From look-alike data, ensembles of SKU/product categories can be assembled. Individual SKUs/products can be selected to fill the categories from individualized data. Product availability can be taken into account when an individualized ensemble is constructed. This approach can be applied both in store and online. In a store, a user who is browsing the retailer's app or the venue operator's app can receive from a server personalized ensemble recommendations. Or a personal shopping assistant or concierge can receive the recommendations and convey them to the shopper. Online, the user can receive the personalized recommendations as browsing and buying proceed.

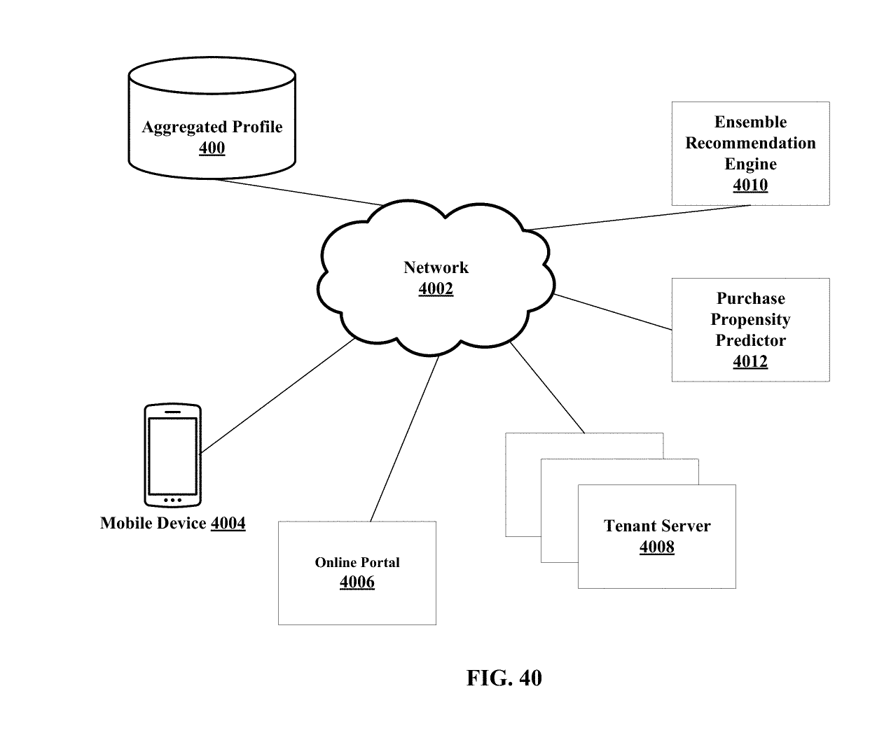

FIG. 40 shows a system diagram for an ensemble recommendation system. When a user accessing a retailer's web portal queries an item of interest, the ensemble recommendation system selects a set of replacement or complementary items to present in conjunction with the queried item of interest. The system of FIG. 19 includes a mobile device 4004, an online portal 4006, one or more tenant servers 4008, the aggregated profile 400, and an ensemble engine 4010, a purchase propensity predictor 4012, all connected to a network.

The online portal 4006 enables a user to search for, view, and purchase retailer inventory items, and is accessible from a user's mobile device 4004 or from another computing device. Retail assistants may also access the online portal on in-store devices in order to assist shoppers with ensemble purchases. Retailer inventory information accessed through the web portal is stored on the tenant servers.

The purchase propensity predictor 4012 uses machine learning techniques to produce purchase propensity scores that predict user purchase behavior in a future period. Using time-binned purchase data from the aggregated profile 400, the purchase propensity predictor produces these scores both for item categories and for characteristics of the items within these categories. Examples of item characteristics include item sizes, colors, brands, and styles. To calculate a purchase propensity score for a category, the purchase propensity predictor may use a neural network or tree ensemble algorithm to analyze the time-binned purchase data and produce a single score for the category. To calculate purchase propensity scores for characteristics of items within a category, the purchase propensity predictor may use a neural network with a softmax layer to give each item characteristic a purchase propensity score. Purchase propensity scores are stored in the aggregated profile 400, and accessed by the ensemble engine to select ensemble items for presentation.

The aggregated profile 400 maintains historical user information, including purchase histories, browsing histories, purchase propensity scores calculated using the purchase propensity predictor, and other user characteristics tabulated from shopping cart data. The aggregated profile 400 may maintain group interest patterns, or information regarding which items users most commonly purchased together in individual transactions.

The ensemble engine 4010 creates an ensemble of items to be presented to the user via the online portal along with the queried item of interest. In order to do this, the ensemble engine first selects categories containing items which are complementary with or which can replace the queried item. For example, if the queried item is a cocktail dress, the ensemble engine may present items from the shoe category, the jewelry category, and the makeup category, or it may present other items from the dress category. The ensemble engine then uses historical purchase information retrieved from the aggregate profile to decide which of the categories contain items that the user is likely to buy, or, in other words, are relevant to the user. For example, the ensemble engine may create the set of relevant categories by selecting categories with the highest user purchase propensities, or by selecting categories that have high lift associations with the category containing the queried item of interest. The ensemble engine then selects specific items from the relevant set of categories it has chosen, based on user preferences for item characteristics. To select the items, the ensemble engine uses the purchase propensity predictor to calculate propensity scores for item characteristics, and select the highest scoring items for presentation via the online portal.

In some implementations, the approach to creating ensembles follows the product taxonomy that is available to the retailer. The taxonomy can have several levels before it classifies a particular item. For example, the first level (L1) could be Clothing, the second level (L2) could be Women's, the third level (L3) could be sweaters, and the fourth level (L4) could be cardigans. A second example can be the first level (L1) being shoes, the second level (L2) being women's shoes, and the third (L3) level being boots.

The ensemble engine 4010 creates an ensemble of items by identifying similar shoppers using similarity and genetic algorithms or classifiers such as Classification and Regression Trees (CART), RNNs, collaborative Filtering or context-based filtering. The ensemble engine 4010 then creates a composite similarity measure by taking into account purchases by the identified shoppers that occur together at the L4 level, adjusted for purchases at the L3, L2, and L1 levels. Rather than based on an item by item similarity measure, the ensemble engine 4010 approach looks at customers that have similar purchase, spending, and browsing behavior. The ensemble engine 4010 provides recommendations for products to be included in the ensemble based upon the multiple level category based purchases.

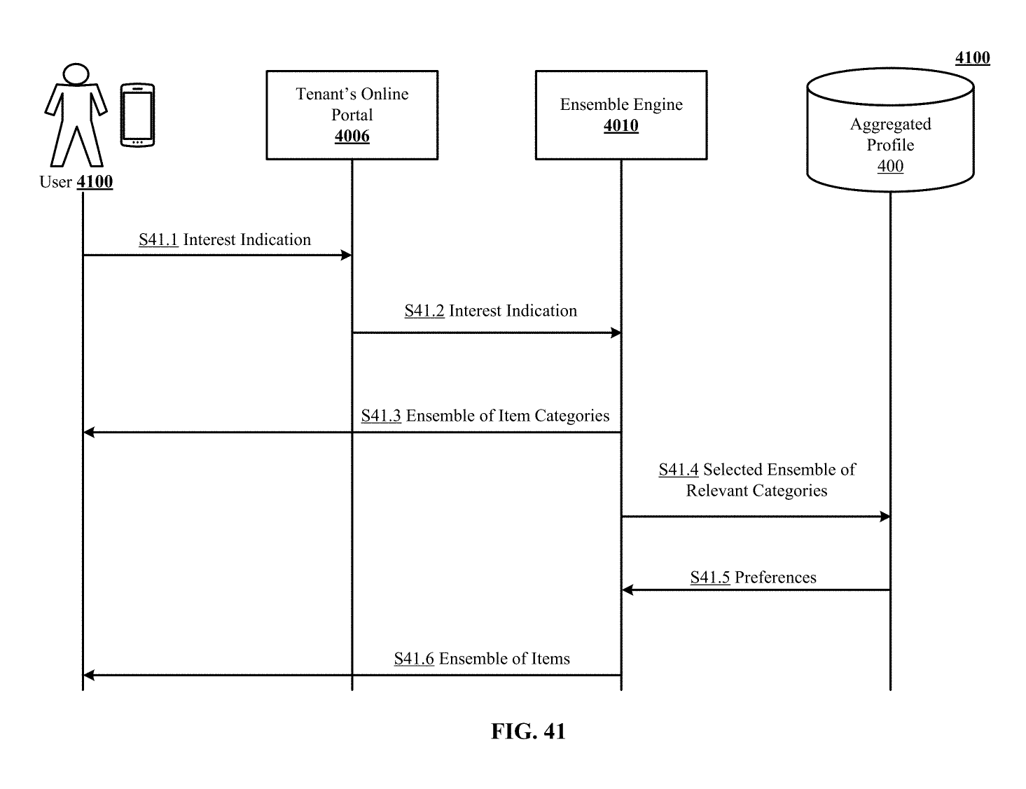

FIG. 41 depicts a message sequence chart of enhancing a user 4100 browsing experience using the ensemble engine. At step S41.1, when the user accesses a tenant's online portal 4006 (e.g., website) and indicates an item of interest, the portal pings an ensemble engine 4010 with the item of interest at step S41.2. In response, at step S41.3, the ensemble engine 4010 provides to the user, via the portal 4006, an ensemble of item categories that complement or replace the item of interest. At step S41.4, based on user preferences for categories, the ensemble engine 4010 selects relevant categories from the ensemble. At step S41.5, the ensemble engine then determines which items to present as an ensemble by analyzing user preferences for characteristics of items from the relevant categories. At step S41.6, the ensemble of items selected using the determined preferences of the user is then presented to the user by the ensemble engine via the portal.

FIGS. 20A and 20B show one example of how the user browsing experience is enhanced by the ensemble engine of FIG. 40. In FIG. 20A, user experience without the use of the ensemble engine is shown. In FIG. 20A, the user selected a red dress and is recommended a high heeled shoe to complement the red dress. In FIG. 20B, the user experience is enhanced by invoking the ensemble engine. Upon invocation, the ensemble engine determines from the aggregated profile 400 that the user prefers low heeled shoes and some other makeup accessories (e.g., lipstick, preferred shoe brand, price sensitivity). Based on this information, the recommendations to the user are revised to include products that match the user's preferences.

### Individualized Incentives to Modify Shopper Behavior

Profiles created using aggregated, and retailer-specific data also can be used to precipitate a visit, thereby increasing foot traffic in the venue. Two opportunities to bring an online user to a store are order fulfillment order and the return of goods purchased online.

When a online user buys from a retailer who has a physical presence at a location that the user visits, the online user may be converted to a visitor by offering to make the goods available immediately at a pick-up counter at a venue. Pick-up today caters to some of the same instincts that cause coffee buyers to pre-order and prepay their morning coffee, for pickup without waiting in line. A user who seldom visits the retailer's physical location may require an extra nudge.

Customized incentives to pick up goods by visiting a physical location can be crafted based on goods specific information and a user profile. While free shipping is enticing to buyers, it is not free to sellers. Part of a custom incentive can be funded by reduced shipping costs. Many shoppers buy a few more things when they happen to visit a venue, so an incentive can be fashioned for discounted purchases today, for instance, that increase the likelihood that a visit to pick up goods will convoy additional purchases.

Elasticity, as a factor in customization of pickup incentives, can be assessed using data aggregated across retailers, which will reveal users with a propensity to take advantage of pick-up today options. It also may reveal proven pick-up visitors who are not aware of a pick-up location that would be convenient for them to visit.

Return of goods purchased online is a further opportunity to precipitate a visit that increases foot traffic in the venue. Returns can be more expensive for an online retailer to process than fulfillment, when the return address is different than the fulfillment address. This is the case when fulfillment is directly from a manufacturer's warehouse, instead of a retailer's distribution center. A customized incentive can be offered to return or exchange goods in-store, potentially avoiding two-way shipping costs. As with pick up of goods, part of a custom incentive can be funded by reduced shipping costs. Another part of an incentive can be based on a likelihood that a visit to pick up goods will convoy additional purchases. Elasticity can be assessed to gauge an amount of incentive that is likely to succeed in precipitating a visit.

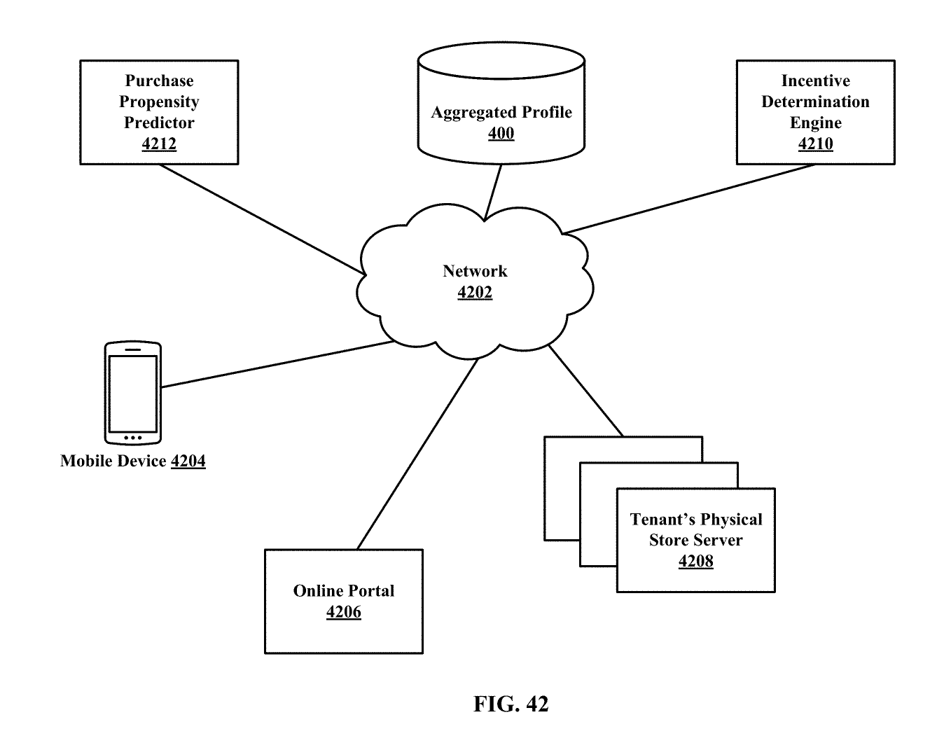

FIG. 42 shows a diagram of an incentive determination system, which uses machine learning techniques to incent users to visit a retailer's physical venue in order to purchase or return items, rather than perform those transactions online. The incentive determination system thus allows retailers to reduce fulfillment costs from shipping and processing online purchases and returns. The system of FIG. 42 includes a mobile device 4204, an online portal 4206, one or more tenant physical store servers 4208, the aggregated profile 400, and an incentive determination engine 4210, all connected to a network. The web portal 4206, accessible from the mobile device 4204 or another computing device, allows users to search for, view, and purchase retailer inventory items. Retailer inventory information is stored by the tenant physical store servers 4208. The aggregated profile 400 stores historical user data, including data on user purchase patterns and return patterns. The propensity predictor 4212 uses machine learning to calculate propensity scores for users from the historical user data. The calculated propensity scores are stored in the aggregated profile. The incentive determination engine 4210 calculates an incentive offer using historical data and propensity scores from the aggregated profile and inventory information from the tenant physical store servers.

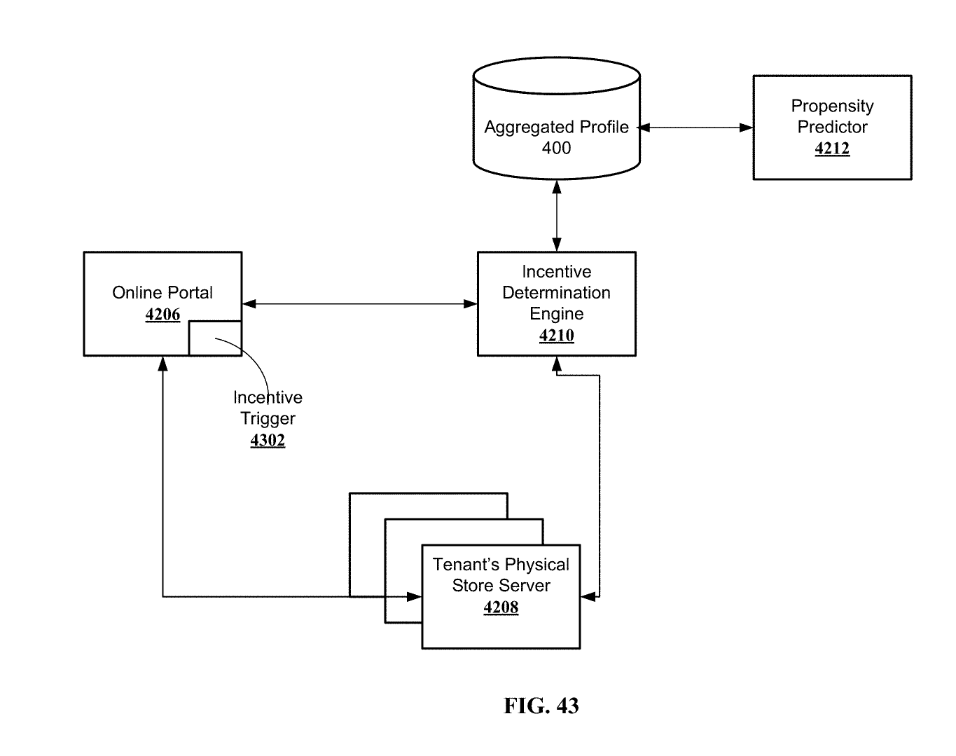

FIG. 43 shows a block diagram illustrating information transfers among the components of the incentive determination system. The online portal 4206 displays inventory information from the tenant physical store servers. When a user selects an inventory item for purchase or return, the item is placed in a shopping cart for the user. The user's shopping cart contains a trigger that prompts the incentive determination engine to calculate the incentive offer. The tenant servers 4208 and aggregated profile 400 provide the incentive determination engine with values for independent variables used to calculate the incentive offer. The independent variables provided by the tenant physical store servers 4208 are derived from inventory-specific information, such as prices and shipping costs for items. The independent variables provided by the aggregated profile are derived from user data, such as historical purchase data, historical return data, and propensity scores produced by the propensity predictor 4212.

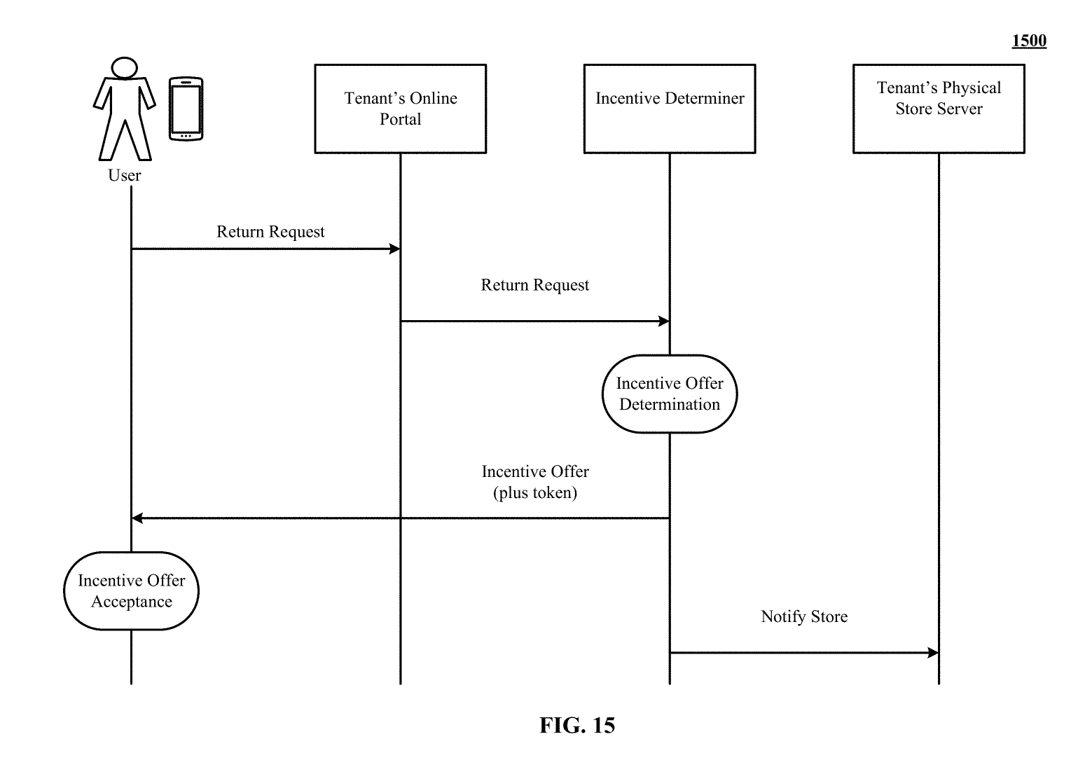

FIG. 15 is a message sequence chart for determining an incentive offer for a shopper 1502 using the aggregated profile 400 of FIG. 4 and using the incentive offer to cause the shopper to return goods purchased online at a physical location instead of returning the goods by shipping. It is expensive for a retailer to accept returns by shipping. Sometimes, the return destination is different from the fulfillment destination. In those instances, a restocking fee is charged by the fulfillment agent. It is likely to be less expensive for the retailer to exchange goods at a physical location, for instance, by providing a better fitting size. The opportunity to convert a return by shipping to a return in-store arises when a user makes a return request to an online portal. The online portal accesses the incentive determination engine. The incentive determination engine uses data in the aggregate profile 400 to assess how much incentive, if any, is likely to convert the user from a return by shipping to a return in store. The aggregated profile 400 contains user propensity scores to return goods in-store and is linked to additional data, including event data. It also contains binned historical data on return patterns. The incentive determination engine also has access to return processing costs. Reduced return processing costs and opportunities to make an exchange or sell additional goods to the user can be taken into account by the incentive determination engine. The incentive determination engine calculates a maximum incentive for in-store return. This incentive may be modified based on propensity scores of a particular user. Once an incentive offer determination is made, the offer is returned the user. Upon acceptance of an offer, the online portal for the incentive determination engine notifies the location at which the return is to take place and provides a token, such as a scannable code, to the user to present at return.

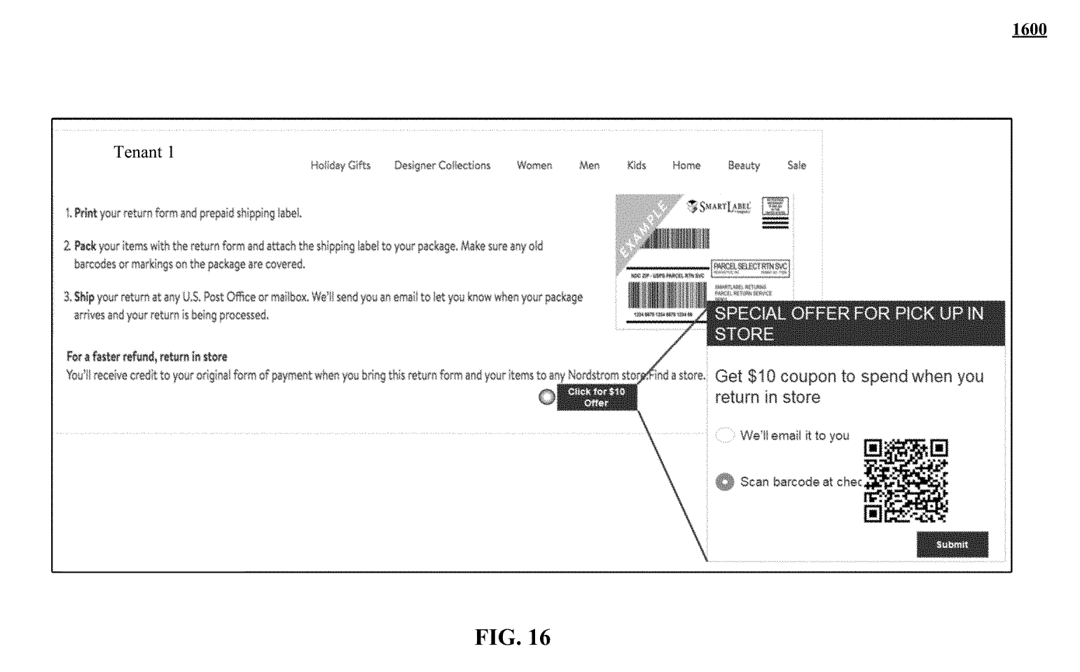

FIG. 16 shows one example of the incentive offer described in FIG. 15. This offer provides a $10 coupon towards additional purchases and a scannable code that can be associated with the return. The scannable code is a token that allows a point-of-sale system to readily accept the return. It also can be used as a coupon, once the return is completed.

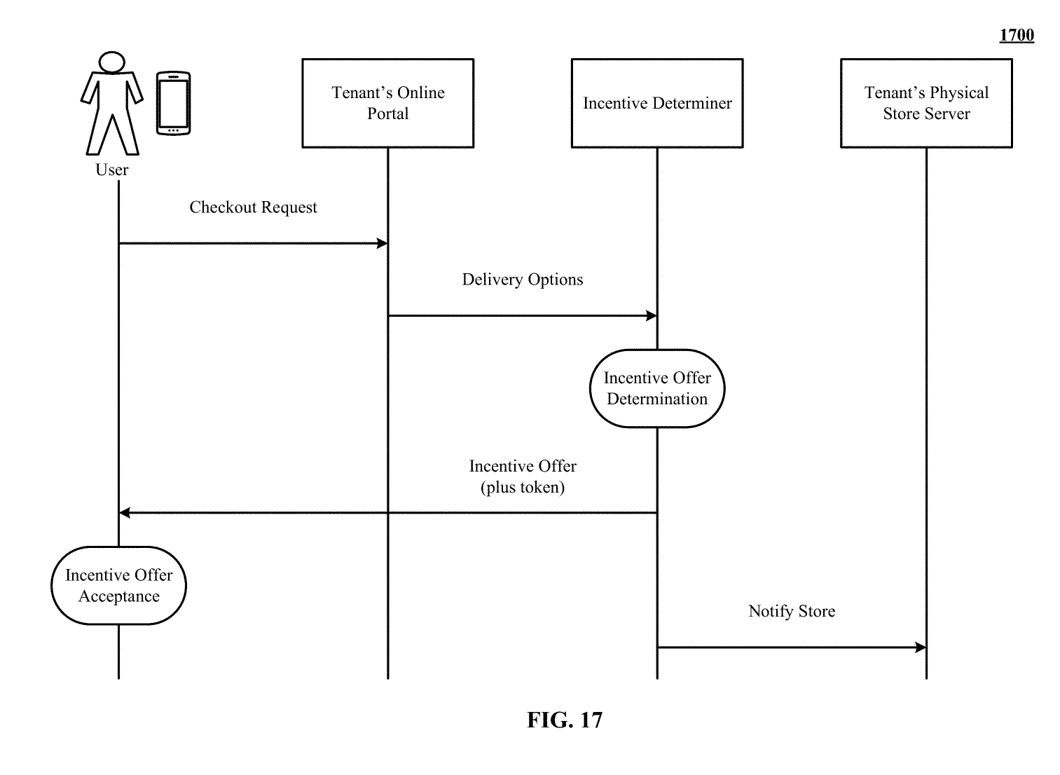

FIG. 17 is a message sequence chart of determining an incentive offer for a user using the aggregated profile 400 of FIG. 4 and using the incentive offer to cause the user to pick up goods at a physical location rather than request shipping. This works much the same way as returning goods purchased online at a physical location, instead of by shipping. Instead of returning goods, for example, for exchange, the user picks up purchased goods. The physical location is responsible for picking the goods and making them available at a pickup counter. In the figure, the online portal, at checkout request, offers the option of in-store pickup. The incentive determination engine uses data in the aggregate profile to assess how much incentive, if any, is likely to convert the user from fulfillment by shipping to pick up goods at a physical location. The aggregated profile contains user purchase propensity scores for picking up goods from a physical location, where the goods are selected and purchased online. The incentive determination engine also has access to fulfillment by shipping costs. Reduced fulfillment costs and opportunities to sell additional goods the user can be taken into account by the incentive determination engine. The incentive determination engine calculates a maximum incentive for in-store pickup. This incentive may be modified based on historical data regarding user purchase propensity scores. Once in all incentive offer determination is made, the offer is returned to the user. Upon acceptance of an offer, the online portal for the incentive engine notifies the location at which the goods are to be picked up to pull the goods from inventory. It provides a token to the user to present upon arrival at the pickup desk.

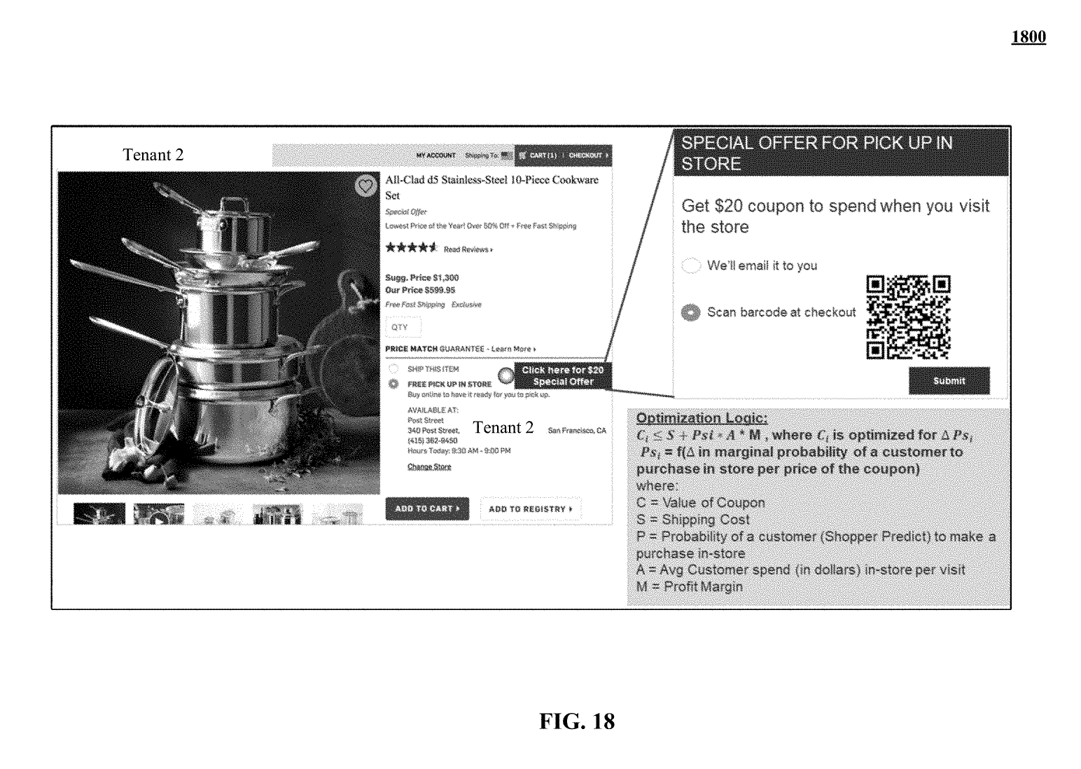

FIG. 18 shows one example of the incentive offer described in FIG. 17. A formula for pricing the incentive offer appears in the bottom right-hand corner. The cookware goods being purchased appear prominently in a photograph. The incentive in this example is a $20 coupon to spend while visiting the store. The scannable barcode acts as a token for pickup and can serve as a coupon once the pickup is complete.

The formula for pricing the coupon is:

Cᵢ≤S+Psi×A×M

where Cᵢ is the value of the coupon, S is the shipping cost, Pₛᵢ is a purchase propensity score for a user, A is the average spend by the user per visit, and M is the retailer's profit margin. A and M may be retrieved directly from shopping cart data, while Pₛᵢ is produced by the propensity predictor. Thus, the coupon's value is priced to be less than the sum of the shipping cost for the item and the retailer's expected profit (the formula term Psi×A×M) from the user. This enables the retailer to profit, on average, from each user receiving an incentive offer, while recouping shipping costs.

In order for the incentive determination engine to determine the expected profit, the propensity predictor first calculates the purchase propensity score Pₛᵢ. The user's purchase propensity score Pₛᵢ describes the likelihood of a user making a purchase during a future time period. The purchase propensity score Pₛᵢ may be a cross-category purchase propensity for the retailer (e.g., the likelihood that the user will purchase something from the store) or a category-specific propensity (e.g., the likelihood that the user will purchase a pot from the store). The propensity predictor analyzes both category-specific and cross-category time-binned purchase information from users in order to produce the purchase propensity score Pₛᵢ. In some implementations, non time-binned data, such as total yearly spend, or recency of last purchase, may be analyzed by the propensity predictor.

The formula indicates that users receive larger incentive offers if they are more likely to purchase items from the retailer and if they spend, on average, larger amounts of money when they visit. Thus, pricing the coupon using the above formula may not only incentivize in-store purchases over online purchases but may also drive sales. If users wish to receive larger discounts on items from the retailer, they can purchase items from the store more frequently as well as purchase expensive items during store visits.

In some implementations, the coupon pricing formula may be modified to incentivize consumers who purchase items may be a mainly online to visit the retailer's physical location to purchase the item instead (Buy Online Pick In-Store, BOPIS). An example of such a modification is multiplying the product term Pₛᵢ×A×M by an offset multiplier (e.g., the ratio of the user's purchase propensity score for an online purchase to the user's purchase propensity score for an offline purchase). Using this offset multiplier, users who primarily purchase online (and have a larger offset multiplier) would be offered larger incentives to visit the physical location of the retailer to purchase items rather than purchasing them online. Users who primarily purchase at the physical location would be offered smaller incentives.

In some implementations, an online shopper can be converted to an in-retailer purchaser by offering discounts as incentives. Visitors in venues can be increased by encouraging the right shoppers to visit the retailers despite their online purchase preferences or behavior. By identifying the right candidate to bring to the physical locations of the retailer, the retailer can provide the necessary incentive at the time of online purchase, to buy the product online but pick it up in the store.

In order to determine the necessary incentive, the likelihood of a shopper to pick up an item in-store needs to be determined. The probability of the shopper picking up an item in-store can be estimated by a first probabilistic classifier, where the training data to the first probabilistic classifier includes both online and in-store purchase behavior of the shopper. The input features in the first probabilistic classifier can be generated across retailers in the network, taking into account the proximity of the shopper's residence to addresses of the most frequented physical stores within the network.

A second probabilistic classifier will be used to predict the level of discount that will likely incentivize the shopper to come to the store, such as the conditional Probability (10% discount), Probability (25% discount), Probability (50% discount). In lieu of prior BOPIS discount behavior, discounted purchases may be used as an initial proxy.

In addition to the first probability classifier and the second probability classifier, an amount the shopper will spend when they come into the store for the pickup needs to be estimated to calculate the necessary incentive.

The necessary incentive for each Discountᵢ can be calculated by:

Prob(BOPIS,Discountᵢ)=Prob(BOPIS)*Prob(Discountᵢ/BOPIS).

The net benefit for each Discountᵢ can be calculated by:

Gains to Retailer: Prob(BOPIS,Discountᵢ)×(Shipping Cost Savings+Impulse Spend in store)

Losses to Retailer: Prob(BOPIS,Discountᵢ)×(Value of the Incentive+Cost of the fulfillment in store)

Net Benefit for each Discountᵢ=Gains to Retailer−Losses to Retailer

The optimal incentive Discount₀ maximizes the net benefit.

A luxury shopper is defined by their purchases in the most expensive brands in a category, and then across all categories they have purchased in. The rank ordering of luxury shoppers is done in two stages. In the first stage, the luxury brands are identified within a category based on the SKU level prices, which is then aggregated across categories to arrive at a rank-ordered index at the shopper level at the second stage.

Luxury brands can be identified by calculating the minimum, the 25^{th} percentile, the median, the mean, the 75^{th} percentile, and the maximum price measures for each brand taking into account the gross price of each distinct product that has been sold Quintile based ranks and scores are assigned to each brand based on each of the above price measures. An overall luxury score for each brand can be calculated by taking the average of the above scores.

A Luxury Score of a shopper can be estimated by:

$$Luxury Score of a shopper = \frac{\begin{matrix}Sum ( Brand Luxury Score * \\ Number of items purchased )\end{matrix}}{Sum ( Number of items purchased )}$$

### Computer System

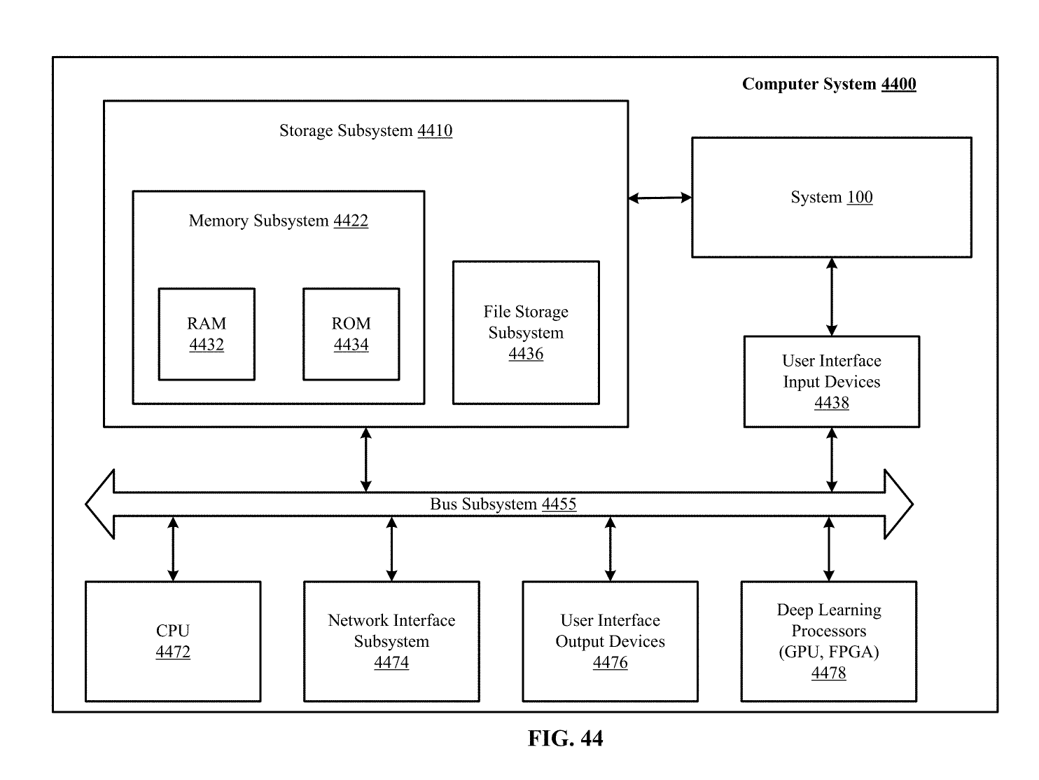

FIG. 44 is one implementation of a computer system 4400 that can be used to implement the technology disclosed. Computer system 4400 includes at least one central processing unit (CPU) 4472 that communicates with a number of peripheral devices via bus subsystem 4455. These peripheral devices can include a storage subsystem 4410 including, for example, memory devices and a file storage subsystem 4436, user interface input devices 4438, user interface output devices 4476, and a network interface subsystem 4474. The input and output devices allow user interaction with computer system 4400. Network interface subsystem 4474 provides an interface to outside networks, including an interface to corresponding interface devices in other computer systems.

In one implementation, the system 100 of FIG. 1 is communicably linked to the storage subsystem 4410 and the user interface input devices 4438.

User interface input devices 4438 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 4400.

User interface output devices 4476 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 4400 to the user or to another machine or computer system.

Storage subsystem 4410 stores programming and data constructs that provide the functionality of some or all of the modules and methods described herein. These software modules are generally executed by deep learning processors 4478.

Deep learning processors 4478 can be graphics processing units (GPUs) or field-programmable gate arrays (FPGAs). Deep learning processors 4478 can be hosted by a deep learning cloud platform such as Google Cloud Platform™, Xilinx™, and Cirrascale™. Examples of deep learning processors 4478 include Google's Tensor Processing Unit (TPU)™, rackmount solutions like GX4 Rackmount Series™, GX8 Rackmount Series™, NVIDIA DGX-1™, Microsoft™ Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamiclQ™ IBM TrueNorth™, and others.

Memory subsystem 4422 used in the storage subsystem 4410 can include a number of memories including a main random access memory (RAM) 4432 for storage of instructions and data during program execution and a read only memory (ROM) 4434 in which fixed instructions are stored. A file storage subsystem 4436 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 4436 in the storage subsystem 4410, or in other machines accessible by the processor.

Bus subsystem 4455 provides a mechanism for letting the various components and subsystems of computer system 4400 communicate with each other as intended. Although bus subsystem 4455 is shown schematically as a single bus, alternative implementations of the bus subsystem can use multiple busses.

Computer system 4400 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 4400 depicted in FIG. 44 is intended only as a specific example for purposes of illustrating the preferred embodiments of the present invention. Many other configurations of computer system 4400 are possible having more or less components than the computer system depicted in FIG. 44.

Particular Implementations—Overall

We describe a system and various implementations of using machine learning and analytics to help brick and mortar stores compete with online shopping moguls. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

### Particular Implementations (1004)—Visitor to Venue

The technology disclosed relates to using machine learned visitor intent propensity to greet and guide a visitor at a physical venue.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation related to greeting upon arrival, we disclose a method of greeting a visitor at a venue. The method, for example, includes recognizing arrival of a mobile device carried by a visitor at a venue having participating tenants. The technology disclosed not only applies to a single tenant at a single location. This same approach may be applied to over multiple locations and sub-locations that have the same vendor operator.

The method also includes informing servers representing the participating tenants of arrival of the visitor. This “informing” is accompanied by a profile of the visitor, tenant-specific information and aggregate intent propensity information. The method further includes receiving and evaluating proposed messages from the servers representing the participating tenants for a predetermined limit on messages. According to the method, selected methods are forwarded, where the messages are selected by the evaluating to the mobile device carried by the visitor.

In an example implementation, the method includes recognizing the arrival of the mobile device carried by the visitor. This is based on beacon reporting from the mobile device carried by the visitor.

As an example of the beacon reporting, the beacon reporting is received from symbiotic reporting code running on an app on the mobile device. The app on the mobile device can be (i) a social media app, (ii) a navigation app, and/or (iii) a ride sharing app. The app can also be running in a foreground mode or an active background mode of the mobile device. As another example of the beacon reporting, the beacon reporting includes at least one encrypted message from a beacon having a registered location within the venue.

Further, as an example of the profile, the profile includes (i) a visitor name, (ii) a visitor photograph, (iii) other personally identifiable information and/or (iv) a unique identifier but not a visitor name or photograph.

In an implementation, the intent propensity information does not include a specific predetermined intent based on recent online activity of the visitor. Additionally, for example, the tenant-specific and aggregate intent propensity information is pre-calculated prior to the arrival and binned by category in the visitor's profile.

According to an implementation, the method includes evaluating the proposed messages for at least consistency with (between) the tenant-specific and aggregate intent propensity information.

Examples of evaluating the proposed messages, as performed by the method, are provided below. One example includes evaluating the proposed messages for consistency based on semantic analysis of the proposed messages against the tenant-specific and aggregate intent propensity information. Other example includes evaluating the proposed messages, for example, using a multi-layer convolutional neural network. Another example includes updating the evaluating of the proposed messages (as a location of the visitor within the venue) using a recurrent neural network. Another example includes updating the evaluating of the proposed messages (as a location of the visitor within the venue) using a convolutional neural network, a multi-layer convolutional neural network, and an attention mechanism.

In an implementation the method includes queuing unused messages among the received messages. As an example, the selected unused messages are forwarded to the visitor based on location updates obtained or that occurred during a journey of the visitor through the venue. For example, according to the method, the messages selected by the evaluating are forwarded to the mobile device within less than five minutes of the arrival.

Further, in an implementation, the method includes determining that the visitor has at least one identified intent upon arrival at the venue. This is done using recent online browsing activity. Additionally, the method includes, for example, informing the participating tenants of the identified intent and/or evaluating the proposed messages from the servers representing the participating tenants for at least consistency with the identified intent.

The method, in an implementation, includes prioritizing the proposed messages based at least in part to complement the identified intent. Additionally, the method includes delivering the prioritized messages not exceeding the message limit.

Further example of the method include (i) determining that the visitor has at least one identified intent upon arrival at the venue, where this can be done based on an entitlement being fulfilled at the venue, (ii) further informing the participating tenants of the identified intent, and (iii) further evaluating the proposed messages from the servers representing the participating tenants for at least consistency with the identified intent.

In one implementation related to a next best offer or obtaining a next best offer, we disclose a method of helping a visitor proceed in a journey through a facility having multiple tenants. The technology disclosed not only applies to a single tenant at a single location. This same approach may be applied to over multiple locations and sub-locations that have the same vendor operator. The method includes planning, upon arrival at the facility, a sequence of messages to lead the visitor on the journey through the facility. This sequence of messages is constructed based on (i) binned profile data for the visitor and, at least, (ii) a calculation of current intent indications for the visitor.

The method of this implementation further includes updating the plan based on hyper-location data obtained after the arrival. This reveals a course of an actual journey by the visitor through the facility. The method further includes periodically messaging a mobile device carried by the visitor with messages based on the updated plan.

In an implementation according to this method, a dwell time of the visitor at two or more tenants that is used in a recalculation, results in changed current intent indications. Further, the method includes causing presentation of an incentive to the visitor based on the recalculation.

In another implementation the method informs servers representing the tenants of arrival of the visitor. This informing is accompanied by the changed current intent indications. Also, in an example the method receives and evaluates proposed messages from the servers representing the tenants, and forwards messages selected by the evaluating to the mobile device carried by the visitor.

For example, the dwell time of the visitor at two or more tenants are used in a recalculation and results in changed current intent indications, such that the method informs servers representing the tenants of arrival of the visitor, accompanied by the changed current intent indications.

In an implementation the method receives and evaluates proposed messages from the servers representing the tenants and also forwards messages selected by the evaluating to the mobile device carried by the visitor.

### Particular Implementations (1005)—Gender and Age Context

The technology disclosed relates to providing gender and age context for user intent when browsing or searching.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of enhancing a user browsing experience. This method includes receiving a gender context query from a provider for a content request by an identified user, and also includes accessing an aggregated profile with an interest history organized by provider for the identified user. In an implementation includes determining an a priori most likely gender context based on the provider and the aggregated profile, as well as returning a gender context identifier responsive to the query, based on the determining.

An example of the aggregated profile for the identified user includes pre-calculated clusters of gender and age for distinct personalized historical interests of the identified user. The method, for example, determines the a priori most likely gender context as one of the distinct personalized historical interests.

Examples of the pre-calculated clusters include style preferences of the distinct personalized historical interests.

Another example of the aggregated profile for the identified user includes pre-calculated historical frequencies of gender and age interest, organized by provider for the identified user.

In an implementation the method accesses recent browsing history of the identified user, as well as combines a priori likelihood with recent browsing history to determine the most likely gender context.

Further, for example the method includes receiving an age context query with the gender context query. This makes it possible to use the aggregated profile for the identified user to determine and return the most likely age context.

An implementation of this method, for example includes (i) receiving an age context query with the gender context query, and/or (ii) using the aggregated profile for the identified user to determine and return the most likely age context as one of the distinct personalized historical interests.

According to another implementation the method (i) receives an age context query with the gender context query, and/or (ii) uses the aggregated profile for the identified user to determine and return the most likely age context.

In a further implementation the method (i) receives an age context query with the gender context query, and/or (ii) combines a priori likelihood with recent browsing history to determine and return the most likely age context.

### Particular Implementations (1006)—Ensemble

The technology disclosed relates to generating an individualized ensemble of complementary items in complementary item categories.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of enhancing a user browsing experience. The method includes detecting an indication of interest in an item for an identified user, as well as invoking an ensemble engine with the item of interest. The method, for example, also responsively receives, from the ensemble engine, an ensemble of item categories that complement the item of interest.

Further, the method retrieves an aggregate profile for the identified user, as well as determines preference of the user for a category among recommended categories in the ensemble of item categories, determines feature preferences of the identified user that apply to the recommended categories, and uses the determined category and feature preferences to select items to include in an ensemble of items. The method also includes causing display (to the identified user) of the ensemble of items selected using the determined category and feature preferences of the identified user.

In another implementation the method detects the interest in the item (i) during online browsing by the identified user, (ii) during physical browsing by the identified user at a physical location, and/or (iii) from a PoS terminal adjacent to the identified user.

In an example, the method determines (from the aggregate profile) a group interest pattern. The method can also select items from the group interest pattern to include in the ensemble of items selected.

In various implementations the method determines (i) a style preference among the feature preferences, (ii) a size preference among the feature preferences, and/or (iii) a color preference among the feature preferences.

In other various implementations the method causes display (to the user) on (i) a mobile device held by the user, (ii) a display adjacent to the user, and/or (iii) a display of a mobile device held by a person assisting the user.

### Particular Implementations (1007)—Modifying Purchase Behavior

The technology disclosed relates to systems and methods of individualized incentives to modify shopper behavior.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation related to buying online and returning at a store, we disclose method of handling returns for retailers with both online and physical presences. The method includes interacting with a user online responsive to a return request, as well as evaluating specific goods identified by the user to be returned and determining a first incentive value based on a cost of processing the return. The method also causes presentation (to the user) of an incentive offer that is less than or equal to the first value in exchange for returning the specific goods at a physical location instead of by shipping. The method further, upon accepting the incentive, pre-arranges receipt of return of the specific goods at the physical location. This can also include giving the user a token to present when visiting the physical location.

Examples of evaluating the specific goods include (i) taking into account the user's history of return to a physical location of goods purchased online and/or (ii) taking into account and a history of return patterns by the user.

In an implementation the method (i) evaluates binned profile data for the user, (ii) determines a second incentive value based on bringing the user to a physical location, and/or (iii) combines the first and second incentive values and presenting the user the incentive offer with a value less than or equal to the combined first and second incentive values, instead of an offer with a value less than or equal to the first incentive value.

In an example implementation the method directs the incentive to ensemble items available at the physical location. In another example implementation the method causes presentation of a list of physical locations to the user and receives a selection of the physical location for return. In a further example implementation the token to present is a scan code pattern.

In another implementation related to buying online and picking up at a store, we disclose method of handling fulfillment for retailers with both online and physical presences. This method interacts with a user online responsive to a purchase request, evaluates specific goods identified by the user to be purchased, and determines a first incentive value based on a cost of fulfilling the purchase request. Further, this method includes causing presentation (to the user) of an incentive offer that is less than or equal to the first value in exchange for picking up the specific goods at the physical location instead of receiving the specific goods by shipping. Additionally, this method, upon acceptance of the incentive, pre-arranges pick up of the specific goods at the physical location, including giving the user a token to present when visiting the physical location.

In an example implementation of this method, the method determines immediate availability of the specific goods ordered and accompanying the incentive offer with assertion of the immediate availability.

An example of evaluating specific goods, as performed by this method, includes evaluating specific goods identified by taking into account the user's history of pick up from a physical location of online purchases.

In an implementation the method includes (i) evaluating binned profile data for the user and determining a second incentive value based on bringing the user to a physical location, (ii) combining the first and second incentive values, and/or (iii) presenting the user the incentive offer with a value less than or equal to the combined first and second incentive values, instead of an offer with a value less than or equal to the first incentive value.

The method also includes, in an example implementation, (i) directing the incentive to ensemble items available at the physical location, and/or (ii) causing presentation of a list of physical locations (to the user) and receiving a selection of the physical location for return. In another implementation the token to present is a scan code pattern.

In one implementation related to underestimated shoppers, we disclose method of converting shoppers to in-retailer purchases. This method includes receiving an identified shopper from a retailer with an interest context directed to a product, as well as determining a product category that includes the product. In an implementation this method also determines (from an aggregated profile for the identified shopper) (i) an in-retailer purchase propensity and (ii) overall purchase propensity for the product category or for an ensemble of related product categories. The method further includes comparing the in-retailer purchase propensity and overall purchase propensity, as well as determining that the in-retailer purchase propensity underestimates the overall purchase propensity. This method also causes an alert (based on the determined underestimate) to the retailer that the identified purchaser is a conversion candidate for in-retailer purchases.

Examples of identified shoppers being received include the identified shopper being received from the retailer from (i) the retailer during online browsing by the shopper, (ii) the retailer during physical browsing by the shopper, and/or (iii) the retailer from a point-of-sale system during checkout by the shopper.

In an implementation the method determines the product category within a SKU hierarchy from a SKU.

In another implementation the method calculates and causes display of an incentive to convert the identified shopper to an in-retailer purchase in the product category or ensemble of product categories.

The method, for example also includes causing initiating of direct marketing (to the identified shopper) directed to the product category or ensemble of product categories.

In one implementation related to price elasticity, we disclose method of customizing an incentive for a visitor. This method includes receiving a specification of one or more goods under consideration by a visitor who has a purchase history, as well as determining a set of prior purchases of prior goods by the visitor in one or more categories correlated with the goods under consideration. This method further compares prices actually paid for the prior goods with standard prices for the prior goods, and also generates a discount-orientation rating for the visitor based on the comparing.

In an example implementation this method receives the specification of the goods under consideration, as product stock keeping units (abbreviated SKUs), as well as determines the categories correlated with the goods under consideration. This is done from a hierarchy arranged from dozens of main categories through hundreds or thousands of SKUs.

In another example implementation the method (i) generates a numerical discount-orientation rating, (ii) generates a categorical discount-orientation rating, (iii) adjusts an incentive presented to the visitor based on the discount-orientation rating, (iv) determines to provide a future upgrade incentive to the visitor based on a price insensitive discount-orientation rating, and/or (v) determines to provide an discount incentive to the visitor based on a price sensitive discount-orientation rating.

In one implementation related to a luxury buyer special service, we disclose method of rationing attention devoted to a visitor. This method includes receiving a signal from a mobile device allowing identification of a visitor upon arrival at a venue, as well as accessing an aggregated profile for the identified visitor, and determining an aggregated luxury purchase index for a particular retailer at the venue and a luxury purchase index aggregated across retailers. This message also includes messaging a server representing the particular retailer at the venue identifying the visitor as a luxury buyer based on one or both of the luxury purchase indexes.

In an example implementation this method involves multiple participating retailers being located at a venue further including. This further includes informing servers representing the participating retailers of arrival of the visitor at the venue, accompanied by a profile of the visitor and retailer-specific and aggregate intent propensity information from the aggregated profile. Additionally, this method includes receiving and evaluating proposed messages from the servers representing the participating retailers, as well as forwarding messages selected by the evaluating to the mobile device carried by the visitor.

Examples of this method further includes evaluating the proposed messages for (i) at least likelihood of success based on the aggregate intent propensity information, and/or (ii) at least price offered for delivery of the proposed messages.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

### CLAUSES

The following clauses point out various features of the invention.

Clause A1. A method of enhancing a user browsing experience, including:

receiving a gender context query from a provider for a content request by an identified user, wherein the identified user's content request applies to an unidentified beneficiary;

accessing an aggregated profile with an interest history organized by provider for the identified user;

determining an a priori most likely gender context based on the provider and the aggregated profile; and

returning a gender context identifier for the unidentified beneficiary responsive to the query, based on the determining.

A2. The method of clause A1, wherein the aggregated profile for the identified user further includes pre-calculated clusters of gender and age for distinct personalized historical interests of the identified user;

further including determining the a priori most likely gender context as one of the distinct personalized historical interests.

A3. The method of clause A2, wherein the pre-calculated clusters further include style preferences of the distinct personalized historical interests.

A4. The method of clause A1, wherein the aggregated profile for the identified user further includes pre-calculated historical frequencies of gender and age interest, organized by provider for the identified user.

A5. The method of clause A1, further including:

accessing recent browsing history of the identified user; and

combining a priori likelihood with recent browsing history to determine the most likely gender context.

A6. The method of clause A1, further including:

receiving an age context query with the gender context query; and

using the aggregated profile for the identified user to determine and return the most likely age context.

A7. The method of clause A2, further including:

receiving an age context query with the gender context query; and

using the aggregated profile for the identified user to determine and return the most likely age context as one of the distinct personalized historical interests.

A8. The method of clause A4, further including:

receiving an age context query with the gender context query; and

using the aggregated profile for the identified user to determine and return the most likely age context.

A9. The method of clause A5, further including:

receiving an age context query with the gender context query; and

combining a priori likelihood with recent browsing history to determine and return the most likely age context.

A10. A system including one or more processors coupled to memory, the memory loaded with computer instructions, the instructions, when executed on the processors, implement a method of enhancing a user browsing experience, including:

receiving a gender context query from a provider for a content request by an identified user, wherein the identified user's content request applies to an unidentified beneficiary;

accessing an aggregated profile with an interest history organized by provider for the identified user;

determining an a priori most likely gender context based on the provider and the aggregated profile; and

returning a gender context identifier for the unidentified beneficiary responsive to the query, based on the determining.

A11. A non-transitory computer readable storage medium impressed with computer program instructions, the instructions, when executed on a processor, implement a method of enhancing a user browsing experience, including:

receiving a gender context query from a provider for a content request by an identified user, wherein the identified user's content request applies to an unidentified beneficiary;

accessing an aggregated profile with an interest history organized by provider for the identified user;

determining an a priori most likely gender context based on the provider and the aggregated profile; and

returning a gender context identifier for the unidentified beneficiary responsive to the query, based on the determining.

B1. A method of enhancing a user browsing experience, including:

receiving a selection of an object feature from among a plurality of object features displayed across a web interface, wherein the object features are embedded in a search space;

invoking an recommendation engine with the object feature and responsively receiving from the recommendation engine a set of object classes that complement the object feature;

retrieving an aggregate profile for the identified user, determining likelihood of the user selecting a class among recommended object classes in the set of object classes, determining feature likelihoods of the identified user that apply to the recommended object classes, and using the determined class and feature likelihood to select object features from the search space to include in a selected set of object features; and

causing display to the identified user of the selected set of the object features based on the determined class and feature likelihoods of the identified user.

B2. The method of clause B1, further including detecting the interest in the object during online browsing by the identified user.

B3. The method of clause B1, further including detecting the interest in the object during physical browsing by the identified user at a physical location.

B4. The method of clause B1, further including detecting the interest in the object from a PoS terminal adjacent to the identified user.

B5. The method of clause B1, further including determining from the aggregate profile a group interest pattern and selecting items from the group interest pattern to include in the ensemble of object selected.

B6. The method of clause B1, further including determining a style preference among the feature preferences.

B7. The method of clause B1, further including determining a size preference among the feature preferences.

B8. The method of clause B1, further including determining a color preference among the feature preferences.

B9. The method of clause B1, further including causing display to the user on a mobile device held by the user.

B10. The method of clause B1, further including causing display to the user on a display adjacent to the user

B11. The method of clause B1, further including causing display to the user on a display of a mobile device held by a person assisting the user.

B12. A system including one or more processors coupled to memory, the memory loaded with computer instructions, the instructions, when executed on the processors, implement a method of enhancing a user browsing experience, including:

receiving a selection of an object feature from among a plurality of object features displayed across a web interface, wherein the object features are embedded in a search space;

invoking an recommendation engine with the object feature and responsively receiving from the recommendation engine a set of object classes that complement the object feature;

retrieving an aggregate profile for the identified user, determining likelihood of the user selecting a class among recommended object classes in the set of object classes, determining feature likelihoods of the identified user that apply to the recommended object classes, and using the determined class and feature likelihood to select object features from the search space to include in a selected set of object features; and

causing display to the identified user of the selected set of the object features based on the determined class and feature likelihoods of the identified user.

B13. A non-transitory computer readable storage medium impressed with computer program instructions, the instructions, when executed on a processor, implement a method of enhancing a user browsing experience, including:

receiving a selection of an object feature from among a plurality of object features displayed across a web interface, wherein the object features are embedded in a search space;

invoking an recommendation engine with the object feature and responsively receiving from the recommendation engine a set of object classes that complement the object feature;

retrieving an aggregate profile for the identified user, determining likelihood of the user selecting a class among recommended object classes in the set of object classes, determining feature likelihoods of the identified user that apply to the recommended object classes, and using the determined class and feature likelihood to select object features from the search space to include in a selected set of object features; and

causing display to the identified user of the selected set of the object features based on the determined class and feature likelihoods of the identified user.

C1. A method of handling returns for retailers with both online and physical presences, the method including:

interacting with a user online responsive to a return request;

evaluating specific goods identified by the user to be returned and determining a first incentive value based on a cost of processing the return;

causing presentation to the user of an incentive offer that is less than or equal to the first value in exchange for returning the specific goods at a physical location instead of by shipping; and

upon acceptance of the incentive, pre-arranging receipt of return of the specific goods at the physical location, including giving the user a token to present when visiting the physical location.

C2. The method of clause C1, further including evaluating specific goods identified by taking into account the user's history of return to a physical location of goods purchased online.

C3. The method of clause C1, further including evaluating specific goods identified by taking into account and a history of return patterns by the user.

C4. The method of clause C1, further including:

evaluating binned profile data for the user and determining a second incentive value based on bringing the user to a physical location; and

combining the first and second incentive values and presenting the user the incentive offer with a value less than or equal to the combined first and second incentive values, instead of an offer with a value less than or equal to the first incentive value.

C5. The method of clause C1, further including directing the incentive to ensemble items available at the physical location.

C6. The method of clause C1, further including causing presentation of a list of physical locations to the user and receiving a selection of the physical location for return.

C7. The method of clause C1, wherein the token to present is a scan code pattern.

C8. A method of handling fulfillment for retailers with both online and physical presences, the method including:

interacting with a user online responsive to a purchase request;

evaluating specific goods identified by the user to be purchased and determining a first incentive value based on a cost of fulfilling the purchase request;

causing presentation to the user of an incentive offer that is less than or equal to the first value in exchange for picking up the specific goods at the physical location instead of receiving the specific goods by shipping; and

upon acceptance of the incentive, pre-arranging pick up of the specific goods at the physical location, including giving the user a token to present when visiting the physical location.

C9. The method of clause C8, further including determining immediate availability of the specific goods ordered and accompanying the incentive offer with assertion of the immediate availability.

C10. The method of clause C8, further including evaluating specific goods identified by taking into account the user's history of pick up from a physical location of online purchases.

C11. The method of claim C8, further including:

evaluating binned profile data for the user and determining a second incentive value based on bringing the user to a physical location; and

combining the first and second incentive values and presenting the user the incentive offer with a value less than or equal to the combined first and second incentive values, instead of an offer with a value less than or equal to the first incentive value.

C12. The method of clause C8, further including directing the incentive to ensemble items available at the physical location.

C13. The method of clause C8, further including causing presentation of a list of physical locations to the user and receiving a selection of the physical location for return.

C14. The method of clause C8, wherein the token to present is a scan code pattern.

C15. A method of converting shoppers to in-retailer purchases, including:

receiving an identified shopper from a retailer with an interest context directed to a product;

determining a product category that includes the product;

determining from an aggregated profile for the identified shopper an in-retailer purchase propensity and overall purchase propensity for the product category or for an ensemble of related product categories;

comparing the in-retailer purchase propensity and overall purchase propensity and determining that the in-retailer purchase propensity underestimates the overall purchase propensity; and

causing an alert, based on the determined underestimate, to the retailer that the identified purchaser is a conversion candidate for in-retailer purchases.

C16. The method of clause C15, wherein the identified shopper is received from the retailer during online browsing by the shopper.

C17. The method of clause C15, wherein the identified shopper is received from the retailer during physical browsing by the shopper.

C18. The method of clause C15, wherein the identified shopper is received from the retailer from a point-of-sale system during checkout by the shopper.

C19. The method of clause C15, further including determining the product category within a SKU hierarchy from a SKU.

C20. The method of clause C15, further including calculating and causing display of incentive to convert the identified shopper to an in-retailer purchase in the product category or ensemble of product categories.

C21. The method of clause C15, further including causing initiating of direct marketing to the identified shopper directed to the product category or ensemble of product categories.

C22. A method of customizing an incentive for a visitor, including:

receiving a specification of one or more goods under consideration by a visitor who has a purchase history;

determining a set of prior purchases of prior goods by the visitor in one or more categories correlated with the goods under consideration;

comparing prices actually paid for the prior goods with standard prices for the prior goods; and

generating a discount-orientation rating for the visitor based on the comparing.

C23. The method of clause C22, further including:

receiving the specification of the goods under consideration, as product stock keeping units (abbreviated SKUs); and

determining the categories correlated with the goods under consideration, from a hierarchy arranged from dozens of main categories through hundreds or thousands of SKUs.

C24. The method of clause C22, further including generating a numerical discount-orientation rating.

C25. The method of clause C22, further including generating a categorical discount-orientation rating.

C26. The method of clause C22, further including adjusting an incentive presented to the visitor based on the discount-orientation rating.

C27. The method of clause C22, further including determining to provide a future upgrade incentive to the visitor based on a price insensitive discount-orientation rating.

C28. The method of clause C22, further including determining to provide an discount incentive to the visitor based on a price sensitive discount-orientation rating.

C29. A method of rationing attention devoted to a visitor, including:

receiving a signal from a mobile device allowing identification of a visitor upon arrival at a venue;

accessing an aggregated profile for the identified visitor and determining an aggregated luxury purchase index for a particular retailer at the venue and a luxury purchase index aggregated across retailers; and messaging a server representing the particular retailer at the venue identifying the visitor as a luxury buyer based on one or both of the luxury purchase indexes.

C30. The method of clause C29, wherein multiple participating retailers are at a venue further including:

informing servers representing the participating retailers of arrival of the visitor at the venue, accompanied by a profile of the visitor and retailer-specific and aggregate intent propensity information from the aggregated profile; and

receiving and evaluating proposed messages from the servers representing the participating retailers; and

forwarding messages selected by the evaluating to the mobile device carried by the visitor.

C31. The method of clause C30, further including:

evaluating the proposed messages for at least likelihood of success based on the aggregate intent propensity information.

C32. The method of clause C30, further including:

evaluating the proposed messages for at least price offered for delivery of the proposed messages.

C33. A system including one or more processors coupled to memory, the memory loaded with computer instructions, the instructions, when executed on the processors, implement a method of handling returns for retailers with both online and physical presences, the method including:

interacting with a user online responsive to a return request;

evaluating specific goods identified by the user to be returned and determining a first incentive value based on a cost of processing the return;

causing presentation to the user of an incentive offer that is less than or equal to the first value in exchange for returning the specific goods at a physical location instead of by shipping; and

upon acceptance of the incentive, pre-arranging receipt of return of the specific goods at the physical location, including giving the user a token to present when visiting the physical location.

C35. A non-transitory computer readable storage medium impressed with computer program instructions, the instructions, when executed on a processor, implement a method of handling returns for retailers with both online and physical presences, the method including:

interacting with a user online responsive to a return request;

evaluating specific goods identified by the user to be returned and determining a first incentive value based on a cost of processing the return;

causing presentation to the user of an incentive offer that is less than or equal to the first value in exchange for returning the specific goods at a physical location instead of by shipping; and

upon acceptance of the incentive, pre-arranging receipt of return of the specific goods at the physical location, including giving the user a token to present when visiting the physical location.

What is claimed is:

1. A method of greeting a visitor at a venue, the method including:
using multilateration for three or more beacons, recognizing arrival of a mobile device carried by a visitor at a venue having participating tenants;
informing servers representing participating tenants of arrival of the visitor, accompanied by a visitor profile and tenant-specific and aggregate intent propensity information;
receiving and evaluating proposed messages from the servers representing the participating tenants for a predetermined limit on messages, wherein the messages are evaluated based on data from the visitor profile and the tenant-specific and aggregate intent propensity information; and
forwarding messages selected by the evaluating to the mobile device carried by the visitor, wherein the selected messages identify objects and procurement schemes available for the objects.

2. The method of claim 1, further including recognizing the arrival of the mobile device carried by the visitor based on a beacon reporting from the mobile device carried by the visitor.

3. The method of claim 2, wherein the beacon reporting is received from symbiotic reporting code running on an app on the mobile device that is a social media app, a navigation app, or a ride sharing app and that is running in a foreground mode or active background mode.

4. The method of claim 2, wherein the beacon reporting includes at least one encrypted message from a beacon having a registered location within the venue.

5. The method of claim 1, wherein the visitor profile includes a visitor name and other personally identifiable information.

6. The method of claim 1, wherein the visitor profile includes a visitor photograph and other personally identifiable information.

7. The method of claim 1, wherein the visitor profile includes a unique identifier but not a visitor name or photograph.

8. The method of claim 1, wherein the tenant-specific and aggregate intent propensity information includes a specific predetermined intent based on recent online activity of the visitor.

9. The method of claim 1, wherein the tenant-specific and aggregate intent propensity information is pre-calculated prior to the arrival and binned by category in the visitor's profile.

10. The method of claim 1, further including evaluating the proposed messages for at least for consistency with the tenant-specific and aggregate intent propensity information.

11. The method of claim 10, further including evaluating the proposed messages for consistency based on semantic analysis of the proposed messages against the tenant-specific and aggregate intent propensity information.

12. The method of claim 11, further including evaluating the proposed messages using a multi-layer convolutional neural network.

13. The method of claim 11, further including evaluating the proposed messages, as a location of the visitor within the venue is updated, using a recurrent neural network.

14. The method of claim 11, further including evaluating the proposed messages, as a location of the visitor within the venue is updated, using a convolutional neural network, a multi-layer convolutional neural network, and an attention mechanism.

15. The method of claim 1, further including queuing unused messages among the messages and forwarding selected unused messages to the visitor based on location updates during a journey of the visitor through the venue.

16. The method of claim 1, further including forwarding the messages selected by the evaluating to the mobile device within less than five minutes of the arrival.

17. The method of claim 1, further including:
determining that the visitor has at least one identified intent upon arrival at the venue, based on recent online browsing activity;
further informing the participating tenants of the identified intent; and
further evaluating the proposed messages from the servers representing the participating tenants for at least consistency with the identified intent.

18. The method of claim 17, further including:
prioritizing the proposed messages based at least in part to complement the identified intent and delivering the prioritized messages not exceeding the predetermined limit on messages.

19. A system including one or more processors coupled to memory, the memory loaded with computer instructions, the instructions, when executed on the processors, implement a method of greeting a visitor at a venue, the method including:
using multilateration for three or more beacons, recognizing arrival of a mobile device carried by a visitor at a venue having participating tenants;
informing servers representing participating tenants of arrival of the visitor, accompanied by a visitor profile and tenant-specific and aggregate intent propensity information;
receiving and evaluating proposed messages from the servers representing the participating tenants for a predetermined limit on messages, wherein the messages are evaluated based on data from the visitor profile and the tenant-specific and aggregate intent propensity information; and
forwarding messages selected by the evaluating to the mobile device carried by the visitor, wherein the selected messages identify objects and procurement schemes available for the objects.

20. A non-transitory computer readable storage medium impressed with computer program instructions, the instructions, when executed on a processor, implement a method of greeting a visitor at a venue, including;
using multilateration for three or more beacons, recognizing arrival of a mobile device carried by a visitor at a venue having participating tenants;
informing servers representing participating tenants of arrival of the visitor, accompanied by a visitor profile and tenant-specific and aggregate intent propensity information;
receiving and evaluating proposed messages from the servers representing the participating tenants for a predetermined limit on messages, wherein the messages are evaluated based on data from the visitor profile and the tenant-specific and aggregate intent propensity information; and
forwarding messages selected by the evaluating to the mobile device carried by the visitor, wherein the selected messages identify objects and procurement schemes available for the objects.

21. A method of helping a visitor proceed in a journey through a facility having multiple tenants, the method including:
planning, upon arrival at the facility, a sequence of messages to lead the visitor on the journey through the facility, with the messages constructed based on binned profile data for the visitor and calculation of current intent indications for the visitor;
updating the plan based on hyper-location data obtained after the arrival that reveals a course of an actual journey by the visitor through the facility; and
periodically messaging a mobile device carried by the visitor with messages based on the updated plan.

22. The method of claim 21, wherein:
dwell time of the visitor at two or more tenants used in a recalculation results in changed current intent indications; and
further including causing presentation of an incentive to the visitor based on the recalculation.

23. The method of claim 22, further including:
informing servers representing the tenants of arrival of the visitor, accompanied by the changed current intent indications;
receiving and evaluating proposed messages from the servers representing the tenants; and
forwarding messages selected by the evaluating to the mobile device carried by the visitor.

24. The method of claim 21, wherein:
dwell time of the visitor at two or more tenants used in a recalculation results in changed current intent indications; and
further including informing servers representing the tenants of arrival of the visitor, accompanied by the changed current intent indications.

25. The method of claim 24, further including:
receiving and evaluating proposed messages from the servers representing the tenants; and
forwarding messages selected by the evaluating to the mobile device carried by the visitor.
